(19) United States
(12) Patent Application Publication
(10) Pub. No.: US 2022/0077688 A1
(43) Pub. Date: Mar. 10, 2022

(54) INTEGRATED POWER SHARING CONTROL METHOD FOR THREE-PHASE INVERTER-BASED GENERATORS WITH APPLICATIONS IN MICROGRIDS

(71) Applicants: Juan Felipe Patarroyo, Mayaguez, PR (US); Fabio Andrade, Cabo Rojo, PR (US)

(72) Inventors: Juan Felipe Patarroyo, Mayaguez, PR (US); Fabio Andrade, Cabo Rojo, PR (US)

(21) Appl. No.: 17/109,059

(22) Filed: Dec. 1, 2020

Related U.S. Application Data
(60) Provisional application No. 62/942,190, filed on Dec. 1, 2019.

(51) Int. Cl. H02J 3/38

(52) U.S. Cl. CPC H02J 3/388; H02J 3/381

(57) ABSTRACT

The invention proposes a power sharing control strategy based on the Linear Quadratic Regulator with optimal reference tracking (LQR-ORT) for three-phase inverter-based generators using LCL filters in both grid-connected and islanded modes. The use of an LQR-ORT controller increases robustness margins and reduces the quadratic value of the power error and control inputs during transient response. Supplementary loops are also used to avoid frequency and voltage deviations in the AC bus without communications. These supplementary loops are used to achieve proportional power sharing among generators according to their rated power capacity. A synchronous reference frame model, which integrates dynamics of power sharing and voltage-current (V-I) control loops, is also proposed. Experimental results demonstrate accuracy of the proposed invention and the effectiveness of the LQR-ORT controller on improving transient response, power sharing, and voltage and frequency recovery.

### FIELD OF THE INVENTION

The invention relates to power sharing control strategies for three-phase inverter-based generators in both grid-connected and islanded modes.

### BACKGROUND OF THE INVENTION

Conventional energy sources such as petroleum, coal, gas, and hydroelectric are facing challenges related to sustainability, reliability, and penetration. Renewable Energy Sources (RES) are emerging as an effective solution to address these challenges. Typically, RES are integrated with an Energy Storage Unit (ESU) and an Energy Conversion Unit (ECU) connected to a load and the main grid as shown in FIG. 1. The ESU is used to store the remainder of generated energy after being consumed by the load. Given that RES such as wind and solar have a variable nature, an ESU is used to increase energy availability. The ECU is used to transform the input voltage (AC or DC) to a rated voltage level depending on the AC or DC nature of the load. Also, the ECU may be connected to the main grid to complement the generated power or to inject power to the grid.

Microgrids emerge as an organized form of integrating RES in local communities or industrial clusters. Currently, there are more than 2,134 active microgrid projects around the world that represent 24.981 GW of capacity. Companies like OPAL RT technologies, National Instruments LabView, and dSPACE Systems are increasing their offering regarding to microgrid technologies, providing users with multiple modules to simulate power systems in real time. Recent advances in power electronics devices, control theory, distribution systems, and government policies make microgrids a suitable solution for generating electricity in a decentralized form. However, the variable nature of the RES obligates engineers to address multiple challenges regarding to microgrid implementation, penetration, and formalization. These challenges include lack of standardization policies, power quality issues, control issues related to stability and robustness, and others.

With the increase of power generation using renewable energy sources, the concept of microgrids is becoming popular nowadays. The U.S. Department of Energy (DOE) defines a microgrid as “a group of interconnected loads and distributed energy resources within clearly defined electrical boundaries that acts as a single controllable entity with respect to the grid. A microgrid can connect and disconnect from the grid to enable it to operate in both grid-connected or island-mode”. This concept gives a clear general view of the main characteristics of a microgrid. Also, it illustrates most of the technological challenges regarding to microgrid integration. First, a microgrid must be composed of distributed generators that must be safely interconnected. Second, a microgrid should act as a single entity. This means that all generators must be synchronized to deliver active and reactive power according to microgrid requirements and operational mode. Finally, a microgrid may work directly connected to the main grid or working totally off grid. This implies that power quality must be guaranteed even if there is not a main grid with high inertia that indicates the reference voltage, frequency, and phase.

General Structure of a Microgrid

In a microgrid, multiple Distributed Generators (DG) and loads are connected to a common bus as shown in FIG. 2. The loads connected to the microgrid may be supplied by the DGs or by a direct connection to the main grid. In addition, multiple ESUs may be connected to the microgrid to increase power availability and system reliability.

A microgrid requires the use of power electronics devices to perform the energy conversion from one voltage level to another. For example, for an AC microgrid, the ESU requires the use of a bidirectional AC-DC converter that regulates the charge or discharge process depending on the available energy. Wind turbine generators require the use of AC-AC converters to transform the amplitude and frequency to standardized voltage levels in the microgrid. Solar photovoltaic (PV) generators require the use of a DC-AC converter to inject the maximum available energy to the microgrid. Loads such as residential homes and streetlights are connected to the microgrid's common bus. The common bus may be connected to the main grid or disconnected to be operating in islanded mode. Each of the interconnections mentioned above are managed by one or more controllers to optimize the energy generation, guarantee adequate power quality, and to improve stability and robustness in the microgrid.

Microgrid Hierarchical Control

Microgrid control is typically separated into different hierarchical levels. One of the most relevant proposals of a standardized control structure for microgrids is presented in “Hierarchical control of droop-controlled AC and DC microgrids—A general approach toward standardization”, J. M. Guerrero, J. C. Vasquez, J. Matas, L. G. De Vicuna, and M. Castilla, IEEE Trans. Ind. Electron., vol. 58, no. 1, pp. 158-172, 2011. The authors set a baseline of all the control levels involved in a microgrid as shown in FIG. 3.

The four control levels are: V-I Control, primary control, secondary control, and tertiary control. V-I control level regulates inverter's output signal waveform in order to meet power quality requirements such as amplitude, frequency, and harmonic distortion. Primary control regulates power sharing between generators and the main grid. Secondary control regulates microgrid power quality. Finally, tertiary control manages issues related to energy markets such as microgrid power sharing to the main grid, controlling battery usage, predicting energy production values, demand response against sudden generator changes, etc. The microgrid control bandwidth decreases with each control level implementation. It means that V-I control has the largest bandwidth and tertiary control has the lowest bandwidth. A large bandwidth implies faster dynamics, low noise attenuation, and highly negative poles. On the other hand, a small bandwidth implies slower dynamics, high noise attenuation, and microgrid closed-loop poles near to the imaginary axis. Typically, each of these control levels is designed separately due to the evident difference in their dynamics.

Voltage and Current Control (V-I Control)

The V-I control level regulates inverter's output voltage and current. A typical V-I control scheme for an inverter generator is shown in FIG. 4.

The inverter is composed of an H-bridge structure made of IGBT transistors. These transistors are switched at a high frequency according to the signal coming from the Pulse-Width Modulation (PWM) generator. The switching action of the transistors makes inverter's output voltage to be a high frequency square signal with variable duty cycle. In frequency domain, the inverter's output signal is represented by a peak at fundamental frequency (50 Hz or 60 Hz) with harmonics at the PWM's switching frequency. To attenuate these harmonics an output filter is used. This output filter is composed of reactive elements to reduce power losses. Typically, the output filter may be an LC, LCL, LLCL, or an L type filter. Each of these filters provide advantages and disadvantages. For example, an L filter is suitable for injecting current directly to the main grid with a high switching frequency. However, this filter does not provide as much harmonic attenuation as the LC, LCL, or LLCL filters. To close the control loop, the V-I controller reads the signals from filter elements and compute them to generate a control output that tracks the signal coming from a reference generator.

Inverter models may be single-phase or three-phase. Single phase inverters are typically used in Uninterruptible Power Supply (UPS) applications. On the other hand, three phase inverters are typically used in microgrid applications given the ease of implementation with the conventional distribution networks. Without loss of generality, three-phase inverters may be analyzed in a stationary reference frame (ABC or αβ) or in a synchronous reference frame (dq). The stationary three-phase reference frame is commonly modeled using ABC coordinates, where A, B, and C correspond to each phase voltage or current. Each phase in the ABC frame has a shift of 120 degrees

$$( \frac{2 π}{3} rads )$$

with the previous phase. A unitary voltage vector in ABC frame is defined by:

$${v}_{a b c} = {[ \begin{matrix}{v}_{a} & {v}_{b} & {v}_{c}\end{matrix} ]}^{T} = {[ \begin{matrix}cos ( ω t ) & cos ( ω t - \frac{2 π}{3} ) & cos ( ω t + \frac{2 π}{3} )\end{matrix} ]}^{T} \qquad ( 1 )$$

The ABC frame may also be modeled as a cartesian coordinate system with three orthogonal vectors representing each phase as shown in FIG. 5a. The balanced three-phase operating vector rotates in the zero-plane represented by the red hexagon. The typical two-dimensional diagram of the ABC shown in FIG. 5b is the same three-dimensional system seen from an isometric point of view shown in FIG. 5a. The ABC frame may also be rotated such that the C vector becomes perpendicular to the zero-plane and vectors A and B are in the zero-plane. In this way, a three-vector reference is transformed into a two-vector reference frame commonly named as the αβ0 frame. This rotation is the well-known Clarke Transformation and is defined by:

c_{αβ0}=[T_{αβ0}]v_{abc} (1)

or by:

$$[ \begin{matrix}{v}_{α} \\ {v}_{β} \\ {v}_{0}\end{matrix} ] = \sqrt{\frac{2}{3}} [ \begin{matrix}1 & - \frac{1}{2} & - \frac{1}{2} \\ 0 & \frac{\sqrt{3}}{2} & - \frac{\sqrt{3}}{2} \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ] \qquad ( 2 )$$

Typically, the zero vector v₀ is not included in the expression because it represents a null value for balanced systems. The main use of the Clarke transformation is to eliminate a component that is common to all three reference vectors in the ABC frame to reduce computations and simplify calculations. In the αβ frame, the three-phase operating vector \vec{v}_{αβ} rotates on a two-dimensional cartesian plane as shown in FIG. 6. It means that v_{α} and v_{β} represent a cosine and a sine function respectively.

If an auxiliary cartesian frame with unitary vectors û_{d} and û_{q} is rotated at the nominal angular frequency ω and \vec{v}_{αβ} is projected to this rotating frame, the sine and cosine functions become constant values. The transformation shown in FIG. 6 corresponds to the well-known Park transformation. To transform a rotating three-phase vector from a stationary reference frame in αβ into a static vector in a synchronous reference frame in dq coordinates, the following transformation must be performed:

v_{dg0}=[T_{dg0}]v_{αβ0}=[T_{θ}]v_{abc} (3)

Which is equal to:

$$[ \begin{matrix}{v}_{d} \\ {v}_{q} \\ {v}_{0}\end{matrix} ] = [ \begin{matrix}cos ( θ ) & sin ( θ ) & 0 \\ - s in ( θ ) & cos ( θ ) & 0 \\ 0 & 0 & 1\end{matrix} ] [ \begin{matrix}{v}_{α} \\ {v}_{β} \\ {v}_{0}\end{matrix} ] = \sqrt{\frac{2}{3}} [ \begin{matrix}cos ( θ ) & cos ( θ - \frac{2 π}{3} ) & cos ( θ + \frac{2 π}{3} ) \\ - sin ( θ ) & - sin ( θ - \frac{2 π}{3} ) & - sin ( θ + \frac{2 π}{3} ) \\ \frac{1}{\sqrt{2}} & \frac{1}{\sqrt{2}} & \frac{1}{\sqrt{2}}\end{matrix} ] [ \begin{matrix}{v}_{a} \\ {v}_{b} \\ {v}_{c}\end{matrix} ] \qquad ( 4 )$$

It is important to note that the normalized transformations in (3) and (5) conserve the norm of the three phase vectors, thus:

v_{d}²+v_{g}²+v₀²=v_{α}²+v_{β}²+v₀²=vₐ²+v_{b}²+v_{c}² (5)

FIG. 7 shows the complete transformation process from ABC frame to αβ frame and dq frame. Note that there is a multiplication in amplitude by a factor of \sqrt{⅔} to conserve the transformation norm. Typically, the grid synchronization is done in this level using PLL techniques in a dq frame. The PLL is a control block that increases the angular frequency ω until the q component of the three-phase signal becomes zero. In this way, the generated signal is synchronized with the main grid to avoid current spikes during interconnection.

The control objectives of the V-I control loop are:
Perfect tracking of the voltage or current sinusoidal reference signal.
Harmonic rejection to keep THD below 5% as specified in IEEE Std. 1547.
High robustness against sudden load or microgrid changes.
Grid synchronization using PLL techniques.

To achieve these objectives, many different control strategies have been proposed in literature. These control strategies may be divided into classical controllers, optimal controllers, and robust controllers:

Classical Controllers:

These controllers refer to Laplace-domain controllers with typical structures such as P, PI, or PID controllers. The Proportional-Resonant controller is a variant of PI controller and is also considered as a classical controller in this document. The P, PI, PID, and PR controllers are often used in industry due to their “tuning” nature that makes their implementation quite straightforward. To illustrate this concept, equation (7) shows a typical PID controller:

$${K}_{PID} ( s ) = {k}_{P} + \frac{{k}_{I}}{s} + s {k}_{D} \qquad ( 6 )$$

Where k_{P}, k_{I}, and k_{D} are the proportional, integral, and derivative gains of the PID controller. When k_{D}=0, the controller is said to be PI. Similarly, when k_{I} is also zero, the controller is said to be a P controller. Each of the constants in the PID controller represent a control objective. Typically, proportional gain is associated to the settling time of a controlled system in response to a step input. Also, derivative gain is associated with overshoot, and integral gain is associated with the steady state error at a 0 Hz step input. Thus, it results quite straightforward for the designer to adjust these three parameters to achieve a desired performance.

Classical controllers have a block diagram structure similar to the one shown in FIG. 8, Where G(s) represents the plant and K(s) represents a classical controller that may be P, PI, PID, or PR. The closed-loop transfer function of the block diagram shown in FIG. 8 is given by:

$$T ( s ) = \frac{Y ( s )}{R ( s )} = \frac{K ( s ) G ( s )}{1 + K ( s ) G ( s )} \qquad ( 7 )$$

In the frequency domain, the addition of an integral component to the controller represents a pole at s=jω=0. This implies an infinite open-loop gain at a frequency of 0 Hz. In other words, at a frequency of 0 Hz (s=jω=0), the open-loop transfer function of a PID controller is equal to

$${lim}_{s \to {0}^{+}} K ( s ) G ( s ) = {lim}_{s \to {0}^{+}} ( {k}_{P} + \frac{{k}_{I}}{s} + {k}_{D} s ) G ( s ) = ∞ .$$

This causes that the closed-loop transfer function T(s) tends to 1 at a frequency of 0 Hz, which means that there is no steady state error.

In microgrid V-I control, a PI controller is often used to regulate output voltage or current in a dq synchronous reference frame where the steady state is achieved when output is a constant signal. Similarly, PR controllers are often used to regulate output voltage or current in a stationary αβ reference frame. A PR controller has the following transfer function:

$${K}_{R E S} ( s ) = {k}_{P} + \frac{{k}_{R} s}{{s}^{2} + {ω}_{n}^{2}} \qquad ( 8 )$$

Where k_{R} is the resonant control gain and on is the nominal microgrid angular frequency. At a nominal frequency, the term s²+ωₙ²=(jωₙ)²+ωₙ² becomes zero. Thus, the open-loop gain of the PR controller at the nominal frequency is infinite. An infinite open-loop gain means that the PR controller achieves zero steady-state error when a sinusoidal reference signal oscillates at the nominal frequency.

Optimal Controllers:

These controllers are based on the Linear Quadratic Regulator (LQR) method, which is modeled in state-space domain. The LQR minimizes energy of the input and the states. Derivations from this method include the use of Kalman filters and Linear-Quadratic Gaussian (LQG) controllers. Also, optimal controllers can be synthesized using heuristic methods such as Particle Swarm Optimization, which uses a set of agents that look for the optimal value of certain cost function in an organized form. Generally, optimal controllers apply to the linearized state-space domain where the system is defined by:

\dot{x}=Ax+Bu

y=Cx+Du (9)

Where x is the state vector that represents the value of each of the variables of interest and u is the input vector. Matrix A is known as the “state matrix” and is used to describe state dynamics. Matrix B is known as the “input matrix” and is used to relate input vector with state vector. Matrix C is known as the output matrix and is used to relate the state vector with the output of the system. Finally, matrix D is known as the “feedforward matrix” and is used to directly relate the input with the output of the system. The state-feedback controller is defined by the expression u=−Kx, where K is the state-feedback controller that may be represented by a vector or matrix. The general block diagram of a state-feedback controller is shown in FIG. 9.

The most common optimal control method is the LQR. This controller optimizes a quadratic cost function defined by:

J(t₀)=½x^{T}(T)S(T)x(T)+½∫ₜ_{₀}^{T}(x^{T}Qx+u^{T}Ru)dt (10)

Where Q and R represent the weighting matrices in the state vector and input vector respectively. Additionally, S(T) represents the weighting matrix of the final state. The optimal controller K* may be found by the following expression:

K*=R⁻¹B^{T}S(t) (11)

Where S(t) is the solution to the Ricatti differential equation:

−\dot{S}=A^{T}S+SA−BR⁻¹B^{T}S+Q (12)

A suboptimal solution may be found by solving the Algebraic Ricatti Equation (ARE):

0=A^{T}S+SA−BR⁻¹B^{T}S+Q (13)

The time varying matrix S(t) becomes static and is replaced in (12) to find a suboptimal feedback matrix K. LQR controllers demonstrate to be a suitable solution for a wide variety of control problems due to the robust and stability properties that this controller possesses.

Nonlinear controllers have a higher mathematical complexity compared to classical control methods. Nonlinear controllers for the V-I control level may be divided into sliding mode controllers, feedback-linearization based controllers, and hysteresis controllers. These controllers also require more computational resources compared to other control methods. Additionally, there are limitations on the performance analysis of these methods. For these reasons, nonlinear controllers are out of the scope of this research work.

Finally, robust control strategies are used to design controllers that consider uncertainties that may affect stability or performance. In this control strategy, it is important to have a clear definition of the uncertainty bounds and performance bounds. Some of the most used robust control strategies for V-I control are H_{∞} control and μ-synthesis.

H_{∞} Controllers:

These controllers formulate the control problem as an optimization problem where the best performance of a predefined frequency response is synthesized. A typical robust control block diagram is shown in FIG. 10. Signals M(s) and D(s) represent disturbances in measurements and process respectively. Signals R(s) and Y(s) represent reference and output signals respectively. The equation that defines the output is then given by:

$$Y ( s ) = \frac{D ( s )}{I + K ( s ) G ( s )} + \frac{K ( s ) G ( s )}{I + K ( s ) G ( s )} [ R ( s ) - M ( s ) ] \qquad ( 14 )$$

From (15), one can notice that the output is affected directly by disturbances in the process and disturbances in the measurements through different transfer functions. By defining the sensitivity S(s), co-sensitivity T(s), and open-loop L(s) transfer functions:

$$\begin{matrix}S ( s ) = {[ I + K ( s ) G ( s ) ]}^{- 1} & ( 15 ) \\ T ( s ) = \frac{K ( s ) G ( s )}{I + K ( s ) G ( s )} & ( 16 ) \\ L ( s ) = K ( s ) G ( s ) & ( 17 )\end{matrix}$$

equation (15) can be written as Y(s)=S(s)D(s)+T(s)[R(s)−M(s)]. Thus, it can be noticed that S(s) affects the influence of process disturbances on closed-loop system output. Similarly, T(s) affects the influence of measurement disturbances on closed-loop system output. Thus, one can design a controller K(s) to have a desired behavior on T(s) or S(s). Note also that, from the definitions of T(s) and S(s):

T(s)+S(s)=I (18)

This implies that T(s) and S(s) are complementary functions. Typically, process disturbances are of low-frequency nature while measurement disturbances are of high-frequency nature. Thus, T(s) is designed to behave as a low-pass filter while S(s) is designed to be a high-pass filter.

In H_{∞} control, the infinity norm of the sensitivity and co-sensitivity transfer functions are minimized according to some predefined weighting functions W₁ and W₂. The H_{∞} problem may be defined by:

$${min}_{K} {‖ \begin{matrix}{W}_{1} S \\ {W}_{2} T\end{matrix} ‖}_{∞} \qquad ( 19 )$$

Where the operator ∥⋅∥_{∞} is defined as the infinity norm and represents the maximum gain on certain frequency response. This approach is suitable to define a desired frequency response of a multivariable system. It is common to use H_{∞}, controllers to generate a behavior similar to PR controllers. The drawbacks of the H_{∞} controllers include high computational costs and high sensitivity to nonlinearities.

μ-Synthesis Controllers:

This controller is based on H_{∞} control and uses Linear Matrix Inequalities (LMI) to define a robustness bound where stability and performance can be achieved. Iterative methods can be used or even optimization methods like the LQR, Particle Swarm Optimization, or the Glover-Doyle algorithm.

There are other control strategies such as intelligent control, predictive, and adaptive control that may be found in literature for inverter V-I control. However, these strategies are not considered due to the lack of techniques to analyze their stability and performance parameters compared to the strategies previously mentioned.

Power Sharing Control (Primary Control Level)

The primary control level regulates power sharing from each DG to the common AC bus. Also, the primary control level may extract the maximum power from the RES to inject it to the main grid. Typically, in AC systems, power may be divided into active and reactive power. In “Generalized instantaneous reactive power theory for three-phase power systems”, Fang Zheng Peng and Jih-Sheng Lai, IEEE Trans. Instrum. Meas., vol. 45, no. 1, pp. 293-297, 1996, the author presents a generalized theory for calculating instantaneous active and reactive power for three phase systems. This approach is suitable for sinusoidal or non-sinusoidal, balanced or unbalanced, with or without zero sequence currents and voltages. FIG. 11 shows a three-phase voltage source connected to a load or a network that could represent the common AC bus. Voltages Va, Vb, and Vc are referenced to ground.

The instantaneous active power can be defined as the dot product between voltage and current vectors as follows:

P=v·i=vₐiₐ+v_{b}i_{b}+v_{c}i_{c} (20)

Similarly, the instantaneous reactive power can be defined as the cross product between voltage and current vectors as follows:

$$Q = v \times i = [ \begin{matrix}\vert \begin{matrix}{v}_{b} & {v}_{c} \\ {i}_{b} & {i}_{c}\end{matrix} \vert \\ \vert \begin{matrix}{v}_{c} & {v}_{a} \\ {i}_{c} & {i}_{a}\end{matrix} \vert \\ \vert \begin{matrix}{v}_{a} & {v}_{b} \\ {i}_{a} & {i}_{b}\end{matrix} \vert\end{matrix} ] \qquad ( 21 )$$

Active and reactive power may be related by the definition of apparent power, which is defined by:

S=\sqrt{P²+Q²} (22)

From these expressions, it can be concluded that the instantaneous active and reactive power represent two orthogonal vectors and their dot product is equal to zero. To expand this concept, the active and reactive instantaneous power can be also written in the αβ0 domain:

P=v_{αβ0}·i_{αβ0}=v_{α}i_{α}+v_{β}i_{β}

Q=v_{αβ0}×i_{αβ0}=v_{α}i_{β}−v_{β}i_{α} (23)

or in matrix form: PG,

$$[ \begin{matrix}P \\ Q\end{matrix} ] = [ \begin{matrix}{v}_{α} & {v}_{β} \\ - {v}_{β} & {v}_{α}\end{matrix} ] [ \begin{matrix}{i}_{α} \\ {i}_{β}\end{matrix} ] \qquad ( 24 )$$

If the output voltage and current are in phase due to a resistive load, reactive power components in (24) will cancel out and the power consumption would be purely active. On the other hand, if the output voltage and current have a phase shift of π/4 rad due to a purely capacitive or inductive load, the active power components will cancel out and the power consumption will be purely reactive. Thus, reactive power is the power that is not consumed by the load and is exchanged between AC sources and reactive components. This implies that reactive power does not contribute to energy transfer between two systems but causes energy losses in transmission lines. To analyze power sharing among DGs, an electrical analysis must be done. FIG. 12 shows an AC inverter generator connected to an AC stiff voltage source which may be represented by the main grid or the microgrid common AC bus.

In a system as in FIG. 12, the active power P and the reactive power Q received by the main grid are given by:

$$\begin{matrix}P = \frac{1}{{R}^{2} + {X}^{2}} ( R {E}^{2} - REV cos δ + XEV sin δ ) & ( 25 ) \\ Q = \frac{1}{{R}^{2} + {X}^{2}} ( X {E}^{2} - X E V cos δ - REV sin δ ) & ( 26 )\end{matrix}$$

Where δ represents the phase shift between AC sources. Equations (26) and (27) show that the active and reactive power depend on a nonlinear function of the voltage amplitude of both AC sources and the phase shift between them. This implies that the active and reactive power may be controlled by changing δ and E. With this concept in mind, primary control main objectives include:
Regulate active and reactive power sharing according to the rated power of each DG. This task should be done preferably without communications.
Inject a determined amount of active and reactive power to the main grid when working in grid connected mode.
Mitigate overcurrent events that may damage energy conversion systems.

To address these objectives, many approaches have been published in the last decade. These may be divided into communication-based controllers and autonomous controllers. Communication-based controllers may be separated into centralized, master-slave, average load sharing, and circular chain methods. Communication-based controllers lack of reliability and robustness due to their high dependence on constant communication between DGs. On the other hand, autonomous controllers are demonstrated to be more reliable and represent most of the published work in the last decade regarding decentralized microgrid power sharing control strategies.

Autonomous controllers are based on the well-known droop control method, where a synchronous machine behavior is emulated without the need of communication between generators. In a synchronous machine, the voltage frequency is reduced when active power demand increases. Similarly, the voltage amplitude is reduced when reactive power demand increases. To share active and reactive power from the inverter to the common AC bus or another DG without communication, the droop characteristics of the synchronous power generators may be emulated using equations (28) and (29):

ω=ω₀−m(P−P₀) (27)

E=E₀−n(Q−Q₀) (28)

Where P₀, Q₀, ω₀, and E₀ are the nominal values of the active power, reactive power, operating frequency, and amplitude respectively. Coefficients m and n represent the droop rates and are directly related to the power generation capability of each DG. The droop control curves for active and reactive power sharing are shown in FIG. 13.

When there are two or more DGs with droop control and connected as shown in FIG. 14, both generators will reduce their frequency and amplitude according to their active and reactive droop curves. The steady state is reached when all generators reach the same frequency and AC bus voltage is stablished.

FIG. 15 shows a typical hierarchical control diagram for primary control. A V-I control loop is used to guarantee a sinusoidal voltage amplitude E with a frequency ω, both generated by the primary controller. The primary droop controller contains a Power Calculation Block with a low-pass filter to calculate the mean value of the active and reactive powers P and Q. The Reference Generator generates a sine wave signal with a frequency a and a voltage amplitude E according to the output of the two droop controllers (P and Q).

Droop control offers reliability to microgrid systems because it does not need communication between generators. However, some of the drawbacks of this method include:

Lack of controllability: Droop control makes a direct relationship between delivered active power and phase lag. In the same way, there is a direct relationship between reactive power and the signal amplitude. The conventional droop method assumes that there is independence between active and reactive power. This means that both active and reactive power can only be controlled by using a single input variable respectively (frequency and voltage). This implies that it is difficult to meet two or more control objectives at the same time. For example, there is a tradeoff between the settling time of the controlled system and the voltage and frequency regulation.

Voltage and frequency deviations: As the droop control is based on a common reduction of voltage and frequency, small deviations from the operating point occur when the whole microgrid reaches the steady state of delivered power among DGs.

Prior knowledge of the line impedance is required: Conventional droop method assumes that the power is shared across a highly inductive transmission line. This is true for large transmission systems. However, some microgrids sharing low-voltage power may experiment highly resistive transmission lines, which challenges this assumption.

Reactive power may affect voltage regulation: Since reactive power is controlled by changing signal amplitude and this amplitude may vary across generators, there may be undesired voltage behavior when reactive power changes drastically with critical loads. Lack of controllability for distortion power: Distortion power is generated by the presence of harmonic currents caused by nonlinear loads. Conventional droop methods do not measure distortion power and are unable to control the amount of distortion power shared to the microgrid.

Droop controllers may have many variations according to the microgrid operating mode, topology, voltage levels, etc. A complete review of most of the published droop controller variations is presented in “Review of Power Sharing Control Strategies for Islanding Operation of AC Microgrids”, H. Han, X. Hou, J. Yang, J. Wu, M. Su, and J. M. Guerrero, IEEE Trans. Smart Grid, vol. 7, no. 1, pp. 200-215, January 2016. Typically, power sharing controllers use classic PI controllers to regulate transient response. The use of optimal control methods is not widely used due to the mathematical complexity in primary control level. Additionally, it is difficult to formulate the power sharing problem in a state-space domain to formulate optimal or robust control strategies such as LQR, PSO, H_{∞}, or LMI.

Amplitude and Frequency Restoration Control (Secondary Control)

Primary control level regulates power sharing across DGs. When the microgrid is operating in islanded mode without communication, there is no main grid voltage reference to track. This absence of reference causes voltage and frequency deviations on the common AC bus. To compensate these deviations, a secondary control level is used to restore microgrid's frequency and voltage to their nominal values. Also, the secondary control level compensates the generation in case of transmission line unbalances.

A typical scheme of a secondary control level to recover voltage and frequency in a two-generator islanded microgrid is shown in FIG. 16. The secondary controller reads frequency and voltage amplitude (ω_{μG} and E_{μG}) from the common AC bus and generates a compensation signal (Δω_{sec} and ΔE_{sec}) that will be used by the primary controller to recover voltage and frequency nominal values in the common AC bus. One of the main drawbacks of secondary control is the necessity of local communication between DGs. However, this communication is more reliable than the one needed in primary control due to the slow dynamics of secondary control. The slow dynamics allow using low speed communication technologies, which are easier to implement. Also, the slow dynamics in secondary control allows decoupling with primary and V-I control levels. Typically, secondary controllers are based on classic controllers such as P, PI or PID due to their slow dynamics. Also, these controllers are more focused on improving microgrid's power quality and do not consider dynamics and robustness properties.

Microgrid Power Sharing Control (Tertiary Control)

Tertiary control level regulates the active and reactive power sharing between the entire microgrid and the main grid. Considering the microgrid scheme shown in FIG. 2, the tertiary control reads the power flowing from the microgrid to the main grid. Then, according to the control objective, the tertiary control sends a reference value to the secondary control level in order to modify microgrid's common AC bus voltage and frequency to regulate power sharing to the main grid.

The Tertiary control level also manages resources and costs. For example, the Tertiary controller may communicate with each DG or ESU to decide when it is needed to charge the batteries or inject the produced power to the main grid. Usually, the Tertiary controller is designed to optimize costs, energy availability, battery life cycle, etc. To solve these optimization problems, heuristic methods are usually used combined with PSO techniques and intelligent control techniques. Due to the fact that Tertiary control is not focused on improving microgrid's dynamics and robustness, this control level is out of the scope of this invention.

Microgrids are emerging as a viable alternative to integrate RES to the conventional energy transmission and distribution system. As previously discussed, requirements such as power quality, stability, and robustness may be achieved with the use of hierarchical control. However, many challenges must be addressed in order to increase the use of microgrids in conventional energy distribution systems. First, it must be considered that inverters have a relative low inertia compared to the conventional high-powered synchronous generators. This low inertia makes microgrids sensitive to high-frequency disturbances and harmonic distortion under nonlinear loads. Second, the power sharing control has many complex challenges that are mainly related to transmission line properties and tradeoffs between voltage regulation and reactive power sharing. Third, power quality may be affected due to voltage and frequency deviations caused by primary control. Finally, microgrid integration requires a strong standardization base that includes policies, electrical standards, communication protocols, community socialization, etc.

In order to understand the novel aspect of the present invention, a literature review about the main trends in V-I and Primary control for AC microgrids is provided. The works that are discussed are analyzed from a control systems point of view considering characteristics such as control methodology, stability, robustness, frequency response, and power quality.

Voltage and Current Control (V-I Control)

The V-I control level regulates the output voltage or current according to microgrid requirements. Typically, voltage control is used for islanded microgrids due to the direct relationship between voltage amplitude and phase with active and reactive power sharing. On the other hand, current control is mainly used for grid connected microgrids, where the main grid has a stiff nature and no output voltage formation is required to inject a determined amount of power. Control methods discussed below are divided into classical controllers, optimal controllers, and robust controllers. Some of these methods are developed in a stationary reference frame and some of them in a synchronous reference frame.

Classical Controllers

Classical controllers are used due to their straightforward implementation. Generally, classical controllers avoid complex mathematical designs and only require a fine tuning on each of their gains. A typical example of a classical controller in hierarchical control is shown in “Modeling, analysis, and design of stationary-reference-frame droop-controlled parallel three-phase voltage source inverters”, J. C. Vasquez, J. M. Guerrero, M. Savaghebi, J. Eloy-Garcia, and R. Teodorescu, IEEE Trans. Ind. Electron., vol. 60, no. 4, pp. 1271-1280, 2013. In this work, a complete hierarchical control structure for a microgrid in a stationary αβ reference frame is presented. This structure for V-I control used is shown in FIG. 17. The authors used two PR controllers to guarantee adequate voltage tracking and current sharing.

In addition, a set of resonant filters are used in the voltage and current control loops to suppress harmonic distortion in voltage and to guarantee sharing of harmonic currents. Both controllers Gᵥ(s) and G_{I}(s) are defined by the following transfer function:

$${G}_{v , I} ( s ) = {k}_{P} + \frac{{k}_{R} s}{{s}^{2} + {ω}_{0}^{2}} + {\sum }_{{k}_{h} = 5 , 7 , 11} \frac{{k}_{h} s}{{s}^{2} + {( {k}_{h} {ω}_{h} )}^{2}} \qquad ( 29 )$$

Where kₕ and ωₕ represent the resonant gain and angular frequency of the harmonic h. The addition of the resonant filters at harmonics 5, 7, and 11 allow controllers to perfectly track reference signal at those frequencies. For the voltage controller, the references at harmonics 5, 7, and 11 are zero, which improves THD. For the current controller, the current references generated by the voltage controller are perfectly tracked to improve harmonic current sharing to the common AC bus. The approach previously proposed demonstrates adequate results in all control levels of a microgrid. However, no stability or robustness analysis is performed. Also, the gain values of the voltage and current controllers were found by trial and error and do not guarantee the best performance or robustness characteristics.

Similar approaches to the previously discussed have been widely used in literature as a base to design further control levels due to the ease of implementation and the assumption that the dynamics of the V-I control level are considerably faster than the dynamics of the Primary control level. Furthermore, the same analysis previously explained can be applied to a synchronous dq frame. In dq frame, the PR controller is replaced by a PI controller and harmonic frequencies are displaced to the left of the spectrum by ω₀. Some of the applications of PI controllers for the V-I control level are presented in: M. Hao and X. Zhen, “A control strategy for voltage source inverter adapted to multi—Mode operation in microgrid,” Chinese Control Conf. CCC, pp. 9163-9168, 2017; A. Tuladhar, H. Jin, T. Unger, and K. Mauch, “Parallel operation of single-phase inverter modules with no control interconnections,” in Proceedings of APEC 97—Applied Power Electronics Conference, 1997, vol. 1, pp. 94-100; E. A. A. Coelho, P. C. Cortizo, and P. F. D. Garcia, “Small signal stability for single phase inverter connected to stiff AC system,” Conf. Rec. 1999 IEEE Ind. Appl. Conf. Thirty-Forth IAS Annu. Meet. (Cat. No. 99CH36370), vol. 4, pp. 2180-2187, 1999; N. Pogaku, M. Prodanović, and T. C. Green, “Modeling, analysis and testing of autonomous operation of an inverter-based microgrid,” IEEE Trans. Power Electron., vol. 22, no. 2, pp. 613-625, 2007; and W. Xiao, P. Kanjiya, J. L. Kirtley, N. H. Kan'an, H. H. Zeineldin, and V. Khadkikar, “A modified control topology to improve stability margins in micro-grids with droop controlled IBDG,” in 3rd Renewable Power Generation Conference (RPG 2014), 2014, pp. 5.2.2-5.2.2.

In “PI state space current control of gridconnected PWM converters with LCL filters”, J. Dannehl, F. W. Fuchs, and P. B. Thøgersen, IEEE Trans, Power Electron., vol. 25, no. 9, pp. 2320-2330, 2010, a state-feedback current controller design using the pole placement method is presented. The controller is designed for grid-connected three-phase inverters using an LCL filter in a synchronous dq frame. The controller also uses another loop with a PI controller to guarantee perfect tracking of the internal inductor current as shown in FIG. 18.

This controller is designed in three main steps: first, the desired closed loop poles are computed according to the desired overshoot and settling time. Second, the PI and state-feedback gains are computed to achieve the desired closed-loop poles. Finally, an extra harmonic compensation is added to the PI controller. This controller shows suitable results with a low harmonic distortion and acceptable tracking. However, it must be noticed that the controller is developed for a grid connected converter. This means that voltage harmonic distortion is low because the main grid is capable of delivering all the harmonic power to the nonlinear loads. Also, this work lacks stability and robustness analysis against disturbances in the process or measurements.

In “Current Controller Based on Reduced Order Generalized Integrators for Distributed Generation Systems”, C. A. Busada, S. Gomez Jorge, A. E. Leon, and J. A. Solsona, IEEE Trans. Ind. Electron., vol. 59, no. 7, pp. 2898-2909, 2012, a modification of the PR controller is made by the use of the αβ frame to integrate both components as a complex variable. It means that the control input can be expressed as \vec{u}_{αβ}=u_{α}+ju_{β}. This way, a new resonant filter (ROGI) can be expressed as a first-order transfer function as shown in (31).

$${\vec{y}}_{α β} = \frac{{\vec{u}}_{α β}}{p - j {ω}_{0}} \qquad ( 30 )$$

Where p is known as the complex derivative operator. This analysis can be translated to the dq frame due to the orthogonality between d and q axes. This approach demonstrates to be computationally lighter than the classical resonant filter. However, it is more difficult to implement since the ROGI only works for positive-sequence signals. This means that the resonant filter is unable to work under line unbalances or grid faults.

In “A conflict in control strategy of voltage and current controllers in Multi-Modular single-phase UPS inverters system”, S. K. Singh and S. Ghatak Choudhuri, 2017 10th Int. Symp. Adv. Top. Electr. Eng. ATEE 2017, pp. 631-636, 2017, a PR controller to correct circulating currents in a multi-modular UPS single phase inverter system is presented (FIG. 19). The author proposes to calculate the average output current and use it as a feedback and feedforward signal. This modification adds controllability to the circulating current impedance to modify the frequency response and minimize the circulating current between inverters. Results show adequate response in minimizing circulating currents. However, this implementation requires the mean value of all the output currents for all UPS inverters. This means that all UPS inverters require local intercommunication to a central measuring unit.

Most of the approaches in classical control for V-I control level use PI or PR controllers due to the ease of implementation. In this literature review, no other Laplace-domain controllers such as Lead or Lead-Lag were found. Lead-Lag controllers provide further benefits that would be interesting to analyze in microgrid V-I control.

Optimal Controllers

Optimal controllers are characterized by the use of numerical methods to achieve the best value of a predefined cost function. Some of the most popular optimal control strategies include Linear Quadratic control, Particle Swarm optimization, Kalman filter estimators, etc.

In “Control of distributed generation systems—Part I: Voltages and currents control”, M. N. Marwali and A. Keyhani, IEEE Trans. Power Electron., vol. 19, no. 6, pp. 1541-1550, 2004, an optimal V-I control approach for a three-phase inverter using the dq frame is presented. The author uses a “Perfect Servo” controller (RSP) where a set of resonant filters is used to guarantee perfect tracking and minimize THD. The diagram illustrated in FIG. 20, shows the proposed block diagram for this solution. The set of resonant filters G_{RES}(S) are combined with a state-feedback controller K₁ that is computed using an LQR optimization method. The state-feedback controller K₁ is used to find the optimal values of each of the resonant filter gains.

The state-feedback controller K₂ is used to achieve stability and needs five state vectors which include the output voltage, output current, load voltage, load current, and the delayed control signal. This implies that the controller requires to measure voltage and current at the load side, which is not always practical in microgrid applications.

A similar approach was developed in “Control of three-phase voltage source inverter for renewable energy applications”, S. Eren, A. Bakhshai, and P. Jain, 2011 IEEE 33rd Int. Telecommun. Energy Conf., pp. 1-4, 2011, where an optimal LQR controller is used to find the values of the PR controller gains that guarantee the least amount of energy losses on a three-phase inverter connected to the main grid. The three-phase inverter was coupled with an inductive-resistive impedance to the main grid. Thus, a current controller was proposed to regulate the amount of power delivered to the main grid. The current reference was computed by dividing the desired instantaneous power (sum of the active and reactive power) by the grid voltage. Then, a PR controller with the following transfer function was used:

$${G}_{c} ( s ) = \frac{{α}_{1} s + {α}_{2}}{{s}^{2} + {ω}_{n}^{2}} \qquad ( 31 )$$

Where α₁ and α₂ are the parameters to be optimized using the LQR method. Simulation results show adequate performance of power sharing and current regulation. This approach shows a suitable way to integrate the V-I and primary control levels. However, further analysis needs to be done about sharing of harmonic currents when working in islanded mode.

Following this work, the same author shows in “Control of grid-connected voltage source inverter with LCL filter”, S. Eren, A. Bakhshai, and P. Jain, 2012 Twenty-Seventh Annu. IEEE Appl. Power Electron. Conf. Expo., pp. 1516-1520, 2012 a LQR controller to adjust the PR gains for a three-phase voltage source inverter in the ABC frame. The author augments the states of the system with a resonant filter at the nominal frequency. The objective of this approach is to attenuate the resonant peak in an LCL filter frequency response and optimize the energy by computing the optimal PR gains. Although this approach shows suitable results, its implementation is only valid for grid connected inverters with no harmonic distortion. Thus, the Primary control can be implemented quite straightforward because the system behavior can be easily predicted.

In “State-feedback controller and observer design for grid-connected voltage source power converters with LCL-filter”, C. Dirscherl, J. Fessler, C. M. Hackl, and H. Ipach, 2015 IEEE Conf. Control Appl. CCA 2015—Proc., pp. 215-222, 2015, an LQG current controller for a grid connected three-phase inverter was developed. The block diagram of the LQG controller is shown in FIG. 21. The LQR synthesized the optimal PI control gains for the plant model in the dq reference frame. A grid voltage feedforward control/compensation (GVFC) method and a filter current decoupling control (FCDC) where developed to compensate grid unbalances and correct the coupling between d and q voltage components.

A Kalman filter that considers the grid voltage as a disturbance to estimate output current was also developed as shown in FIG. 22. The Kalman filter is a Luenberger observer that minimizes the variance of the measurement error to synthesize an optimal Kalman gain L. The complete development of the Kalman filter may be found in F. L. Lewis, D. L. Vrabie, and V. L. Syrmos, Optimal Control. Hoboken, N.J., USA: John Wiley & Sons, Inc., 2012.

The approach previously presented shows acceptable results. However, the controller was developed to track a current signal in a grid connected environment. For islanded microgrids it is necessary to implement a voltage control without having the grid voltage. This implies that primary and secondary control need to be addressed. Also, in islanded microgrids, the harmonic power sharing becomes a noticeable problem. A deeper analysis needs to be done for the performance of Kalman filters with nonlinear loads in islanded microgrids.

In “LQG servo controller for the current control of LCL grid-connected Voltage-Source Converters”, F. Huerta, D. Pizarro, S. Cóbreces, F. J. Rodríguez, C. Girón, and A. Rodríguez, IEEE Trans. Ind. Electron., vol. 59, no. 11, pp. 4272-4284, 2012, a comprehensive method to develop an LQG current controller for a three-phase inverter connected to the grid is presented. The LQG integrates a Kalman filter estimator and an LQR controller with a servo controller. The whole work was developed on the dq reference frame. The controller was developed to integrate the DC-link voltage with the output current. This application is suitable for solar panel applications injecting power to the grid. In case of a sudden drop in the DC-link voltage occurs, the current reference on the LQG controller drops as well to maximize the power delivery to the grid. The most interesting concept in this work is the development of a Kalman filter using the grid voltage as a disturbance to increment estimation accuracy. The author merged the input vector with the grid voltage to generate an input vector for the Kalman filter and obtain accurate values of the capacitor voltage and inductor currents. Another relevant contribution from this work is the comprehensive algorithm for developing an LQG controller for this application. However, the analysis of this work was performed by injecting noise to the system and it does not consider the effects of harmonic currents caused by the presence of nonlinear loads.

In “Improvement of stability and load sharing in an autonomous microgrid using supplementary droop control loop”, R. Majumder, B. Chaudhuri, A. Ghosh, R. Majumder, G. Ledwich, and F. Zare, IEEE Trans. Power Syst., vol. 25, no. 2, pp. 796-808, 2010, a V-I controller was calculated using an LQR controller with a full-state feedback gain that was multiplied by the tracking error of each state as shown in FIG. 23. This means that this controller not only requires all states, but also requires all the reference signals, including the input and output current reference signals. The input and output reference signals were defined to be a pure sine wave, which may cause stability problems when sharing harmonic power through the common bus caused by the presence of nonlinear loads.

In “Optimal and Systematic Design of Current Controller for Grid-Connected Inverters”, S. A. Khajehoddin, M. Karimi-Ghartemani, and M. Ebrahimi, IEEE J. Emerg. Sel. Top. Power Electron., vol. 6, no. 2, pp. 1-1, 2018, a systematic design of a current controller for grid connected inverters is performed. In this work, the author proposes an optimal LQR controller based on the well-known “Internal Model Principle” (IMP) where the reference signal dynamics are integrated into the system to guarantee perfect tracking. A resonant filter realization is presented as follows:

$${A}_{c} = [ \begin{matrix}0 & - {ω}_{g} \\ {ω}_{g} & 0\end{matrix} ] , {B}_{c} = [ \begin{matrix}1 \\ 0\end{matrix} ] \qquad ( 32 )$$

Once the system is augmented with the resonant dynamics, the entire system is multiplied by the expression D(s)=s²+ω_{g}². Since the reference input is a pure sine wave and the grid voltage is a pure sine wave as well, there are components on the system dynamics that become zero. This operation allows to simplify calculations and also allows to select the derivative of the tracking error as a state variable to improve system controllability.

Similarly, in “Optimal LQR-based multi-loop linear control strategy for UPS inverter applications using resonant controller”, A. Hasanzadeh, C. S. Edrington, B. Maghsoudlou, and H. Mokhtari, Proc. IEEE Conf. Decis. Control, pp. 3080-3085, 2011, an optimal LQ tracker was developed by generating a modified quadratic cost function that depends on the tracking error and the modified input. The input is modeled as a sinusoid and the state equations are modified using a second-order differential equation which become zero when a sinusoid is used as a reference. This way, the tracking problem is modified to a traditional regulator problem that may be solved using the classical LQR approach. Finally, the states are augmented with a resonant filter to guarantee perfect tracking and harmonic rejection at the output. This approach presents suitable results for reducing THD and tracking error. However, the entire system is designed in continuous time, which means that there are some dynamics that are not considered. Also, no robustness analysis is performed.

In “A linear quadratic tracking-based voltage controller for VSI; MVDC shipboard power system application”, M. Babaei, T. Qunais, and S. Abdelwahed, IEEE Power Energy Soc. Gen. Meet., vol. 2018-Janua, pp. 1-5, 2018, a voltage controller based on LQR method with optimal tracking in the αβ frame was developed. The author augments the system with a resonant controller at the nominal frequency to guarantee perfect tracking. In addition, the author makes a transformation for sinusoid signals on the output to transform the tracking problem into a regulator problem.

In “Load Current Decoupling Based LQ Control for Three-Phase Inverter”, X. Quan, Z. Wu, X. Dou, M. Hu, and A. Q. Huang, IEEE Trans. Power Electron., vol. 33, no. 6, pp. 5476-5491, 2018, a state-feedback LQR voltage controller for decoupling load current on a three-phase inverter is presented. The controller is designed on the αβ framework with the states, inputs, and disturbances expressed as a complex number being α the real axis and β on the complex axis. This allows to use discrete-time complex resonant filters defined by:

$$\frac{x}{u} = {( z - {e}^{j ω {T}_{s}} )}^{- 1} {T}_{s} = \frac{{T}_{s}}{z - {e}^{j ω {T}_{s}}} \qquad ( 33 )$$

With x=x_{α}+jx_{β} and u=u_{α}+ju_{β} being the auxiliary complex state-variables for each resonant filter. This method reduces the number of auxiliary states and has infinite gain for positive sequence input variables. This means that the angle between a and fl is positive. The entire system is augmented with the control delay and resonant filters. The controller is designed using a linear quadratic index with the Linear Matrix Inequality method to restrict the optimal solutions to certain robustness parameter variations. This approach demonstrates adequate results. However, the mathematical complexity of working with complex variables makes the system vulnerable to nonlinearities and makes difficult the frequency analysis and numerical implementation.

In “Design and Analysis of an Optimal Controller for Parallel Multi-Inverter Systems”, X. Sun, L. K. Wong, Y. S. Lee, and D. Xu, IEEE Trans. Circuits Syst. II Express Briefs, vol. 53, no. 1, pp. 56-61, 2006, an optimal LQR approach is used to design a voltage controller for parallel connected inverters to a common resistive load using an LC filter. First, the author augments the voltage error signal with an integrator to minimize tracking error. Second, the author defines a cost function as:

J(t₀)=½x^{T}(T)S(T)x(T)+½∫ₜ_{₀}^{T}(u_{T}Wu+x^{T}Q₁x+(vᵣ−y)^{T}Q₂(vᵣ−y))dt (34)

Where W, Q₁, and Q₂ represent the weighting matrices of the input signal, the system states, and the tracking error respectively. Finally, the author makes a change of input variable by adding an oscillatory function with the Laplace transform of a sine wave. The control diagram of the controlled system is shown in FIG. 24. By selecting the weighting elements of Q₁ corresponding to the inductor current, the author may balance the current sharing among multiple inverters. This way, an integrated power sharing control strategy is implemented. However, this approach requires a communication signal with the load current to guarantee stability. Also, this control does not guarantee proper harmonic current sharing and reactive power regulation.

Optimal controllers demonstrate to be an effective method to improve V-I control level performance and stability. However, there are some important limitations regarding to system modeling and harmonic current sharing.

Robust Controllers

Robust controllers are used to improve or optimize stability margins of certain closed-loop system. Also, robust controllers may be used to reject some disturbances caused by uncertainties in the microgrid such as nonlinear loads, transmission faults, or unbalances.

H_{∞} controllers are often used to generate a desired frequency response on the closed-loop system shown in FIG. 10. In microgrid V-I control, H_{∞}, controllers are used to improve tracking error and reject harmonic disturbances caused by nonlinear loads. A robust controller using H_{∞}, control is proposed in S. Yang, Q. Lei, F. Z. Peng, and Z. Qian, “A robust control scheme for grid-connected voltage-source inverters” IEEE Trans. Ind. Electron., vol. 58, no. 1, pp. 202-212, 2011. The author defines the uncertainties in transmission line impedances as one of the major issues that affect stability in grid-connected inverters. Using a typical pole-zero map analysis, the author demonstrates that the inverter stability is critically affected as the transmission inductance increases and the line resistance decreases. This variation in line impedances is modeled as a linear fractional transformation system (LFT) to be analyzed for robustness bounds. The LFT shown in FIG. 25 is used to separate the system Σ(s) with the controller K(s) and disturbances Δ. Signals u(s) and y(s) represent input and output vectors. Signals r(s) and p(s) represent references and measurements respectively. Signals w(s) and z(s) represent auxiliary signals to connect the uncertainty matrix Δ.

The H_{∞} controller requires the definition of weighting functions for the sensitivity (S) and co-sensitivity (T) transfer functions which correspond to measurement and process uncertainties respectively. The weighting functions were defined to track the reference signal and attenuate uncertainties caused by transmission line variations. Once the weighting functions were defined, the author used the mixsyn MATLAB function (Mathworks, “Robust Control Toolbox.” 2018) to synthesize a robust controller that keeps the system stabilized under variations in line impedance. Although the work described above present an acceptable tracking error and disturbance rejection, this approach does not consider harmonic distortion because the controller is designed for grid-connected inverters.

In “Robust Hinf Control for Grid Connected PWM Inverters with LCL Filters”, M. Jr et al., Ind. Appl. (INDUSCON), 2012 10th IEEE/IAS Int. Conf., pp. 1-6, 2012, a robust current control design for grid connected inverters with LCL filters is presented. In this approach the author uses a polytopic model of the plant based on the maximum and minimal values of the line inductance. With the polytopic model, the states are augmented to consider variations on certain parameters of the plant. Also, this approach uses a Linear Matrix Inequality (LMI) with an H_{∞}, augmented restriction to guarantee robust performance of the regulator. The controller results in a state feedback gain with augmented states representing a resonant filter at the nominal frequency. Although this approach considers variations on the plant in islanded mode, this controller is not designed to ensure power quality and THD improvement under nonlinear loads.

The H_{∞} concept may be used to evaluate performance under certain variations using the μ-synthesis framework. In “Robust controller design for a single-phase UPS inverter using μ-synthesis”, T. S. Lee, K. S. Tzeng, and M. S. Chong, IEEE Proc.—Electr. Power Appl., vol. 151, no. 3, p. 334, 2004, a robust controller for a single-phase UPS inverter was developed. For this work, the author used a μ-synthesis analysis to evaluate the robustness, performance and tracking error of a voltage-controlled inverter. The μ-value or structured singular value is defined by:

$${μ}_{Δ} ( M ) := \frac{1}{min \{ \overline{σ} ( Δ ) \text{:} Δ ∈ Δ , det ( I - M Δ ) = 0 \}} \qquad ( 35 )$$

The μ-value may be interpreted as the smallest uncertainty Δ that causes instability on the feedback loop for the plant M. To obtain both stability robustness and tracking performance robustness, the following condition must hold:

μ_{Δ}(\hat{Σ}(jω))<1;∀ω≥0 (36)

Where \hat{Σ}(jω) is the transformation of the plant transfer function that must be separated from the uncertainties and coupled with the designed controller K(s). In FIG. 25, the LFT of the controlled system with uncertainties for the μ-framework analysis is shown. The author also proposes a controller using the D-K iteration algorithm (G. J. Balas, J. C. Doyle, K. Glover, A. Packard, and R. Smith, “Computation Visualization Programming For Use with MATLAB®® μ-Analysis and Synthesis Toolbox User's Guide,” 1984) to achieve an open-loop function that satisfies the control objectives for variations in inductances, capacitances and line impedances. This work sets a baseline to analyze performance of a V-I controller for microgrid applications under modeled uncertainties. In addition, the D-K iteration algorithm may be used to design a controller that fulfills the performance bounds set by the μ-framework.

In “Control design in μ-synthesis framework for grid-connected inverters with higher order filters”, N. A. Ashtinai, S. M. Azizi, and S. A. Khajehoddin, ECCE 2016—IEEE Energy Convers. Congr. Expo. Proc., pp. 1-6, 2016, the author designs a current controller using the μ-synthesis framework for a grid connected three-phase inverter. The μ-controller is designed to reject component and time delay uncertainties by using a LFT and the dkit MATLAB function (Mathworks, “Robust Control Toolbox.” 2018). The LFT parameterizes the desired uncertainty to allow users to analyze the variations in system's frequency response. Then, a set of weighting functions W₁(s) and W₂(s) are used to perform a loop shaping similar to H_{∞}, synthesis that meets the desired performance requirements and also stabilizes the system under defined uncertainties. For this work, the transfer function from reference to the tracking error (S(s)) was intended to guarantee tracking error at the fundamental frequency and reject harmonics 1, 3, 5, and 7. Harmonics are rejected using the product of resonant filters shown in (38) where k represents harmonic number and ω_{g} is the grid angular frequency.

$${W}_{1} ( s ) = \frac{4000}{s ( 0.0001 s + 1 )} {\prod }_{k = 1 , 3 , 5 , 7} \frac{{s}^{2} + 1000 s + {( k {ω}_{g} )}^{2}}{{s}^{2} + s + {( k {ω}_{g} )}^{2}} \qquad ( 37 )$$

This approach presents suitable results. However, the controller is only valid for grid-connected converters, where no frequency or amplitude deviations are present. Also, the controller is not intended to be integrated with a primary control for microgrid applications due to its stiffness to variations in nominal frequency caused by droop control strategies.

In “LMI-Based Control for Grid-Connected Converters With LCL Filters Under Uncertain Parameters”, L. A. Maccari et al., IEEE Trans. Power Electron., vol. 29, no. 7, pp. 3776-3785, July 2014, a Linear Matrix Inequality design method is used for the current control of a three-phase grid-connected inverter. The author defines a theorem based on the polytopic system robustness inequality. A polytopic system is a system that varies its dynamics according to finite number of values for one or more parameters. In this case, the author analyzed the minimum and maximum variation of line inductance and demonstrated sufficient conditions for robust stability. The work explained demonstrates a comprehensive method to design a controller under parameter variations. In addition, the author designed a set of discrete resonant controllers to regulate harmonic power delivery by integrating all the models into a single state-space model. A further analysis for islanded microgrids is required to have a deeper understanding of stability under grid voltage and frequency variations. Also, this approach could be relevant for designing a primary controller using state space approaches.

Finally, a different robust control approach may be found in “Seamless formation and robust control of distributed generation microgrids via direct voltage control and optimized dynamic power sharing”, Y. A. R. I. Mohamed, H. H. Zeineldin, M. M. A. Salama, and R. Seethapathy, IEEE Trans. Power Electron., vol. 27, no. 3, pp. 1283-1294, 2012, where a linear sliding mode controller is used to guarantee robustness under current disturbances for islanded microgrids. The sliding mode controllers are designed such that current disturbances are not contemplated around each of the sliding modes. In addition, an adaptive filtering approach is used to improve the THD and tracking error. Experimental results show adequate response, with a small tracking error, small THD, and stable active power sharing between DGs. It is important to note that V-I and Primary controllers were designed separated and none of the V-I control dynamics are considered when defining Primary controller. This separation may affect stability, robustness, and performance.

Robust controllers for islanded microgrids are suitable for analyzing the effect of uncertainties in microgrid stability and performance. In V-I control, robust controllers may be used to guarantee perfect tracking and to ensure power quality under different types of disturbances. Robust controllers can also be used to provide important measures about stability margins. These measures may be combined with other control methods to evaluate multiple control parameters. However, the use of robust controllers is not popular because the mathematical analysis may result complex and, in some cases, these controllers are only applicable to linear systems.

V-I Control Summary

In this literature review, a total of 26 publications about V-I control methods for microgrids where reviewed. Table 1 below shows a summary of these works. From these publications, 11 are from conference proceedings and 15 are from journals or IEEE Transactions. Most of the reviewed works are less than 10 years old and only relevant work is from 2004 and 2006 as shown by FIG. 26.

It is important to remark that most of the publications in microgrid V-I control are related to classical PI/PR controllers due to the ease of implementation with primary control level. Also, many publications about primary or secondary control levels do not include V-I control because they assume that this control is already done, and its dynamics will not affect other control levels.

Optimal control strategies are mainly represented by LQR or LQG controllers that augment the states of the plant with a PI/PR controller and optimize their gains. The use of PI/PR controllers or the augmentation of plants with PI/PR dynamics for optimal control has a deep impact on robustness margins due to the infinity gain nature of the PI/PR controllers under nominal frequency. Robust control strategies use LMI and μ synthesis to define a parameter that represents stability or performance margins. It is very common to find optimal control methods combined with robust control analysis theory in order to evaluate performance, robustness, and stability. Some of the most relevant challenges found in V-I control include harmonic compensation under nonlinear loads, improvement of robustness against plant variations and line unbalances, and stability improvement.

TABLE 1
Summary of Reviewed V-I Control Methods for Microgrids

| | | Type of | Citations | | | Control | |
|---|---|---|---|---|---|---|---|
| Ref. | Year | Publication | (Gscholar) | Controller | Frame | Variable | Mode |
| [26] | 2006 | Journal | 77 | Optimal-LQR | 3ϕ − ABC | Voltage | Islanded |
| [36] | 2013 | Journal | 398 | Classical-PR | 3ϕ − αβ | Voltage | Islanded |
| [66] | 2017 | Journal | 41 | Classical-PR | 3ϕ − αβ | Voltage | Islanded |
| [38] | 2017 | Conference | NA | Classical-PI | 3ϕ − DQ | Voltage | Islanded |
| [43] | 2010 | Journal | 229 | Classical-PI | 3ϕ − DQ | Current | Grid Connected |
| [44] | 2012 | Journal | 131 | Classical-PR | 3ϕ − αβ | Current | Grid Connected |
| [45] | 2017 | Conference | NA | Classical-PR | 1ϕ | Voltage | Islanded |
| [46] | 2004 | Journal | 294 | Optimal-LQR | 3ϕ − DQ | Voltage | Islanded |
| [47] | 2011 | Conference | 9 | Optimal-LQR | 3ϕ − ABC | Current | Grid Connected |
| [48] | 2012 | Conference | 14 | Optimal-LQR | 3ϕ − ABC | Current | Grid Connected |
| [49] | 2015 | Conference | 11 | Optimal-LQG | 3ϕ − DQ | Current | Grid Connected |
| [50] | 2012 | Journal | 60 | Optimal-LQG | 3ϕ − DQ | Current | Grid Connected |
| [51] | 2010 | Journal | 492 | Optimal-LQR | 3ϕ − DQ | Voltage | Islanded |
| [67] | 2015 | Conference | NA | Optimal-LQG | 3ϕ − DQ | Voltage | Islanded |
| [52] | 2018 | Journal | 5 | Optimal-LQR | 1ϕ | Current | Grid Connected |
| [53] | 2011 | Conference | 10 | Optimal-LQR | 1ϕ | Voltage | Islanded |
| [54] | 2018 | Conference | 2 | Optimal-LQR | 3ϕ − ABC | Voltage | Islanded |
| [55] | 2018 | Journal | NA | Optimal-LQR | 3ϕ − αβ | Voltage | Islanded |
| [56] | 2011 | Journal | 299 | Robust-H∞ | 3ϕ − ABC | Current | Grid Connected |
| [58] | 2012 | Conference | 17 | Robust-LMI | 1ϕ | Current | Grid Connected |
| [60] | 2004 | Conference | 43 | Robust-H∞ | 1ϕ | Voltage | Islanded |
| [62] | 2016 | Conference | 3 | Robust-μ | 1ϕ | Current | Grid Connected |
| [63] | 2014 | Journal | 56 | Robust-LMI | 1ϕ | Current | Grid Connected |
| [65] | 2012 | Journal | 74 | Robust-Sliding | 3ϕ − DQ | Voltage | Islanded |
| | | | | Mode | | | |

[26] X. Sun, L. K. Wong, Y. S. Lee, and D. Xu, “Design and Analysis of an Optimal Controller for Parallel Multi-Inverter Systems,” IEEE Trans. Circuits Syst. II Express Briefs, vol. 53, no. 1, pp. 56-61, 2006.
[36] J. C. Vasquez, J. M. Guerrero, M. Savaghebi, J. Eloy-Garcia, and R. Teodorescu, “Modeling, analysis, and design of stationary-reference-frame droop-controlled parallel three-phase voltage source inverters,” IEEE Trans. Ind. Electron., vol. 60, no. 4, pp. 1271-1280, 2013.
[38] M. Hao and X. Zhen, “A control strategy for voltage source inverter adapted to multi—Mode operation in microgrid,” Chinese Control Conf. CCC, pp. 9163-9168, 2017.
[43] J. Dannehl, F. W. Fuchs, and P. B. Thogersen, “PI state space current control of grid-connected PWM converters with LCL filters,” IEEE Trans. Power Electron., vol. 25, no. 9, pp. 2320-2330, 2010.
[44] C. A. Busada, S. Gomez Jorge, A. E. Leon, and J. A. Solsona, “Current Controller Based on Reduced Order Generalized Integrators for Distributed Generation Systems,” IEEE Trans. Ind. Electron., vol. 59, no. 7, pp. 2898-2909, 2012.
[45] S. K. Singh and S. Ghatak Choudhuri, “A conflict in control strategy of voltage and current controllers in Multi-Modular single-phase UPS inverters system,” 2017 10th Int. Symp. Adv. Top. Electr. Eng. ATEE 2017, pp. 631-636, 2017.
[46] M. N. Marwali and A. Keyhani, “Control of distributed generation systems—Part I: Voltages and currents control,” IEEE Trans. Power Electron., vol. 19, no. 6, pp. 1541-1550, 2004.
[47] S. Eren, A. Bakhshai, and P. Jain, “Control of three-phase voltage source inverter for renewable energy applications,” 2011 IEEE 33rd Int. Telecommun. Energy Conf., pp. 1-4, 2011.
[48] S. Eren, A. Bakhshai, and P. Jain, “Control of grid-connected voltage source inverter with LCL filter,” 2012 Twenty-Seventh Annu. IEEE Appl. Power Electron. Conf. Expo., pp. 1516-1520, 2012.
[49] C. Dirscherl, J. Fessler, C. M. Hackl, and H. Ipach, “State-feedback controller and observer design for grid-connected voltage source power converters with LCL-filter,” 2015 IEEE Conf. Control Appl. CCA 2015—Proc., pp. 215-222, 2015.
[50] F. Huerta, D. Pizarro, S. Cóbreces, F. J. Rodríguez, C. Girón, and A. Rodríguez, “LQG servo controller for the current control of LCL grid-connected Voltage-Source Converters,” IEEE Trans. Ind. Electron., vol. 59, no. 11, pp. 4272-4284, 2012.
[51] R. Majumder, B. Chaudhuri, A. Ghosh, R. Majumder, G. Ledwich, and F. Zare, “Improvement of stability and load sharing in an autonomous microgrid using supplementary droop control loop,” IEEE Trans. Power Syst., vol. 25, no. 2, pp. 796-808, 2010.
[52] S. A. Khajehoddin, M. Karimi-Ghartemani, and M. Ebrahimi, “Optimal and Systematic Design of Current Controller for Grid-Connected Inverters,” IEEE J. Emerg. Sel. Top. Power Electron., vol. 6, no. 2, pp. 1-1, 2018.
[53] A. Hasanzadeh, C. S. Edrington, B. Maghsoudlou, and H. Mokhtari, “Optimal LQR-based multi-loop linear control strategy for UPS inverter applications using resonant controller,” Proc. IEEE Conf. Decis. Control, pp. 3080-3085, 2011.
[54] M. Babaei, T. Qunais, and S. Abdelwahed, “A linear quadratic tracking-based voltage controller for VSI; MVDC shipboard power system application,” IEEE Power Energy Soc. Gen. Meet., vol. 2018-Janua, pp. 1-5, 2018.
[55] X. Quan, Z. Wu, X. Dou, M. Hu, and A. Q. Huang, “Load Current Decoupling Based LQ Control for Three-Phase Inverter,” IEEE Trans. Power Electron., vol. 33, no. 6, pp. 5476-5491, 2018.
[56] S. Yang, Q. Lei, F. Z. Peng, and Z. Qian, “A robust control scheme for grid-connected voltage-source inverters,” IEEE Trans. Ind. Electron., vol. 58, no. 1, pp. 202-212, 2011.
[58] M. Jr et al., “Robust Hinf Control for Grid Connected PWM Inverters with LCL Filters,” Ind. Appl. (INDUSCON), 2012 10th IEEE/IAS Int. Conf., pp. 1-6, 2012.
[60] T. S. Lee, K. S. Tzeng, and M. S. Chong, “Robust controller design for a single-phase UPS inverter using μ-synthesis,” IEEE Proc. —Electr. Power Appl., vol. 151, no. 3, p. 334, 2004.
[62] N. A. Ashtinai, S. M. Azizi, and S. A. Khajehoddin, “Control design in μ-synthesis framework for grid-connected inverters with higher order filters,” ECCE 2016—IEEE Energy Convers. Congr. Expo. Proc., pp. 1-6, 2016.
[63] L. A. Maccari et al., “LMI-Based Control for Grid-Connected Converters With LCL Filters Under Uncertain Parameters,” IEEE Trans. Power Electron., vol. 29, no. 7, pp. 3776-3785, July 2014.
[65] Y. A. R. I. Mohamed, H. H. Zeineldin, M. M. A. Salama, and R. Seethapathy, “Seamless formation and robust control of distributed generation microgrids via direct voltage control and optimized dynamic power sharing,” IEEE Trans. Power Electron., vol. 27, no. 3, pp. 1283-1294, 2012.
[66] Y. Han, P. Shen, X. Zhao, and J. M. Guerrero, “Control Strategies for Islanded Microgrid Using Enhanced Hierarchical Control Structure With Multiple Current-Loop Damping Schemes,” IEEE Trans. Smart Grid, vol. 8, no. 3, pp. 1139-1153, May 2017.
[67] M. Kabalan and P. Singh, “Optimizing a virtual impedance droop controller for parallel inverters,” IEEE Power Energy Soc. Gen. Meet., vol. 2015-Septe, 2015.

Power Sharing Droop Control (Primary Control)

Primary control level regulates power sharing between generators, loads, and main grid. Typically, shared power is divided into active and reactive power. Active and reactive power sharing strongly depends on the nature of the transmission line. Also, power sharing strategy varies drastically if the microgrid is operating islanded or grid connected. These characteristics make primary control a popular research topic. Many survey papers have been published in this area. Main contributions on primary control are focused on improving stability, transient response, decoupling between active and reactive power, harmonic power sharing, virtual impedance control, transition between islanded and grid-connected mode, and others.

Communication-based primary controllers rely on a link between generators to balance power sharing. These communication links may affect reliability and robustness against sudden changes in the microgrid. To address this problem, droop control methods emerge as a non-communicated alternative where all generators emulate the behavior of a synchronous generator. Thus, all inverters reduce their nominal frequency according to the demanded power until frequency is the same across the entire microgrid. To balance power generation, the rate of change in frequency may be defined according to the maximum rated power of each generator.

Classical Droop Control Methods

As previously explained, conventional droop control methods are used to distribute power generation proportionally across the microgrid without communication links. Shared power is divided into active and reactive power. Active power is related to the power that is consumed by the loads. On the other hand, reactive power is related to the exchange of energy between generators and loads.

Active and reactive power sharing theory is based on the work developed by Akagi et al. in 1984. This work proposes an effective approach to suppress reactive power from a transmission line by using a three-phase inverter. The author also emphasizes that the reactive power does not deliver energy to the load and, by the contrary, this energy is constantly exchanged between the generators and load. To suppress the reactive power from the grid and correct the power factor, the compensator estimates the active and reactive power and calculates the necessary current to generate the additive inverse of the reactive power. Taking the inverse in (25), the output current expression to suppress reactive power from the grid is given by:

$$[ \begin{matrix}{i}_{α} \\ {i}_{β}\end{matrix} ] = {[ \begin{matrix}{v}_{α} & {v}_{β} \\ - {v}_{β} & {v}_{α}\end{matrix} ]}^{- 1} [ \begin{matrix}0 \\ - Q\end{matrix} ] \qquad ( 38 )$$

The control currents i_{α} and i_{β} are then injected to the grid to suppress fundamental and harmonic components of reactive power. The work developed by Akagi et al. was has been used as a basis to study active and reactive power sharing in microgrids.

One of the first approaches on droop control was developed in “Parallel operation of single-phase inverter modules with no control interconnections”, A. Tuladhar, H. Jin, T. Unger, and K. Mauch, in Proceedings of APEC 97—Applied Power Electronics Conference, 1997, vol. 1, pp. 94-100. In this work, the author shares a load in a single-phase microgrid assuming a purely inductive transmission line as shown in FIG. 27.

This paper extends the droop control concept to single phase inverters which do not count with the dq transformation. This makes the designer work strictly under an oscillatory frame. Similar to the expressions in (26) and (27), the active and reactive power shared by each generator are defined by (40) and (41).

$$\begin{matrix}P = \frac{E V}{X} sin δ & ( 39 ) \\ Q = \frac{V ( E cos δ - V )}{X} & ( 40 )\end{matrix}$$

It can be noticed that for small phase shifts, cos δ≈1 and sin δ≈δ. This makes the active power directly proportional to the phase shift δ and reactive power directly proportional to the generator voltage amplitude E.

Equations (40) and (41) allow to use droop functions shown in (28) and (29) to regulate active and reactive power sharing proportionally to amplitude and phase shift. To guarantee proportional load sharing, the droop coefficients must be selected using the following expressions:

m₁S₁=m₂S₂=m₃S₃ . . . =mₖSₖ (41)

n₁S₁=n₂S₂=n₃S₃ . . . =nₖSₖ (42)

Where mₖ and nₖ represent the active and reactive droop coefficients for the k-th generator and Sₖ represent the rated apparent power in VA. The distortion power D may be related with apparent power by the following expression:

$${S}^{2} = {P}^{2} + {Q}^{2} + {D}^{2} = {E}_{1}^{2} {I}_{1}^{2} {cos}^{2} {Φ}_{1} + {E}_{1}^{2} {I}_{1}^{2} {sin}^{2} {Φ}_{1} + {E}_{1}^{2} {\sum }_{k} {I}_{k}^{2} \qquad ( 43 )$$

Where Iₖ is the harmonic current generated by the presence of nonlinear loads. To share distortion power, the author proposes to add a multiplicative block in the V-I control loop to modify the bandwidth according to the presence of nonlinear currents as shown in FIG. 28.

Results show that active power is shared proportionally. However, reactive power is not proportional because line impedances are different on each generator and are not purely inductive. This works sets a basis on the development of droop controllers for microgrid applications. However, further analysis is required to define stability in a microgrid with primary control.

Following the work shown in “Control of distributed generation systems—Part I: Voltages and currents control”, M. N. Marwali and A. Keyhani, IEEE Trans. Power Electron., vol. 19, no. 6, pp. 1541-1550, 2004, the author in M. N. Marwali, J.-W. Jung, and A. Keyhani, “Control of Distributed GenerationSystems—Part II: Load Sharing Control,” IEEE Trans. Power Electron., vol. 19, no. 6, pp. 551-1561, 2004, proposes a control strategy for power sharing using the classical droop method combined with the average power control method. This combination makes the system less sensitive to instantaneous voltage and current variations. In addition, the author proposes a harmonic power droop control method which measures the harmonic current to adjust the poles of the resonant filters. This work does not emphasize on the effects of including a harmonic power droop control and depends on the use of low band communication to perform the fundamental power sharing control.

In Small signal stability for single phase inverter connected to stiff AC system”, E. A. A. Coelho, P. C. Cortizo, and P. F. D. Garcia, “Conf. Rec. 1999 IEEE Ind. Appl. Conf. Thirty-Forth IAS Annu. Meet. (Cat. No. 99CH36370), vol. 4, pp. 2180-2187, 1999, Coelho presented a small signal stability analysis for a single-phase droop-controlled inverter connected to a stiff AC source. In this analysis, a resistive-inductive load is connected between the inverter and the stiff AC source as shown in FIG. 15. Assuming that in (26) and (27) the stiff AC source amplitude is V=120 Vrms, one may evaluate each of the powers to P₀ and Q₀ to obtain the nominal values of δ₀ and E₀. Using the following linearization function around the point p:

ƒ(x)≈ƒ(P)+∇ƒ|ₚ·(x−p) (44)

One may find the linearized expressions for P, Q, ω, and E:

ΔP=kₚₑΔE+k_{pd}Δδ (45)

ΔQ=k_{qe}ΔE+k_{qd}Δδ (46)

Δω=−mΔP (47)

ΔE=−nΔQ (48)

Where kₚₑ, k_{pd}, k_{qe}, and k_{qd} are constants resulting from evaluating the linearization function on the operating point p. Using a low-pass filter with cut-off frequency ω_{ƒ}, merging equations (46) to (49), and indicating that Δω(s)=sδ(s) one may define the following system:

$$\begin{matrix}Δδ ( s ) = - \frac{{k}_{p} {ω}_{f}}{s ( s + {ω}_{f} )} ( {k}_{p e} Δ E ( s ) + {k}_{p d} Δ δ ( s ) ) & ( 49 ) \\ Δ E ( s ) = - \frac{{k}_{v} {ω}_{f}}{s + {ω}_{f}} ( {k}_{q e} Δ E ( s ) + {k}_{q d} Δ δ ( s ) ) & ( 50 )\end{matrix}$$

The analysis performed is used to determine the stability of a droop-controlled inverter connected to a stiff AC source. This is done by analyzing the resulting eigenvalues of the system generated by equations (50) and (51). It can also be noticed that, for suitable values of m and n, the inverter frequency and voltage amplitude will converge to zero deviation from the linearization point p.

Following this work, Coelho presented in 2000 a similar small-signal stability analysis for two parallel connected inverters sharing power between them. In this work, a state-space representation of the entire linearized microgrid is developed in the dq frame. The entire system is described in (52):

Δ\dot{x}=A·Δx (51)

With ΔX=[Δω₁ ΔE_{d1} ΔE_{q1} Δω₂ ΔE_{d2} ΔE_{q2}]^{T}. States ΔE_{di} and ΔE_{qi} are the in-phase and quadrature nominal voltage in the dq frame for the i-th inverter and Δωᵢ is the frequency of each inverter. The state A=Mₛ+Cₛ(Iₛ+EₛYₛ)Kₛ is composed of matrices that are dependent of the droop coefficients, the nominal voltages, and the nominal currents vector.

Knowing the value of matrix A, the eigenvalues may be calculated to determine the stability and transient response of the entire system. It is also demonstrated that, for a stable matrix A, the frequency values will show a transient response until the desired values of P and Q are achieved and both frequencies become equal. After transient response, both frequencies may show a slight deviation from the nominal frequency, this means that a secondary control loop is required to recover the nominal frequency in both inverters simultaneously. Coelho work provide an effective method for analyzing stability in microgrids using droop method as a primary control strategy. However, this analysis does not consider the effects of the V-I control loop and does not allow to separate the droop controller and the system.

In “Modeling, analysis and testing of autonomous operation of an inverter-based microgrid”, N. Pogaku, M. Prodanović, and T. C. Green, IEEE Trans. Power Electron., vol. 22, no. 2, pp. 613-625, 2007, a complete microgrid was modeled using small-signal analysis. V-I and power sharing control levels where integrated to analyze their influence on microgrid stability. The complete system was modeled in three different parts: Inverter model, network model, and load model. In the inverter model, the V-I and primary droop control were considered together with the LCL output filter dynamics. In the network model, a network with m nodes and n resistive-inductive lines was considered. In the load model, a resistive-inductive load was modeled. Each of these models was written in such a way that the complete microgrid model may integrate them depending on the number of generators, network interconnections, and loads.

The complete model was analyzed using root locus method as shown in FIG. 29. It was discovered that there were three different relevant clusters in the microgrid's eigenvalues placement. The first cluster represented the faster cluster and is related to the inverter dynamics. Changing the values of the LCL filter affects these eigenvalues directly. The second cluster, slightly located at the right of the first cluster, represented the eigenvalues generated by the V-I controllers. These eigenvalues were affected directly by the proportional and integral/resonant constants of each of these controllers. The third and most important cluster is located closely to the vertical imaginary axes. These eigenvalues are directly affected by the line impedances and the droop control constants. Increasing the droop constants will move the eigenvalues to the positive semi-half plane and the microgrid will become unstable.

This approach shows relevant information regarding to microgrid stability using small signal analysis. However, the complete microgrid model relies entirely on the control topology and control constants. Generally, a dynamic system is modeled in such a way that the designer may couple it easily with some control strategy. However, in this approach, the control parameters are embedded into the microgrid model and changing them affects directly the analysis. Also, no formal stability analysis can be performed from an open-loop perspective because the microgrid model can only be developed considering the closed loop system.

Another important work regarding to microgrid stability with droop controllers is shown in “Some aspects of stability in microgrids”, R. Majumder, IEEE Trans. Power Syst., vol. 28, no. 3, pp. 3243-3252, 2013. The author divides microgrid stability in three main categories: Small signal stability, transient stability, and voltage stability. The small signal stability is mainly affected by the V-I and primary feedback controllers, where the control parameters affect system transient response and pole allocation. The use of feedback controllers with decentralized control methods such as droop control creates most of the small signal stability issues in islanded microgrids. This stability can be improved by using robust and optimal control techniques, supplementary control loops, coordinated control, and stabilizers such as flywheels. Transient stability is mainly affected in islanded mode, were frequency and voltage amplitude may be affected without a connection to a stiff grid. Transient stability is analyzed by using Lyapunov function techniques and nonlinear system analysis. Also, transient stability can be addressed by using energy storage and load shedding methods which allow to sustain the entire system when a sudden power loss is detected. Finally, voltage stability may be caused by irregular behavior in reactive load sharing or the connection of induction motors. Voltage stability can be addressed by injecting reactive power to the microgrid and compensate the sudden voltage drop.

Another approach for stability analysis in droop controllers is performed in “Dynamic Phasors-Based Modeling and Stability Analysis of Droop-Controlled Inverters for Microgrid Applications”, X. Guo, Z. Lu, B. Wang, X. Sun, L. Wang, “IEEE Trans. smart grid, vol. 5, no. 6, pp. 2980-2987, 2014, where a Dynamic Phasor Modeling (DPM) of the primary droop control of a microgrid is developed. The DPM concept is generated from the Fourier series:

$${\sum }_{k = - ∞}^{∞} {X}_{K} ( t ) {e}^{j k} {ω}_{s} τ \qquad ( 52 )$$

where ωₛ is the fundamental frequency and Xₖ(t) represents the k-th phasor at time t defined by:

$${X}_{k} ( t ) = \frac{1}{T} {\int }_{t - τ}^{r} x ( τ ) {e}_{s}^{j k {ω}_{s} τ} d τ = {〈 x 〉}_{k} ( t ) \qquad ( 53 )$$

where [symbol] x [symbol] ₖ(t) is the average k-th phasor over a time period T. The most important property of dynamic phasors is their time derivative, which is given by:

$$\frac{d {X}_{k} ( t )}{d t} = {〈 \frac{d x}{d t} 〉}_{k} ( t ) - j k {ω}_{s} {X}_{k} ( t ) \qquad ( 54 )$$

This implies that the voltage in an inductor may be given by:

$${v}_{L} = L ( \frac{d {i}_{L}}{d t} ) + j ω L {i}_{L} \qquad ( 55 )$$

with ω defined as the operating angular frequency. Note that in the conventional circuit theory, the term jωLi_{L} does not exists. This consideration makes the DPM of the inverter circuit more accurate than the conventional small signal analysis previously explained. A new active and reactive power model was developed, and its accuracy was compared to a complete order model and a small signal model. Results show adequate modeling in transient response and eigenvalue location. In addition, a virtual-frame droop control was tested with this model with more accurate results than previous work. However, this model does not consider the V-I control loop and makes difficult to analyze the coupling between real and imaginary components of power, current, and impedances. This modeling could result more effective when analyzing transient responses in a complete microgrid.

To improve transient response, a droop controller based on a small signal analysis and an extra phase shift control action was developed. The additional phase control action k_{d} adds an extra degree of freedom to adjust closed-loop poles in the power sharing controller. The new droop controller is given by:

$$Δ δ = ( - \frac{{k}_{p}}{s} - {k}_{d} ) Δ P \qquad ( 56 )$$

The interesting contribution in this approach is the use of a small-signal model to develop a droop controller. This small signal analysis may be used with optimal control strategies to improve transient response and guarantee robustness. Results show improvement on transient response. However, this implementation is only for grid connected inverters, where frequency and voltage do not deviate from the operating point.

In “Improvement of stability and load sharing in an autonomous microgrid using supplementary droop control loop”, R. Majumder, B. Chaudhuri, A. Ghosh, R. Majumder, G. Ledwich, and F. Zare, IEEE Trans. Power Syst., vol. 25, no. 2, pp. 796-808, 2010, a supplementary droop control loop for active power sharing is proposed. The purpose of this supplementary control loop is to improve stability caused by the selection of high droop gains. To do this, the authors added a new block that calculated the oscillatory response of the active power. Then, a set of lead-lag controllers were used to ensure a damped response under high values of droop gains. The entire system with the V-I and primary control was analyzed for stability. For this purpose, the author modeled the whole system in a dq frame. This allows to analyze the V-I control and the primary control in the same linear state system. The author states that the dynamics of the V-I control do not affect stability due to the high-bandwidth behavior. Also, the addition of the supplementary control loop modifies the eigenvalues to be away from the imaginary axis. However, the insertion of the supplementary control loop generates some nonminimum phase zeros which may affect the stability when using with higher control levels such as secondary or tertiary control. the author makes the analysis with the internal V-I controller already designed and does not propose a complete linear state system that could be used to synthesize an integrated PQVI controller.

Conventional droop controllers with proportional droop coefficients have a notorious oscillating transient response and steady state error. Also, there is a tradeoff between steady-state accuracy and transient oscillations, which may affect the V-I control loop stability. Transient oscillations also indicate an undesirable energy transfer between inverters. To address this problem, a PID control approach may be implemented on the droop controller according to the following expression:

$$\begin{matrix}δ = - m {\int }_{- ∞}^{r} P d τ - {m}_{p} P - {m}_{d} \frac{d P}{d t} & ( 57 ) \\ E = {E}^{*} - n Q - {n}_{d} \frac{d Q}{d t} & ( 58 )\end{matrix}$$

Note that

$$ω = \frac{d δ}{d t} ,$$

which means that when P reaches steady state, the derivative of (58) is equal to:

ω=−mP (59)

Which is equal to the classic proportional frequency droop control law. Results from this approach show that transient response is improved, and steady state error is reduced. However, this approach requires high precision with a trial-and-error method to find a suitable set of droop gains. Furthermore, there is no robustness analysis performed for these types of controllers. The integral component indicates the presence of a pole at the origin, which may represent small gain and phase margins.

Similarly, a complete microgrid hierarchical controller in a stationary reference frame was presented in “Modeling, analysis, and design of stationary-reference-frame droop-controlled parallel three-phase voltage source inverters”, J. C. Vasquez, J. M. Guerrero, M. Savaghebi, J. Eloy-Garcia, and R. Teodorescu, IEEE Trans. Ind. Electron., vol. 60, no. 4, pp. 1271-1280, 2013. In this work, a PR V-I controller was integrated with a PI droop controller and a secondary PI controller as shown in FIG. 16. The PI droop controller shows that power is shared proportionally according to the power ratings of each generator. However, no stability analysis is performed and the control gains for each level were calculated heuristically, which does not guarantee optimal performance.

Another example of a complete microgrid control system is shown in “Control of island AC microgrids using a fully distributed approach”, H. Xin, L. Zhang, Z. Wang, D. Gan, and K. P. Wong, IEEE Trans. Smart Grid, vol. 6, no. 2, pp. 943-945, 2015, where a fully distributed control approach for AC microgrids is presented. The author integrates primary, secondary, and tertiary control to share power, restore grid frequency, and exchange energy with other microgrids respectively. To ensure stability, the author sets some base rules for each inverter time constants and maximum frequency values. Additionally, the tertiary control is based on a nonlinear function that evaluates actual costs of selling energy and adjusts the frequency to sell or buy energy accordingly.

One of the main challenges in primary control is the effect of line impedance in power dynamics. As shown in FIG. 30, output current vector varies with line impedance angle and the phase shift between generators. Thus, active and reactive power expressions vary as well.

This concept may be illustrated mathematically in (61), where the active and reactive power vary according to the output impedance angle θ, the phase difference between the inverter and the AC bus φ, and the inverter voltage amplitude E:

$$P = \frac{E V}{Z} cos ( θ - φ ) - \frac{{V}^{2}}{Z} cos θ \\ Q = \frac{E V}{Z} sin ( θ - φ ) - \frac{{V}^{2}}{Z} sin θ \qquad ( 60 )$$

In microgrids, it is common to find resistive transmission lines due to the small distances between generators. This may affect power sharing accuracy because classical droop controllers are based on the premise that transmission line is highly inductive. The output voltage of the controlled inverter may be written as a function of the voltage reference and the output current as follows:

v_{c}=G(s)v_{ref}+Zₒ(s)iₒ(s) (61)

This means that Zₒ(s) may be interpreted as the output impedance of the controlled inverter. This concept is crucial to understand power sharing in droop controllers. To reduce the effects caused by inaccuracies in transmission line impedances, Guerrero et al. in proposed a virtual impedance loop as shown in FIG. 31. The virtual impedance Z_{D}(s) may be subtracted from the droop controller output as follows:

v_{ref}=vₒ*−Z_{D}(s)iₒ(s) (62)

This is done to modify the output impedance to have an inductive frequency response of 20 dB/dec and 90° of phase shift. Normally, Z_{D}(s) is chosen as a first-order high-pass filter to compensate harmonic power sharing. The contribution of Guerrero at al. shows excellent results modifying inverter's output impedance. This way, droop controller can be implemented based on the premise that output impedance is highly inductive under the working frequency band.

Virtual impedance can be designed to enhance harmonic current sharing and attenuate current spikes due to sudden load changes. In “A new control scheme for harmonic power sharing and PCC voltage harmonics compensation based on controlling the equivalent harmonic impedance of DGs in islanded microgrids”, Z. Zeng, H. Yi, H. Zhai, Z. Wang, S. Shi, and F. Zhuo, 2017 19th Eur. Conf. Power Electron. Appl. EPE 2017 ECCE Eur., vol. 2017-Janua, pp. 1-7, 2017, a control method for harmonic power sharing control is presented. This method is based on the negative virtual harmonic impedance and harmonic power droop control (Zₕ−H droop) where the output impedance at harmonic h is reduced according to the voltage amplitude of harmonic h at the AC bus.

To share harmonic power proportionally, each DG estimates its available power by using the rated apparent power, active power, and reactive power shown in (44). This estimation indicates the available power to be shared with harmonic current. Based on this available power, the virtual output impedance is reduced on each harmonic proportionally depending on the power capacity of each generator. Simulation results show that the harmonic power sharing control method is effective by distributing harmonic current among DGs depending on the available apparent power capacity. However, a stability analysis should be done to guarantee effective and reliable performance.

A similar approach is performed in “Control Strategies for Islanded Microgrid Using Enhanced Hierarchical Control Structure With Multiple Current-Loop Damping Schemes”, Y. Han, P. Shen, X. Zhao, and J. M. Guerrero, IEEE Trans. Smart Grid, vol. 8, no. 3, pp. 1139-1153, May 2017, where a hierarchical structure for three phase islanded microgrids is presented. This structure uses a multiple harmonic current control loops based on virtual impedances. Also, this structure uses multiple virtual impedance loops to compensate positive and negative sequence currents caused by transmission line unbalances. Finally, a small signal stability model is developed integrating primary and secondary control loops to analyze power damping behavior caused by secondary control. All the control loops were developed using PI/PR controllers, which does not ensure robustness and appropriate transient behavior. Another way of transforming output impedance is to make it purely resistive. In “Robust droop controller for accurate proportional load sharing among inverters operated in parallel”, Q. C. Zhong, IEEE Trans. Ind. Electron., vol. 60, no. 4, pp. 1281-1290, 2013, a resistive virtual impedance scheme is adopted for power sharing control in islanded microgrids. The author uses a proportional coefficient at the output voltage to emulate a resistive virtual impedance, which has less drawbacks than the inductive output impedance. Notice that when the output impedance is mainly resistive, the typical droop control P−ω, Q−E is substituted by the droop-boost control Q−ω, P−E. This implies that the active power is directly proportional to the voltage deviations and the reactive power is inversely proportional to the phase deviations. An additional proportional droop coefficient Kₑ is added to the output voltage to compensate voltage deviations in steady state. This additional coefficient regulates the output amplitude proportionally to the generator voltage deviation with the grid voltage. This strategy makes the controller independent of the output impedance and the model becomes robust against impedance variations and measurement errors. One of the main drawbacks of this method is the grid voltage need to be measured with a high precision in order to guarantee stability.

Classical droop control methods offer certain advantages over communication-based power sharing control strategies. However, the design of these controllers lacks a formal methodology to guarantee stability and performance in microgrids. Most of the coefficients or gains used in classical droop controllers are found by heuristic methods and the stability is analyzed using eigenvalues location in a pole-zero diagram. Also, classical droop methods rely on the premise that the output impedance is highly inductive. To address this problem, a virtual impedance loop is proposed in different forms to modify the frequency response to have an inductive behavior. However, this virtual impedance is inserted as a feedforward element that may affect stability and robustness.

Optimal Droop Control Methods

Optimal droop control methods are aimed to guarantee the best performance and/or stability margins by selecting the optimal droop gain values for active and reactive power. For this literature review, only a few works related to optimize droop controllers were found. The main limitation that this kind of controllers have is the need of a complete mathematical model of the system. In hierarchical control, primary and V-I controllers are coupled by the modification of frequency and amplitude of the reference signal. This coupling is not linear and makes it difficult to express the inverter as a linear state space system. This could be the main reason why primary and V-I control are designed separated by using a low-pass filter at the power calculation block shown in FIG. 15. Previous works provide a useful knowledge base to develop a mathematical model of the inverter connected to a microgrid. However, these works merge inverter and controller dynamics in a single state-space model, which makes difficult to express a control law that may be optimized.

In “Modelling, analysis and design of droop controlled parallel three phase voltage source inverter using dynamic phasors method”, J. Zhang, J. Chen, X. Chen, and C. Gong, IEEE Transp. Electrif. Conf. Expo, ITEC Asia-Pacific 2014—Conf. Proc., pp. 1-6, 2014, a small signal analysis using the dynamic phasors method is performed to analyze the stability margins of the proportional frequency and voltage droop gains in an islanded microgrid. The dynamic phasor modeling gives a wider view of the transient response and stability analysis of an oscillatory system. In this case, two inverters each one connected with a resistive-inductive line were modeled. Then, a closed-loop analysis was performed to each active and reactive power transfer functions. The author used partial derivatives to find the optimal values of the components and constants to obtain the highest possible range of proportional droop constants. Results show that the model is accurate in determining optimal ranges. This method may be used with state-space models to develop state-feedback control. Moreover, the optimization method may be improved by using Particle Swarm Optimization with another performance index or using LQ control.

In “Optimizing a virtual impedance droop controller for parallel inverters”, M. Kabalan and P. Singh, IEEE Power Energy Soc. Gen. Meet., vol. 2015-Septe, 2015, a virtual impedance controller [78] is used to optimize load sharing using an optimal servo LQG approach similar to C. Dirscherl, J. Fessler, C. M. Hackl, and H. Ipach, “State-feedback controller and observer design for grid-connected voltage source power converters with LCL-filter”, previously explained. The author uses a Second-Order Generalized Integrator (SOGI) to generate signal reference. In addition, the entire inverter is modeled as a Thevenin equivalent with an AC voltage source, a virtual impedance, and a parallel AC current source to supply harmonic and fundamental current. harmonic power is taken into consideration because the controller uses instantaneous values of current and voltage.

In “Seamless formation and robust control of distributed generation microgrids via direct voltage control and optimized dynamic power sharing”, Y. A. R. I. Mohamed, H. H. Zeineldin, M. M. A. Salama, and R. Seethapathy, IEEE Trans. Power Electron., vol. 27, no. 3, pp. 1283-1294, 2012, an optimal control approach based on PSO was developed. The author proposed the following performance index to minimize frequency deviations:

$$J = {\sum }_{k = 1}^{N} {\sum }_{n}^{l} {[ {nTE}_{{ω}_{k}} ( n ) ]}^{2} \qquad ( 63 )$$

where E_{ω}_{ₖ} is the frequency error at the time n for inverter k, T is the sampling time, l is the total number of samples, and N is the total number of inverter units in isolated microgrid. Optimizing J, power sharing transient response is improved and the frequency deviations are optimized. By minimizing frequency deviations, the oscillatory behavior of the phase is reduced, and the active power losses are minimized.

Finally, in “PI state space current control of grid connected PWM converters with LCL filters”, J. Dannehl, F. W. Fuchs, and P. B. Thøgersen, IEEE Trans. Power Electron., vol. 25, no. 9, pp. 2320-2330, 2010, a PSO method is used to find the optimal coefficients for a V-I controller and active-reactive power sharing controller. The V-I controllers are defined as PID and P controllers after concluding that the integral component is not required for the current controller due to its impact on system eigenvalues. Also, the active power controller is designed as a PD controller to improve transient response and controllability. The objective of this approach is to maximize the margin for selecting the proportional gain of the active power sharing controller. This is done because it is demonstrated that droop controllers affect the stability on islanded microgrids. The restrictions for this optimization are based on keeping the maximum eigenvalue in the right half complex plane and to guarantee a damping ratio below 0.5. The PSO method was used to find the optimal local values of the voltage proportional and derivative control constants and to find the optimal local values of the active power proportional, integral, and derivative control constants. Results provide notorious improvements compared to work previously explained. It was demonstrated that with this method, the proportional gain of the active power sharing controller gets maximized. This maximization improves system stability and transient response.

To this date, optimal control contributions to distributed power sharing control are limited. The most important reason for this is the limitation to develop a mathematical model that integrates power sharing and V-I dynamics. With this model, many optimal and robust control techniques may be used. The models developed in literature integrate system and controller as a single state-space system. Then, the eigenvalues of this system are analyzed with variations in droop control gains. This kind of models are useful to analyze stability but are not suitable for designing optimal or robust controllers.

Power Sharing Droop Control Summary

In this literature review, a total of 25 publications about droop control methods for microgrids where reviewed. Table 2 below shows a summary of these works. From these publications, 7 are from conference proceedings and 18 are from journals. Most of the reviewed works are less than 10 years old and only relevant work was reviewed before 2008 as shown in FIG. 32.

TABLE 2
Summary of Reviewed Droop Control Methods for Microgrids

| | | Citations | | |
|---|---|---|---|---|
| Ref. | Year | (Gscholar) | Type of Publication | Controller |
| [22] | 2012 | 527 | Journal | Survey |
| [28] | 2016 | 209 | Journal | Survey |
| [36] | 2013 | 398 | Journal | Classical |
| [66] | 2017 | 41 | Journal | Virtual Impedance |
| [39] | 1997 | 374 | Conferencia | Classical |
| [40] | 1999 | 125 | Conferencia | Classical |
| [41] | 2007 | 1545 | Journal | Classical |
| [42] | 2014 | 2 | Conferencia | Optimal |
| [51] | 2010 | 492 | Journal | Optimal, Classical |
| [65] | 2012 | 74 | Journal | Optimal |
| [67] | 2015 | NA | Conferencia | Optimal |
| [68] | 2017 | 79 | Journal | Survey |
| [69] | 2008 | 595 | Journal | Survey |
| [70] | 1984 | 3902 | Journal | Teoría de Potencia |
| [71] | 2004 | 450 | Journal | Classical |
| [72] | 2013 | 195 | Journal | Classical |
| [74] | 2014 | 90 | Journal | Classical |
| [75] | 2012 | 80 | Journal | Classical |
| [76] | 2004 | 949 | Journal | Classical |
| [77] | 2015 | 39 | Journal | Classical |
| [78] | 2005 | 992 | Journal | Virtual Impedance |
| [79] | 2017 | NA | Conferencia | Virtual Impedance |
| [80] | 2013 | 487 | Journal | Virtual Impedance |
| [81] | 2014 | NA | Conferencia | Optimal |
| [82] | 2002 | 552 | Journal | Classical |

[22] A. Bidram and A. Davoudi, “Hierarchical structure of microgrids control system,” IEEE Trans. Smart Grid, vol. 3, no. 4, pp. 1963-1976, 2012.
[28] H. Han, X. Hou, J. Yang, J. Wu, M. Su, and J. M. Guerrero, “Review of Power Sharing Control Strategies for Islanding Operation of AC Microgrids,” IEEE Trans. Smart Grid, vol. 7, no. 1, pp. 200-215, January 2016.
[36] J. C. Vasquez, J. M. Guerrero, M. Savaghebi, J. Eloy-Garcia, and R. Teodorescu, “Modeling, analysis, and design of stationary-reference-frame droop-controlled parallel three-phase voltage source inverters,” IEEE Trans. Ind. Electron., vol. 60, no. 4, pp. 1271-1280, 2013.
[39] A. Tuladhar, H. Jin, T. Unger, and K. Mauch, “Parallel operation of single phase inverter modules with no control interconnections,” in Proceedings of APEC 97—Applied Power Electronics Conference, 1997, vol. 1, pp. 94-100.
[40] E. A. A. Coelho, P. C. Cortizo, and P. F. D. Garcia, “Small signal stability for single phase inverter connected to stiff AC system,” Conf. Rec. 1999 IEEE Ind. Appl. Conf. Thirty-Forth IAS Annu. Meet. (Cat. No. 99CH36370), vol. 4, pp. 2180-2187, 1999.
[41] N. Pogaku, M. Prodanovid, and T. C. Green, “Modeling, analysis and testing of autonomous operation of an inverter-based microgrid,” IEEE Trans. Power Electron., vol. 22, no. 2, pp. 613-625, 2007.
[42] W. Xiao, P. Kanjiya, J. L. Kirtley, N. H. Kan'an, H. H. Zeineldin, and V. Khadkikar, “A modified control topology to improve stability margins in micro-grids with droop controlled IBDG,” in 3rd Renewable Power Generation Conference (RPG 2014), 2014, pp. 5.2.2-5.2.2.
[51] R. Majumder, B. Chaudhuri, A. Ghosh, R. Majumder, G. Ledwich, and F. Zare, “Improvement of stability and load sharing in an autonomous microgrid using supplementary droop control loop,” IEEE Trans. Power Syst., vol. 25, no. 2, pp. 796-808, 2010.
[65] Y. A. R. I. Mohamed, H. H. Zeineldin, M. M. A. Salama, and R. Seethapathy, “Seamless formation and robust control of distributed generation microgrids via direct voltage control and optimized dynamic power sharing,” IEEE Trans. Power Electron., vol. 27, no. 3, pp. 1283-1294, 2012.
[66] Y. Han, P. Shen, X. Zhao, and J. M. Guerrero, “Control Strategies for Islanded Microgrid Using Enhanced Hierarchical Control Structure With Multiple Current-Loop Damping Schemes,” IEEE Trans. Smart Grid, vol. 8, no. 3, pp. 1139-1153, May 2017.
[67] M. Kabalan and P. Singh, “Optimizing a virtual impedance droop controller for parallel inverters,” IEEE Power Energy Soc. Gen. Meet., vol. 2015-Septe, 2015.
[68] Y. Han, H. Li, P. Shen, E. A. A. Coelho, and J. M. Guerrero, “Review of Active and Reactive Power Sharing Strategies in Hierarchical Controlled Microgrids,” IEEE Trans. Power Electron., vol. 32, no. 3, pp. 2427-2451, 2017.
[69] J. M. Guerrero, L. Hang, and J. Uceda, “Control of Distributed Uninterruptible Power Supply Systems,” IEEE Trans. Ind. Electron., vol. 55, no. 8, pp. 2845-2859, 2008.
[70] H. Akagi, Y. Kanazawa, and A. Nabae, “Instantaneous Reactive Power Compensators Comprising Switching Devices without Energy Storage Components,” IEEE Trans. Ind. Appl., vol. IA-20, no. 3, pp. 625-630, 1984.
[71] M. N. Marwali, J.-W. Jung, and A. Keyhani, “Control of Distributed Generation Systems—Part II: Load Sharing Control,” IEEE Trans. Power Electron., vol. 19, no. 6, pp. 1551-1561, 2004.
[72] R. Majumder, “Some aspects of stability in microgrids,” IEEE Trans. Power Syst., vol. 28, no. 3, pp. 3243-3252, 2013.
[74] X. Guo, Z. Lu, B. Wang, X. Sun, L. Wang, and . . . , “Dynamic Phasors-Based Modeling and Stability Analysis of Droop-Controlled Inverters for Microgrid Applications.,” IEEE Trans. smart grid, vol. 5, no. 6, pp. 2980-2987, 2014.
[75] H. J. Avelar, W. A. Parreira, J. B. Vieira, L. C. G. De Freitas, and E. A. A. Coelho, “A state equation model of a single-phase grid-connected inverter using a droop control scheme with extra phase shift control action,” IEEE Trans. Ind. Electron., vol. 59, no. 3, pp. 1527-1537, 2012.
[76] J. M. Guerrero, L. GarciadeVicuna, J. Matas, M. Castilla, and J. Miret, “A Wireless Controller to Enhance Dynamic Performance of Parallel Inverters in Distributed Generation Systems,” IEEE Trans. Power Electron., vol. 19, no. 5, pp. 1205-1213, September 2004.
[77] H. Xin, L. Zhang, Z. Wang, D. Gan, and K. P. Wong, “Control of island AC microgrids using a fully distributed approach,” IEEE Trans. Smart Grid, vol. 6, no. 2, pp. 943-945, 2015.
[78] J. M. Guerrero, L. GarciadeVicuna, J. Matas, M. Castilla, and J. Miret, “Output Impedance Design of Parallel-Connected UPS Inverters With Wireless Load-Sharing Control,” IEEE Trans. Ind. Electron., vol. 52, no. 4, pp. 1126-1135, August 2005.
[79] Z. Zeng, H. Yi, H. Zhai, Z. Wang, S. Shi, and F. Zhuo, “A new control scheme for harmonic power sharing and PCC voltage harmonics compensation based on controlling the equivalent harmonic impedance of DGs in islanded microgrids,” 2017 19th Eur. Conf. Power Electron. Appl. EPE 2017 ECCE Eur., vol. 2017-Janua, pp. 1-7, 2017.
[80] Q. C. Zhong, “Robust droop controller for accurate proportional load sharing among inverters operated in parallel,” IEEE Trans. Ind. Electron., vol. 60, no. 4, pp. 1281-1290, 2013.
[81] J. Zhang, J. Chen, X. Chen, and C. Gong, “Modelling, analysis and design of droop-controlled parallel three phase voltage source inverter using dynamic phasors method,” IEEE Transp. Electrif. Conf. Expo, ITEC Asia-Pacific 2014—Conf. Proc., pp. 1-6, 2014.
[82] E. A. A. Coelho, P. C. Cortizo, and P. F. D. Garcia, “Small-signal stability for parallel-connected inverters in stand-alone AC supply systems,” IEEE Trans. Ind. Appl., vol. 38, no. 2, pp. 533-542, 2002.

Classical droop control methods represent the majority of the reviewed works. This is because classical droop controllers are based on heuristic methods for finding droop gains. Some of the classical controllers analyze the eigenvalue structure of the controlled microgrid to ensure stability. Also, most of the contributions in droop control are focused on adding control loops to reduce counter effects in microgrids under faults.

Power sharing control level has many factors that affect stability. The most important factor is the uncertainty in transmission line impedance.

To address this uncertainty, a virtual impedance control loop is proposed. The virtual impedance is also able to improve harmonic distortion and transient response under a sudden change in the load.

### BRIER DESCRIPTION OF THE DRAWINGS

Further features and advantages of the invention will become apparent from the following detailed description taken in conjunction with the accompanying figures showing illustrative embodiments of the invention, in which:

FIG. 1 illustrates a typical structure of a renewable energy source generator.

FIG. 2 illustrates a microgrid general scheme.

FIG. 3 shows a proposed the hierarchical control levels in microgrids.

FIG. 4 shows a typical V-I control scheme.

FIG. 5s illustrates ABC to αβ0 clarke transformation from a perspective point of view

FIG. 5b illustrates ABC to αβ0 clarke transformation from an isometric point of view.

FIG. 6 illustrates a αβ to dq frame transformation.

FIG. 7 shows a complete transformation process from ABC frame to αβ and dq frames, where (a) shows the ABC frame, (b) shows the αβ frame and (c) shows the dq frame.

FIG. 8 shows a typical closed-loop control diagram.

FIG. 9 shows a general block diagram of a state-feedback controller.

FIG. 10 shows a typical robust control block diagram.

FIG. 11 shows a three-phase voltage source connected to a load or a network.

FIG. 12 shows an AC inverter generator connected to an AC stiff voltage source.

FIG. 13 shows a droop control curves for active and reactive power sharing.

FIG. 14 shows two DGs sharing a load.

FIG. 15 shows a typical hierarchical control diagram for primary control.

FIG. 16 shows a typical scheme of a secondary control level to recover microgrid's voltage and frequency.

FIG. 17 shows a structure for V-I control.

FIG. 18 shows a State-feedback and PI control implementation.

FIG. 19 shows a PR controller to correct circulating currents in

FIG. 20 illustrates a RSP Controller with optimal state-feedback.

FIG. 21 shows a LQG implementation with a servo controller approach.

FIG. 22 shows a Luenberger observer Kalman filter.

FIG. 23 shows a V-I controller was calculated using an LQR controller with a full-state feedback gain.

FIG. 24 shows optimal LQR tracking with average load current sharing.

FIG. 25 shows the Linear Fractional Transformation (LFT) of a closed-loop system.

FIG. 26 shows a distribution of reviewed V-I Control papers by Year.

FIG. 27 shows two generators sharing a load through a purely inductive transmission line.

FIG. 28 shows distortion power sharing with multiplicative component.

FIG. 29 shows resulting clusters when analyzing microgrid eigenvalues.

FIG. 30 shows the effect of line impedance in output current.

FIG. 31 shows a virtual impedance loop.

FIG. 32 shows a distribution of reviewed papers in droop control by year.

FIG. 33 shows a three-phase generator connected to a voltage source.

FIG. 34 shows a complete islanded microgrid scheme with an RL load.

FIG. 35 shows the validation of the integrated state-space model of the inverter-based generator.

FIG. 36 shows the control scheme for the LQR-ORT controller.

FIG. 37 shows the control scheme for the voltage restoration loop.

FIG. 38 shows the SOGI-PLL with frequency restoration loop.

FIG. 39 shows a complete PQVI control scheme, according to the invention.

FIG. 40 shows the validation scheme for the integrated PQVI controller according to the invention.

FIG. 41 shows the complete islanded microgrid scheme with RL loads, according to the invention.

FIG. 42 shows Eigenvalues of nominal G₁(z), G₂(z), and G₃(z) and their variations.

FIG. 43 shows Singular Values Diagram for G₁(z), G₂(z), and G₃(z) and their variations.

FIG. 44 shows Eigenvalues of nominal G_{μG}(z) and its variations.

FIG. 45 shows Singular Values Diagram for G_{μG}(z) and its variations.

FIG. 46 shows a circuit diagram for model validation in grid-connected mode.

FIG. 47 shows power waveforms for the mathematical model and circuit in grid-connected mode, TOP: Active power, BOTTOM: Reactive power.

FIG. 48 shows State-vector waveforms for the mathematical model and circuit in grid-connected mode, TOP: dq frame, BOTTOM: ABC frame.

FIG. 49 shows NRMSE for the state vector and shared power, TOP: state variables, BOTTOM: Active and reactive power.

FIG. 50 illustrates a circuit diagram for model validation in islanded mode.

FIG. 51 shows power waveforms for the mathematical model and circuit in islanded mode, TOP: Inverter 1, MIDDLE: Inverter 2, BOTTOM: Inverter 3.

FIG. 52 shows state-vector waveforms for the mathematical model and circuit in islanded mode in the dq frame, TOP: Inverter 1, MIDDLE: Inverter 2, BOTTOM: Inverter 3.

FIG. 53 shows state-vector waveforms for the mathematical model and the circuit in islanded mode in the ABC frame, TOP: Inverter 1, MIDDLE: Inverter 2, BOTTOM: Inverter 3.

FIG. 54 shows NRMSE for the state vector and shared power, TOP: state variables, BOTTOM: Active and reactive power.

FIG. 55 shows Eigenvalues of nominal Λ₁(z), Λ₂(z), and Λ₃(z) and their variations.

FIG. 56 shows Singular Values Diagram for Λ₁(z), Λ₂(z), and Λ₃(z) and their variations.

FIG. 57 shows Eigenvalues of nominal Λ_{μG}(z) and its variations.

FIG. 58 shows Singular Values Diagram for Λ_{μG}(z) and its variations with performance bound.

FIG. 59 shows a photo of the experimental microgrid setup.

FIG. 60 shows Simulation results comparing the LQR-ORT controller performance with the PR-droop controller using the same reference signals, (a) Active and reactive power, (b) LQ-cost.

FIG. 61 shows Experimental results comparing the LQR-ORT controller performance with the PR-droop controller using the same reference signals, (a) Active and reactive power, (b) LQ-cost values.

FIG. 62 shows Experimental output current values for the LQR-ORT controller in phase A (C4, Z4) and grid voltage (Z2).

FIG. 63 shows Simulation results for (a) Active power, (b) Reactive Power, (c) Voltage in the AC bus and frequency of the microgrid.

FIG. 64 shows Experimental results for (a) Active power, (b) Reactive Power, (c) Voltage in the AC bus and frequency of the microgrid.

FIG. 65 shows Output currents during experiment for T₁=1 s, T₂=3 s, T₃=5 s, Vgrid=200 mA/div, Hgrid=700 ms/div.\

FIG. 66 shows Experiment THD values for (a) main grid, (b) LEFT: after T₂, RIGHT: after T₃.

FIG. 67 shows simulink block for microgrid simulation and controller validation.

FIG. 68 shows simulink block diagram for circuit measurement and dq transformation.

FIG. 69 shows simulink block diagram for controller implementation on the dspace 1006.

FIG. 70 shows simulink block diagram for the integrated pqvi controller.

FIG. 71 shows simulink block diagram for LQR-ORT controller.

FIG. 72 shows Simulink Block Diagram for the SOGI-PLL with the Frequency Restoration Loop, TOP: PLL synchronizer with frequency restoration loop, BOTTOM: SOGI component for α component.

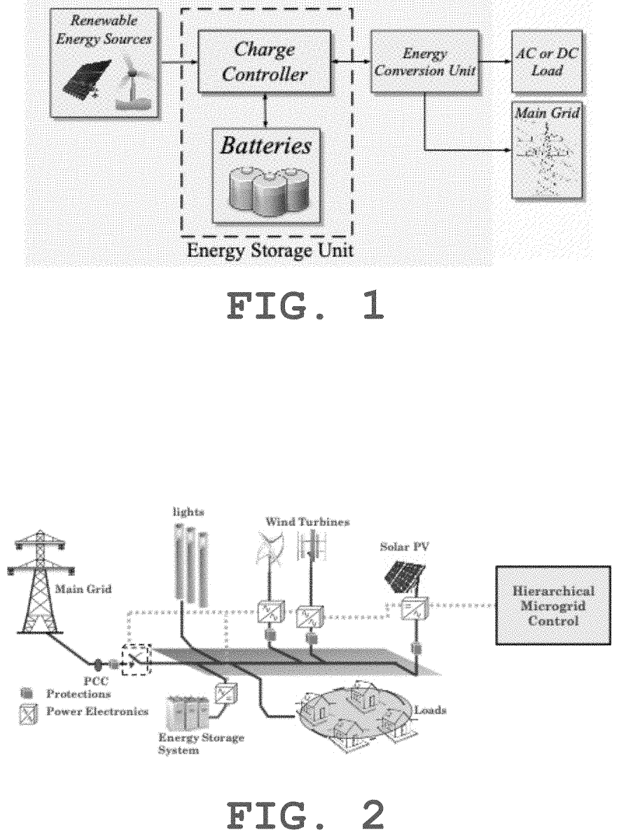

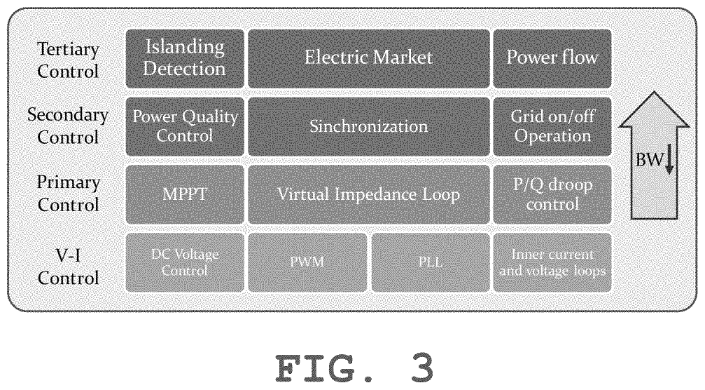

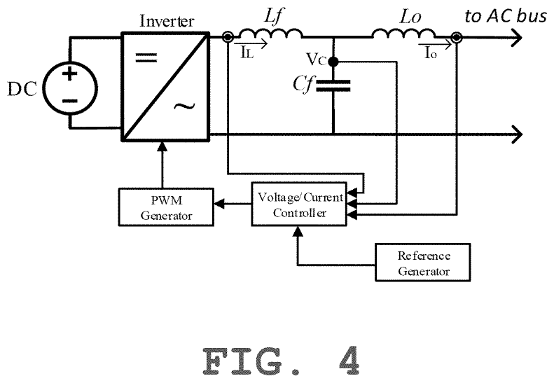

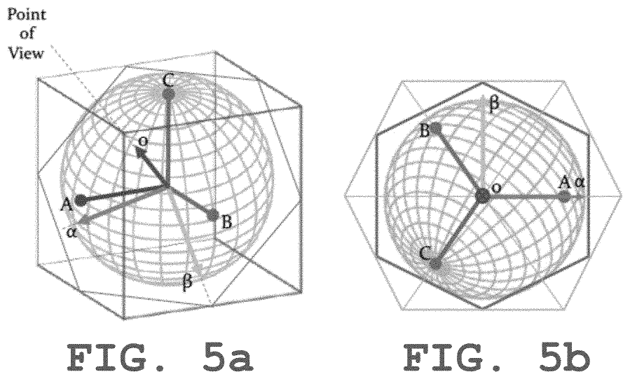

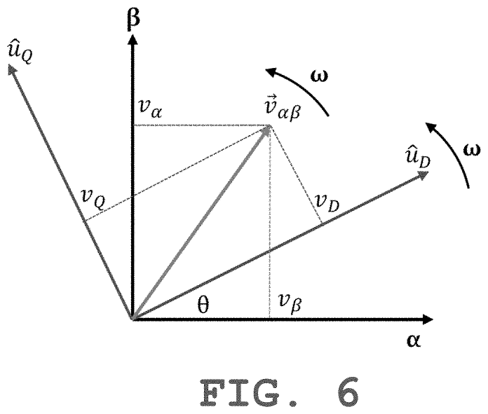

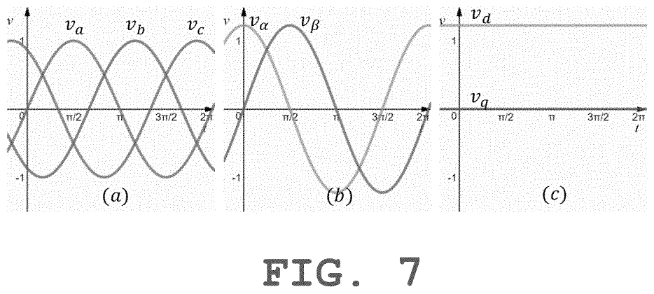

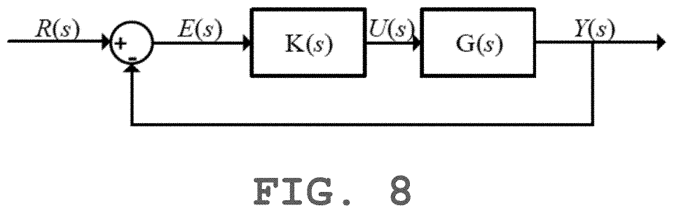

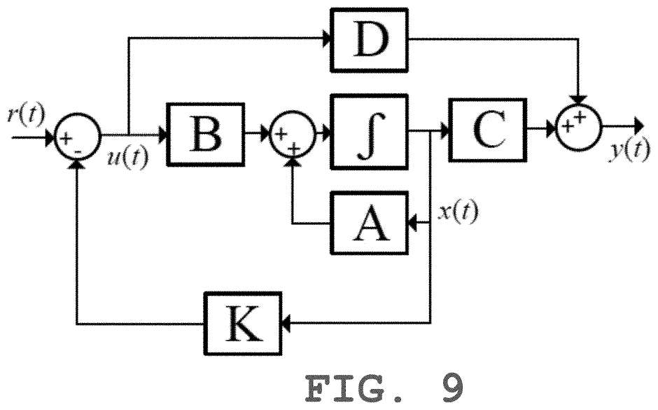

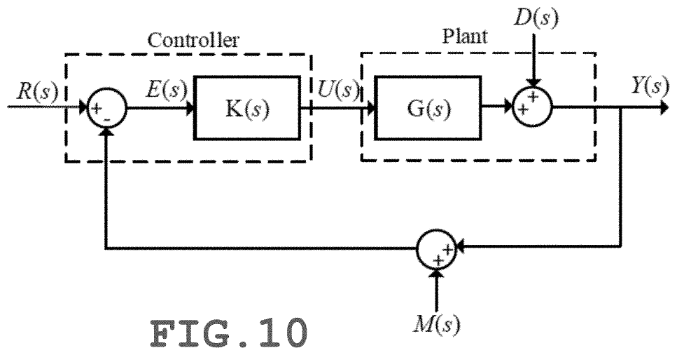

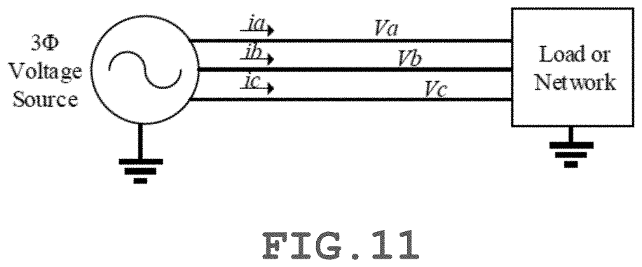

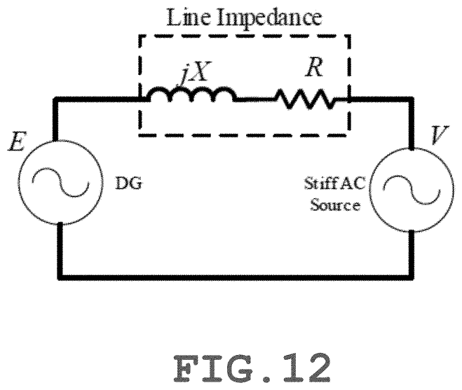

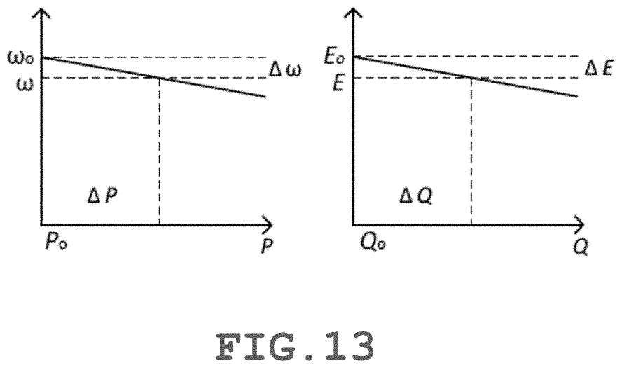

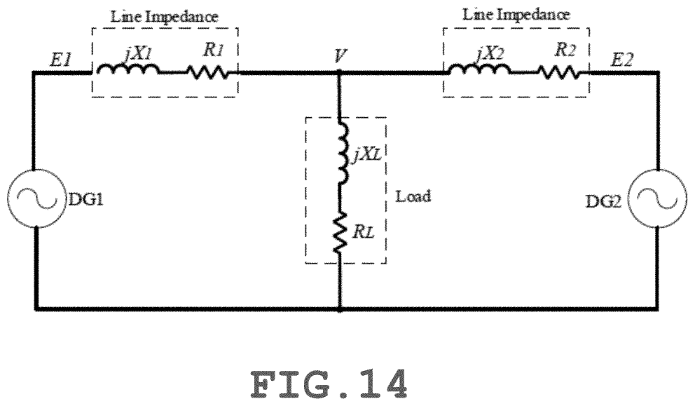

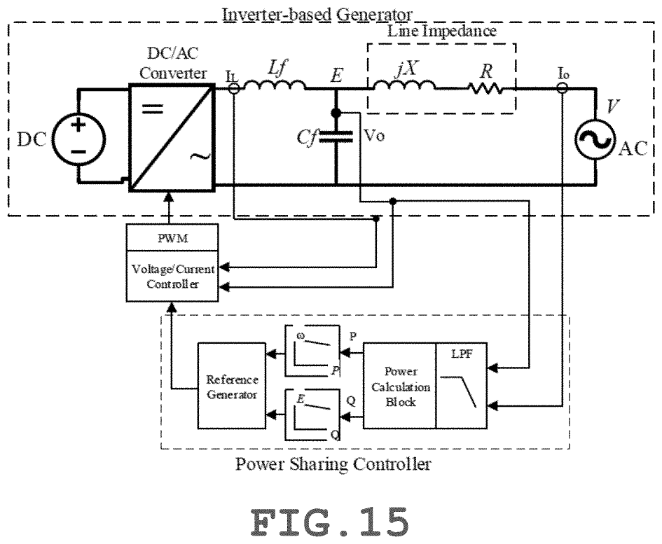

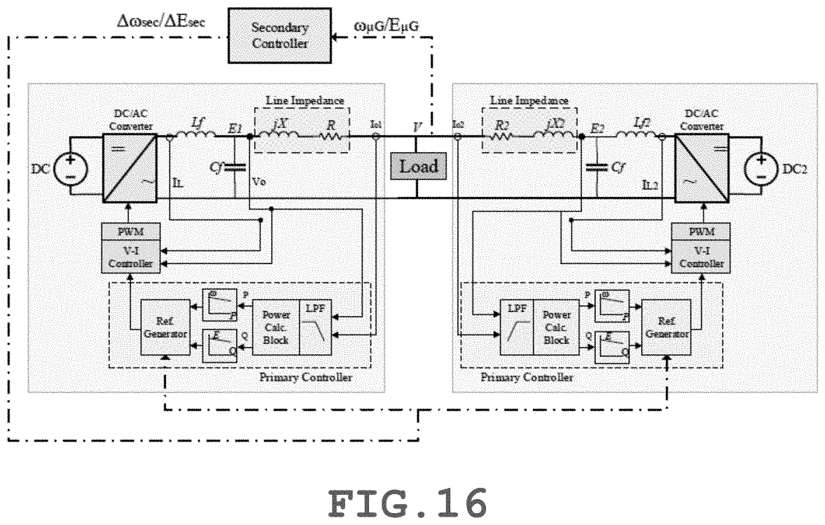

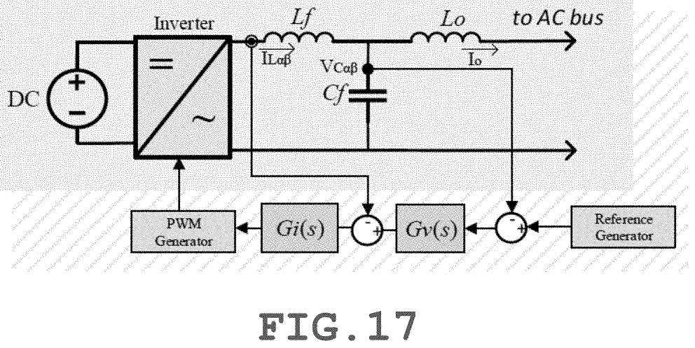

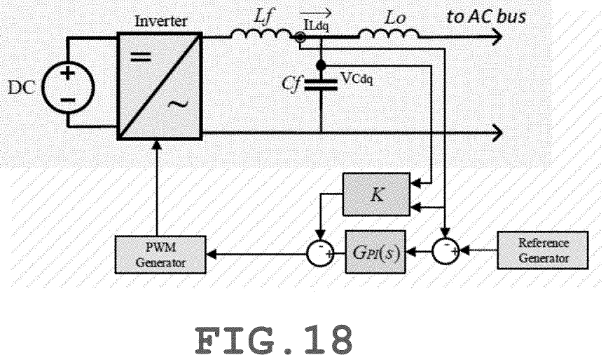

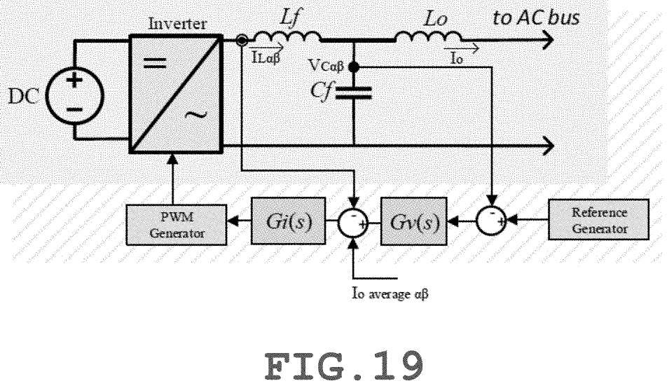

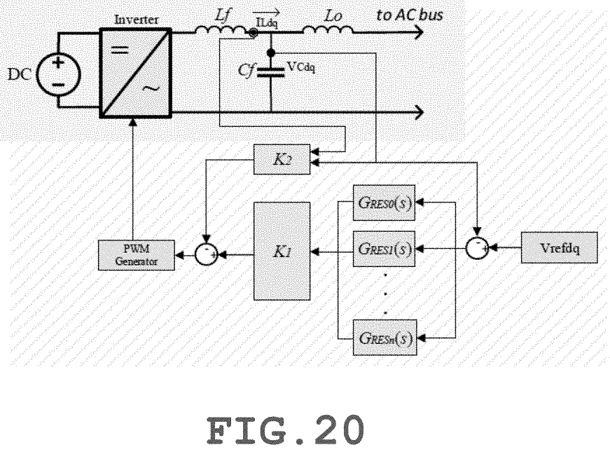

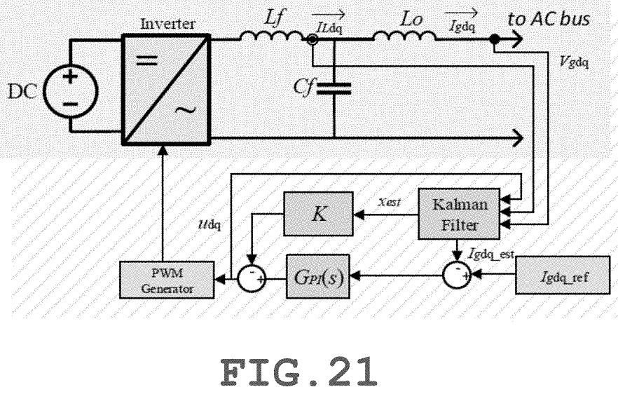

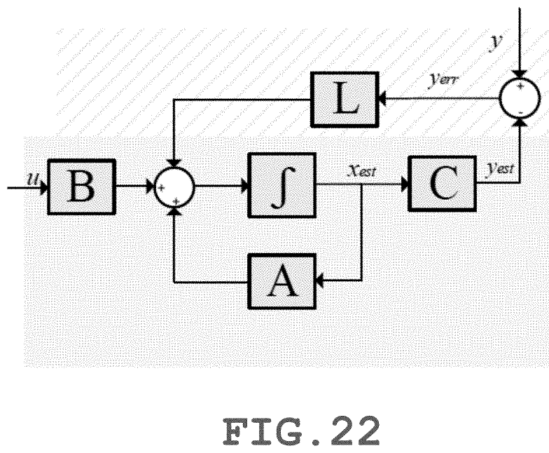

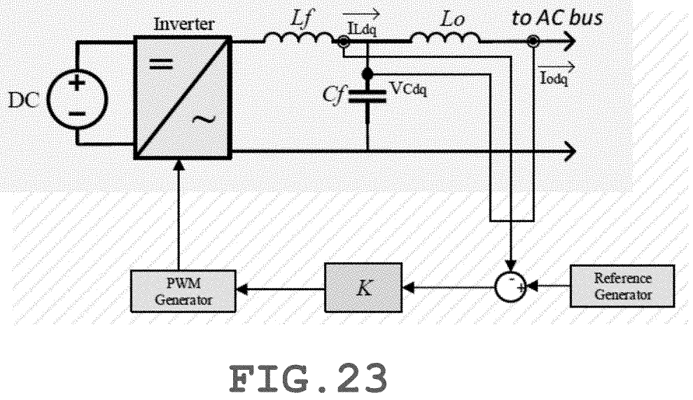

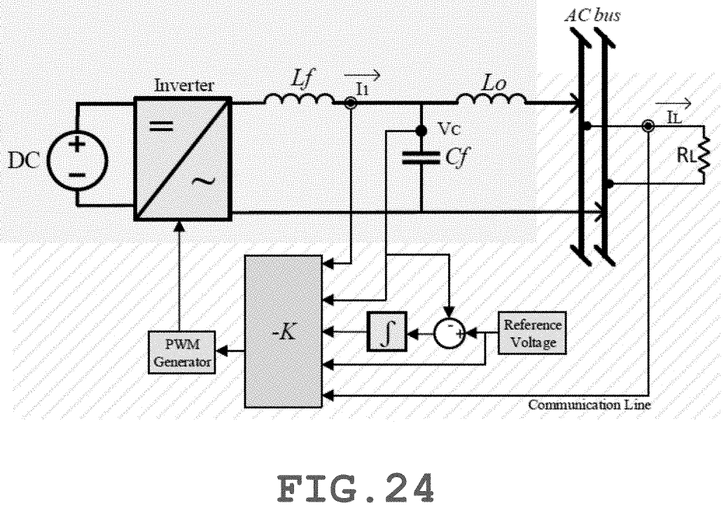

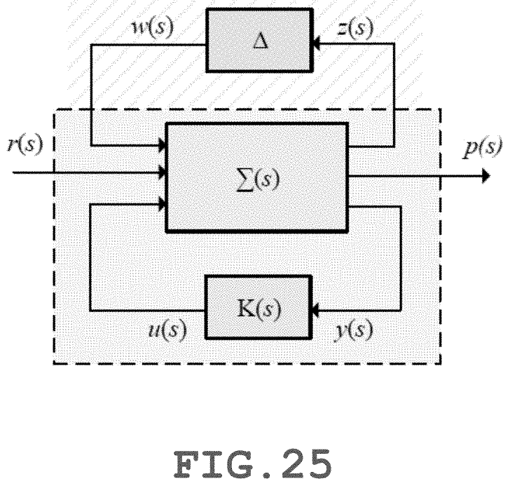

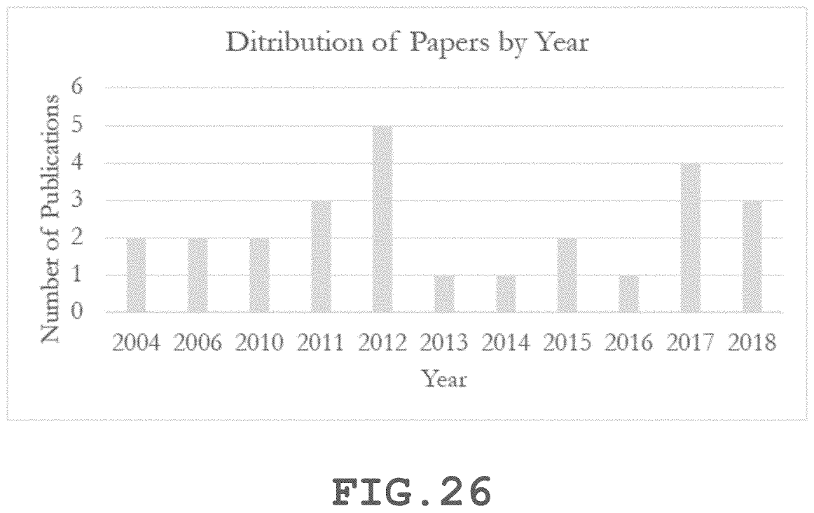

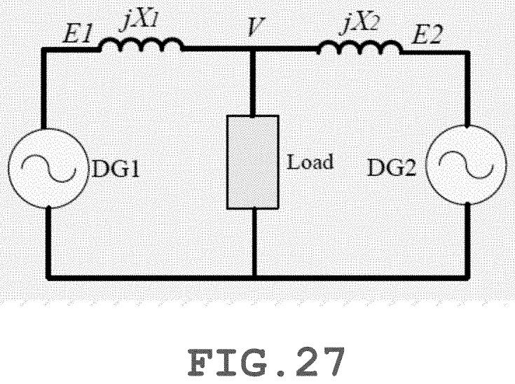

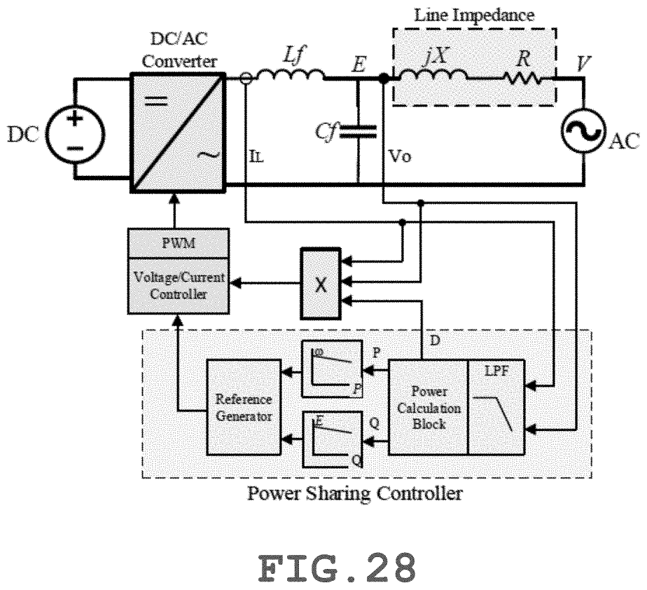

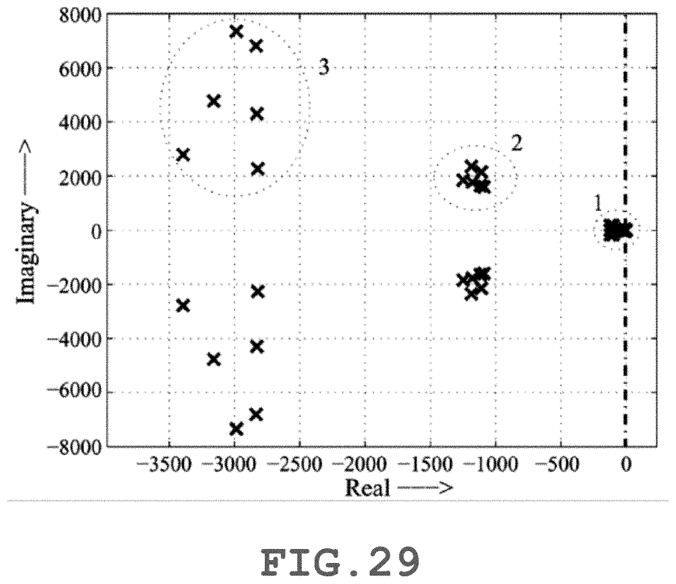

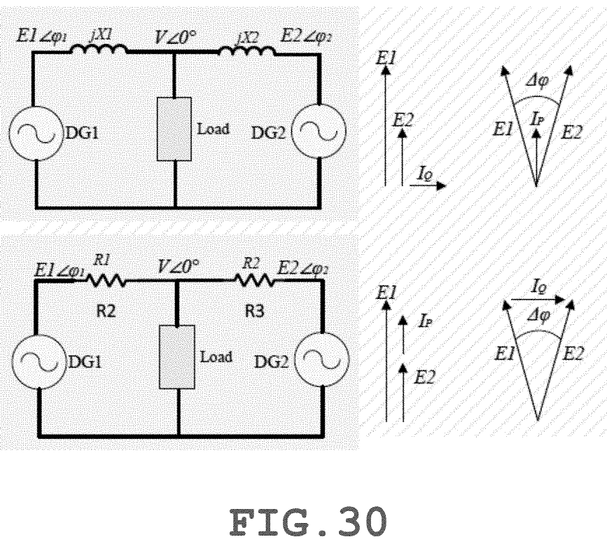

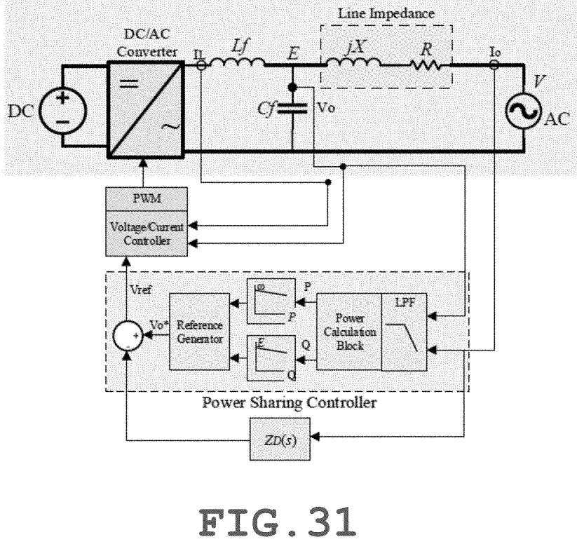

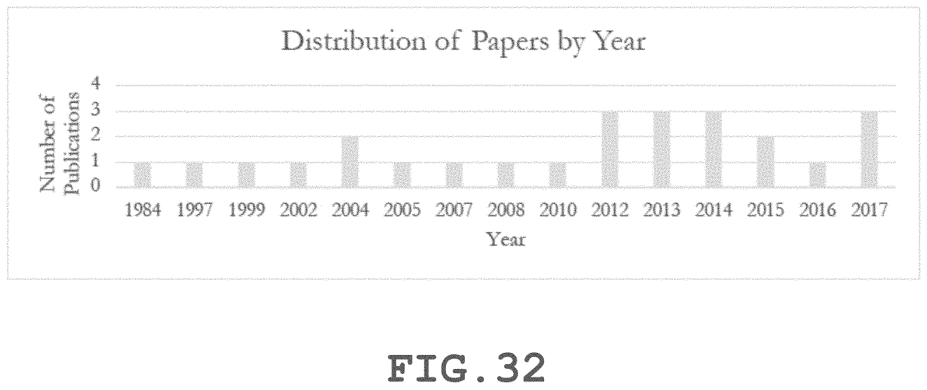

Throughout the figures, the same reference numbers and characters, unless otherwise stated, are used to denote like elements, components, portions or features of the illustrated embodiments. The subject invention will be described in detail in conjunction with the accompanying figures, in view of the illustrative embodiments.

### DETAILED DESCRIPTION OF THE INVENTION

Open-Loop State-Space Model of an Inverter-Based Generator that Includes V-I and Power Sharing Dynamics

The present invention provides a system and a method where first, the model of each inverter connected to the main grid is used to describe dynamics in grid-connected mode. This model is also used to develop the control strategy of the present invention. Then, the models of all inverters are integrated in a single state-space model to provide microgrid dynamics control in islanded mode.

Model of a Single Inverter Connected to the Main Grid

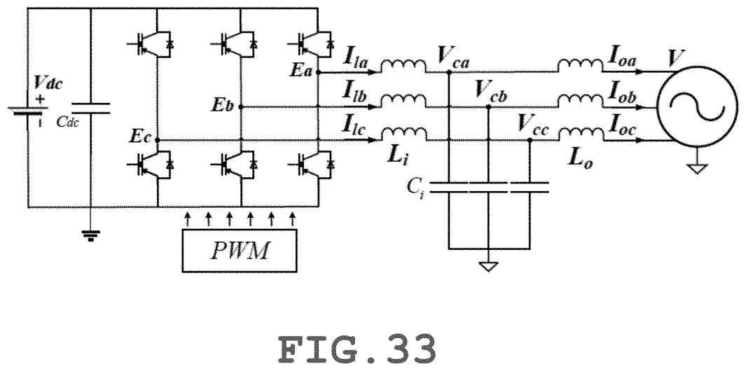

The circuit used to develop the inventive model in grid-connected mode is shown in FIG. 33. The output of a three-phase inverter E is connected through an Inductor-Capacitor-Inductor (LCL) output filter to a stiff voltage source V that represents the main grid. Input inductor current, capacitor voltage, and output current are denoted by Iₗ, V_{c}, and Iₒ, respectively.

The state-space model of this circuit for each phase in the ABC frame is given by:

$$[ \begin{matrix}{\dot{V}}_{c} \\ {\dot{I}}_{l} \\ {\dot{I}}_{o}\end{matrix} ] = [ \begin{matrix}0 & 1 / c & - 1 / c \\ - 1 / {L}_{i} & 0 & 0 \\ 1 / {L}_{o} & 0 & 0\end{matrix} ] [ \begin{matrix}{V}_{c} \\ {I}_{l} \\ {I}_{o}\end{matrix} ] + [ \begin{matrix}0 \\ 1 / {L}_{i} \\ 0\end{matrix} ] E + [ \begin{matrix}0 \\ 0 \\ - 1 / {L}_{o}\end{matrix} ] V . \qquad ( 64 )$$

The state-space model (66) is obtained using the following dq transformation. The dq transformation is performed by assuming a constant angular frequency ω_{c}, which corresponds to the nominal angular frequency of the main grid. The state-space model transformation to the dq frame is based on the Clarke transformation previously presented. Assuming the following state-space model for one phase oscillating at certain angular frequency ω:

$$\begin{matrix}\dot{x} = Ax + Bu \\ with & ( 65 ) \\ A = [ \begin{matrix}{a}_{11} & … & {a}_{1 n} \\ ⋮ & ⋱ & ⋮ \\ {a}_{n 1} & … & {a}_{n n}\end{matrix} ] , B = [ \begin{matrix}{b}_{11} & … & {b}_{m 1} \\ ⋮ & ⋱ & ⋮ \\ {b}_{n 1} & … & {b}_{n m}\end{matrix} ] , \\ x = [ \begin{matrix}{x}_{1} \\ ⋮ \\ {x}_{n}\end{matrix} ] , u = [ \begin{matrix}{u}_{1} \\ ⋮ \\ {u}_{m}\end{matrix} ] & ( 66 )\end{matrix}$$

the balanced model from the ABC frame is transformed to the dq frame by defining:

$$\begin{matrix}{A}_{d q} = [ \begin{matrix}{a}_{T 1} & {a}_{12} {I}_{2 \times 2} & … & {a}_{1 n} {I}_{2 \times 2} \\ {a}_{21} {I}_{2 \times 2} & {a}_{T 2} & … & {a}_{2 n} {I}_{2 \times 2} \\ ⋮ & ⋮ & ⋱ & ⋮ \\ {a}_{n 1} {I}_{2 \times 2} & {a}_{n 2} {I}_{2 \times 2} & … & {a}_{Tn}\end{matrix} ] , {x}_{d q} = [ \begin{matrix}{x}_{1 d} \\ {x}_{1 q} \\ ⋮ \\ {x}_{n d} \\ {x}_{n q}\end{matrix} ] \\ {B}_{d q} = [ \begin{matrix}{b}_{11} {I}_{2 \times 2} & … & {b}_{1 m} {I}_{2 \times 2} \\ & ⋱ & \\ {b}_{n 1} {I}_{2 \times 2} & … & {b}_{n m} {I}_{2 \times 2}\end{matrix} ] , {u}_{d q} = [ \begin{matrix}{u}_{1 d} \\ {u}_{1 q} \\ ⋮ \\ {u}_{m d} \\ {u}_{m q}\end{matrix} ] \\ where & ( 67 ) \\ {a}_{T j} = {a}_{jj} {I}_{2 \times 2} + [ \begin{matrix}0 & ω \\ - ω & 0\end{matrix} ] \\ with 1 \leq j \leq n . \\ Now , & ( 68 ) \\ x = {A}_{d q} x + {B}_{1 d q} {E}_{d q} + {B}_{2 d q} {V}_{d q} \\ where & ( 69 ) \\ x = [ \begin{matrix}{V}_{c d} \\ {V}_{c q} \\ {I}_{l d} \\ {I}_{l q} \\ {I}_{o d} \\ {I}_{o q}\end{matrix} ] ; \\ {A}_{d q} = [ \begin{matrix}0 & {ω}_{c} & 1 / C & 0 & - 1 / C & 0 \\ - {ω}_{c} & 0 & 0 & 1 / C & 0 & - 1 / C \\ - 1 / {L}_{i} & 0 & 0 & {ω}_{c} & 0 & 0 \\ 0 & - 1 / {L}_{i} & - {ω}_{c} & 0 & 0 & 0 \\ 1 / {L}_{o} & 0 & 0 & 0 & 0 & {ω}_{c} \\ 0 & 1 / {L}_{o} & 0 & 0 & - {ω}_{c} & 0\end{matrix} ] \\ {B}_{1 d q} = [ \begin{matrix}0 & 0 \\ 0 & 0 \\ 1 / {L}_{i} & 0 \\ 0 & 1 / {L}_{i} \\ 0 & 0 \\ 0 & 0\end{matrix} ] ; {E}_{d q} = [ \begin{matrix}{E}_{d} \\ {E}_{q}\end{matrix} ] ; \\ {B}_{2 d q} = [ \begin{matrix}0 & 0 \\ 0 & 0 \\ 0 & 0 \\ 0 & 0 \\ - 1 / {L}_{o} & 0 \\ 0 & - 1 / {L}_{o}\end{matrix} ] ; {V}_{d q} = [ \begin{matrix}{V}_{d} \\ {V}_{q}\end{matrix} ] . & ( 70 )\end{matrix}$$

The active and reactive power injected to Vdq are defined by:

P=3/2(V_{d}I_{d}+V_{q}I_{q}) (71)

Q=3/2(V_{q}I_{d}−V_{d}I_{q}) (72)

The dq frame is synchronized with Vₐ by using a PLL so that V_{dq}=[V̅_{d},0]^{T}, where V̅_{d} represents the nominal voltage peak amplitude of the main grid. Thus, the output of the state-space model is used to represent the active and reactive power received by V_{dq} as follows:

$$Y = [ \begin{matrix}P \\ Q\end{matrix} ] = \frac{3}{2} [ \begin{matrix}{\overline{V}}_{d} & 0 \\ 0 & - {\overline{V}}_{d}\end{matrix} ] [ \begin{matrix}{I}_{o d} \\ {I}_{o q}\end{matrix} ] . \qquad ( 73 )$$

Formulating the model in the dq frame as in (66) allows computing the power injected from E_{dq} to V_{dq} by applying the superposition principle. The superposition principle states that, for all linear systems, the net response caused by two or more inputs is the sum of the responses that would have been caused by each input individually. This implies that the net power injected to V_{dq} can be defined as the sum of the individual power contributions of E_{dq} and V_{dq}. The power contribution of E_{dq} is calculated using the output current when V_{dq}=[0 0]^{T} for the following system:

\dot{x}=A_{dq}x+B_{1dq}E_{dq} (74)

The output current from (70) must be evaluated in (70) to obtain the power contribution of E_{dq}. The same procedure is performed for the power contribution of V_{dq} with E_{dq}=[0 0]^{T} for the following system:

\dot{x}=A_{dq}x+B_{2dq}V_{dq} (75)

then, both power contributions must be added to obtain the net injected power. This concept is useful to implement modern controllers for inverter-based generators since a power controller may be computed for the state-space model in (66) with V_{dq}=[0 0]^{T}. Then, the pre-computed closed-loop power contribution of V_{dq} is subtracted from the reference value to inject a desired power to the main grid. This procedure will be explained below.

It is also important to remark that the system in (66) must be discretized in order to implement it in a real experiment using data acquisition devices and PWM control signals. To discretize it, the state must be augmented using a delay or integrator transfer function to account for the delay induced by the PWM output signal. The discrete-time integrator also reduces the steady-state error in the closed-loop system. The resulting system is given by:

$$[ \begin{matrix}x [ k + 1 ] \\ {E}_{i n t} [ k + 1 ]\end{matrix} ] = [ \begin{matrix}{\overline{A}}_{d q} & {\overline{B}}_{1 d q} \\ 0 & I\end{matrix} ] [ \begin{matrix}x [ k ] \\ {E}_{i n t} [ k ]\end{matrix} ] + [ \begin{matrix}0 \\ {T}_{s} I\end{matrix} ] E [ k ] \qquad ( 76 )$$

where Tₛ is the sampling period, Ā_{dq} and B̅_{1dq} are the discrete-time state and input matrices. The auxiliary variable Eᵢₙₜ represents the integral of the input and the discrete-time state-vector in the dq frame is x[k]=[V_{cd} V_{cd} I_{ld} I_{lq} I_{od} I_{oq}]^{T}.

Model of the Microgrid in Islanded Mode

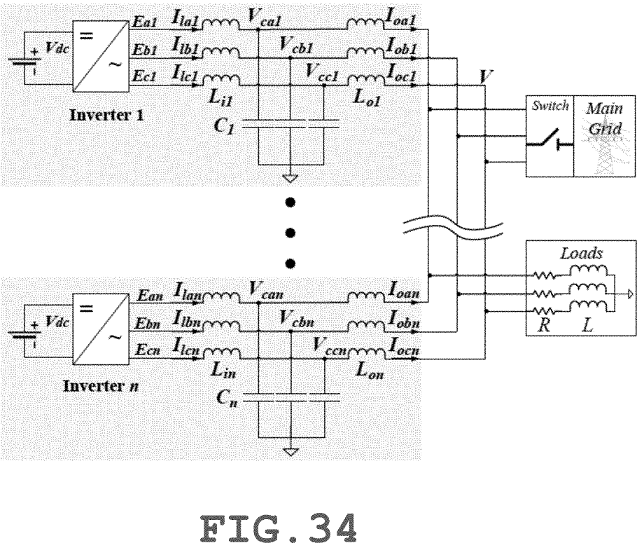

The islanded microgrid model is used to assess stability and robustness of the proposed controller in islanded mode. For grid-connected mode, the state-space model (66) must be used for each generator individually. The circuit considered for the islanded microgrid model is shown in FIG. 34.

Although, many types of loads may exist in microgrids, the load is selected to be an RL circuit because it is the most common type of load found in residential and industrial environments. To obtain the complete microgrid model, the model for one phase of each inverter using (65) must be computed. Then, V must be defined in terms of the output currents and load components as follows:

V=Lİₒₜ+RIₒₜ (77)

where Iₒₜ=Σⱼ₌₁ⁿIₒⱼ with n representing the number of generators. A complete microgrid model is obtained by substituting V from (74) into the model of each inverter (65) and combining all the models. For example, for two generators with a common RL load, the microgrid model in islanded mode for one phase is given by (75).

$$[ \begin{matrix}{\dot{V}}_{c 1} \\ {\dot{I}}_{l 1} \\ {\dot{I}}_{o 1} \\ {\dot{V}}_{c 2} \\ {\dot{I}}_{l 2} \\ {\dot{I}}_{o 2}\end{matrix} ] = [ \begin{matrix}0 & 1 / {C}_{1} & - 1 / {C}_{1} & 0 & 0 & 0 \\ - 1 / {L}_{l 1} & 0 & 0 & 0 & 0 & 0 \\ {L}_{t 2} / {L}_{t} & 0 & ( RL - {RL}_{t 2} ) / {L}_{t} & - L / {L}_{t} & 0 & ( RL - {RL}_{t 2} ) / {L}_{t} \\ 0 & 0 & 0 & 0 & 1 / {C}_{2} & - 1 / {C}_{2} \\ 0 & 0 & 0 & - 1 / {L}_{i 2} & 0 & 0 \\ - L / {L}_{t} & 0 & ( RL - {RL}_{t 1} ) / {L}_{t} & {L}_{t 1} / {L}_{t} & 0 & ( RL - {RL}_{t 1} ) / {L}_{t}\end{matrix} ] [ \begin{matrix}{V}_{c 1} \\ {I}_{l 1} \\ {I}_{o 1} \\ {V}_{c 2} \\ {I}_{l 2} \\ {I}_{o 2}\end{matrix} ] + [ \begin{matrix}0 & 0 \\ 1 / {L}_{i 1} & 0 \\ 0 & 0 \\ 0 & 0 \\ 0 & 1 / {L}_{i 2} \\ 0 & 0\end{matrix} ] [ \begin{matrix}{E}_{1} \\ {E}_{2}\end{matrix} ] \qquad ( 78 )$$

where Lₜ=L(Lₒ₁+Lₒ₂)+Lₒ₁Lₒ₂, Lₜ₁=L+Lₒ₁, and Lₜ₂=L+Lₒ₂. For n inverters, replacing V from (74) into each generator model (65) yields to a linear system with the differential equations for the output currents as shown in (76). Combining the solution of (76) with the model of each inverter (65), the complete microgrid model (77) for n inverters is obtained. The model in (77) is for each phase. However, it must be transformed to the dq frame using (103) previously explained.

$$\begin{matrix}[ \begin{matrix}{\dot{I}}_{o 1} \\ ⋮ \\ {\dot{I}}_{o n}\end{matrix} ] = {[ \begin{matrix}( {L}_{o 1} + L ) & L & L \\ L & ⋱ & L \\ L & L & ( {L}_{o n} + L )\end{matrix} ]}^{- 1} [ \begin{matrix}{V}_{c 1} - {RI}_{t} \\ ⋮ \\ {V}_{c n} - {RI}_{t}\end{matrix} ] = [ \begin{matrix}{φ}_{1} \\ ⋮ \\ {φ}_{n}\end{matrix} ] [ \begin{matrix}{V}_{c 1} \\ {I}_{l 1} \\ {I}_{o 1} \\ ⋮ \\ {V}_{c n} \\ {I}_{l n} \\ {I}_{o n}\end{matrix} ] & ( 79 ) \\ [ \begin{matrix}{V}_{c 1} \\ { }_{l 1} \\ {\dot{I}}_{o 1} \\ ⋮ \\ {V}_{c n} \\ {\dot{I}}_{l n} \\ {\dot{I}}_{o n}\end{matrix} ] = [ \begin{matrix}{\tilde{A}}_{1} & {0}_{2 \times 3} & … & … & {0}_{3 \times 1} \\ & & {φ}_{1} & & \\ {0}_{2 \times 3} & … & {\tilde{A}}_{2} & … & {0}_{2 \times 3} \\ & & {φ}_{2} & & \\ ⋮ & ⋮ & ⋮ & ⋮ & ⋮ \\ {0}_{2 \times 3} & … & … & {0}_{2 \times 3} & {\tilde{A}}_{n} \\ & & {φ}_{n} & & \end{matrix} ] [ \begin{matrix}{V}_{c 1} \\ {I}_{l 1} \\ {I}_{o 1} \\ ⋮ \\ {V}_{c n} \\ {I}_{l n} \\ {I}_{o n}\end{matrix} ] + [ \begin{matrix}{B}_{1} & … & {0}_{3 \times 1} \\ ⋮ & ⋱ & ⋮ \\ {0}_{3 \times 1} & … & {B}_{n}\end{matrix} ] [ \begin{matrix}{E}_{1} \\ ⋮ \\ {E}_{n}\end{matrix} ] & ( 80 )\end{matrix}$$

where:

$${Ã}_{j} = [ \begin{matrix}0 & 1 / {C}_{j} & - 1 / {C}_{j} \\ - 1 / {L}_{j} & 0 & 0\end{matrix} ] , {B}_{j} = {[ \begin{matrix}0 & 1 / {L}_{i j} & 0\end{matrix} ]}^{T} \qquad ( 81 )$$

with 1≤j≤n. Row vectors φⱼ represent the coefficients of each state variable properly arranged from the solution of (76).

Robustness and Stability Analysis to the Open-Loop State-Space Models

Once an open-loop state-space model of the three-phase inverter-based generator is obtained, it is desired to analyze performance, stability, and robustness characteristics such as phase margin, gain margin, eigenvalue structure, etc. These characteristics may be found using methods such as Singular Value plots and root locus. Results from this analysis are used to find the most suitable control method for the present invention.

Robustness and stability analysis must be performed for grid-connected and islanded models. To perform robustness and stability analysis in grid-connected mode, the model of each inverter must be analyzed separately. The discrete transfer function for the i-th inverter is given by:

Gᵢ(z)=C̅_{dqi}(zI−Ā_{dqi})⁻¹B̅_{1dqi}. (82)

where Ā_{dqi}, B̅_{1dqi}, and C̅_{dqi} are the discrete-time form of the i-th inverter state, input, and output matrices respectively. Similarly, to perform robustness and stability analysis in islanded mode, the following discrete-time transfer function of the microgrid is used:

G_{μG}(z)=C̅_{μG}(zI−Ā_{μG})⁻¹B̅_{μG} (83)

where Ā_{μG} and B̅_{μG} are the discrete-time state and input matrices from (77) transformed to the dq frame. The microgrid output matrix is given by C̅_{μG}=diag(C̅_{dq1}, C̅_{dq2}, . . . , C̅_{dqn}).

To assess robustness and stability under component variations, the Robust Control Toolbox from Matlab is used to generate instances of G_{μG}(z) and Gᵢ(z) with randomized variations in components. Obtaining the nominal instances of G_{μG}(z) and Gᵢ(z), and instances under variations, the following robustness and stability analysis can be performed:

Eigenvalue analysis: This analysis consists of plotting the eigenvalues of a Multiple-Input-Multiple-Output (MIMO) transfer function G(z) in the complex z-plane to check whether they remain inside the unit circle. If some of the eigenvalues are located outside the unit circle, it means that the system or its variations are unstable by nature. Eigenvalue location may also provide information about transient response.

Stability Margin Analysis: The disk margin method is used for estimating structured robustness under multiplicative uncertainties for MIMO systems using negative feedback. The disk-based margins are calculated considering all loop interactions and frequencies. Results from this analysis provide a more conservative information about structured gain and phase margins.

Singular value plots: The singular value plot is commonly used to analyze the frequency response of MIMO systems. This plot shows the frequency response of the maximum and minimum singular values of a MIMO transfer function G(z). This way, some performance bounds may be established for the controlled closed-loop system.

Results from the robustness and stability analysis of the open-loop state-space models according to the invention will be discussed below.

Validation of the Open-Loop State-Space Models

Model validation is performed by comparing the response of the mathematical models G_{μG}(z) and Gᵢ(z) against the response of the circuits shown in FIG. 33 and FIG. 34 under the same input signal. This validation requires the interaction of two or more generators connected to the AC bus without any control. For safety reasons, the circuits shown in FIG. 33 and FIG. 34 must be implemented using simulation tools, such as the OPAL 5700 Real Time Simulation libraries for MATLAB-Simulink. The OPAL libraries such as ARTEMiS allow to run accurate simulations of the inverter switching behavior and its effects on inductor currents and capacitor voltages.

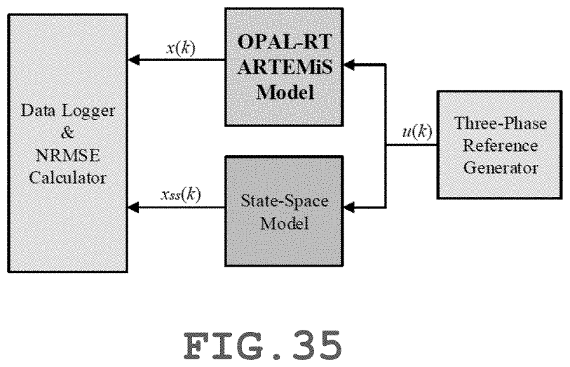

To validate the accuracy of the mathematical model of an inverter connected to the main grid, the simulation of the circuit shown in FIG. 33 must run in parallel with its mathematical model Gᵢ(z). Similarly, to validate the accuracy of the mathematical model of an islanded microgrid, the simulation of the microgrid scheme shown in FIG. 34 must run in parallel with its mathematical model G_{μG}(z). For both validations (grid-connected and islanded mode), the same input signal is used on the mathematical model and the simulated circuit as shown in FIG. 35. The three-phase reference generator produces step changes in amplitude in order to compare transient responses.

Responses of state vector and injected powers are plotted and compared. In addition, the mathematical model and circuit responses are compared using the Normalized Root Mean Squared Error (NRMSE) defined by [87]:

$$NRMSE = 100 \times ( 1 - \frac{‖ {y}_{ref} - y ‖}{‖ {y}_{ref} - mean ( {y}_{ref} ) ‖} ) . \qquad ( 84 )$$

where ∥⋅∥ indicates the 2-norm of a vector. Vectors y and y_{ref} represent the time response of a measurement and its mathematical reference, respectively. The NRMSE varies between −∞ (bad fit) and 100% (perfect fit). The NRMSE is suitable for this validation because it considers the complete measurement during a specific interval of time. The NRMSE must be obtained for each state-variable and power measurement. It is expected to find certain discrepancies between both systems due to parasitic phenomenon and other neglectable nonlinear dynamics of the components that are not being considered in this work. However, parameters such as frequency response and transient response are expected to be similar in both systems. The validation of the open-loop state-space models used in the present invention will be explained below.

Formulation of a Control Method that Optimizes Performance, Stability, and Robustness Characteristics of the Inverter-Based Generator in Islanded Mode

Modern control methods such as LQR, H_{∞}, or μ-synthesis require an open-loop state-space model to implement numerical optimization methods that find a suitable controller according to a specific control objective. The use of the proposed integrated model in the dq frame (66), along with the use of the superposition principle, allows to implement modern control methods that not only improve robustness and transient response, but also integrates V-I and power sharing dynamics for inverter-based generators.

According to the invention, the proposed PQVI controller is based on the classic LQR problem. The LQR controller provides guaranteed robustness properties such as infinity gain margin and a minimum phase margin of 60°. Also, the LQR controller is intended to minimize energy in the states and inputs, which means better transient response and less power losses during transient responses. However, the classic LQR controller's objective is to bring state variables to zero from a certain initial state x₀. Since optimal power sharing is a common tracking problem, a modification to the classic LQR controller, known as Optimal Reference Tracker (LQR-ORT), is used for this invention.

The design of the LQR-ORT controller for each inverter is based on the grid-connected model (66). This controller is able to operate in either grid-connected or islanded mode. If the grid is suddenly disconnected, there will be voltage and frequency deviations in the AC bus, which are restored using supplementary loops without communications. Also, the supplementary loop for restoring voltage deviations is capable of distributing power generation according to the rated power of each inverter.

Integrated PQVI Controller

The discrete-time LQR-ORT optimization problem defines a cost function that weighs the sum of squares of the system input E_{dq}[k] and the output error e[k]=y[k]−r[k]. The discrete LQR-ORT cost function is given by:

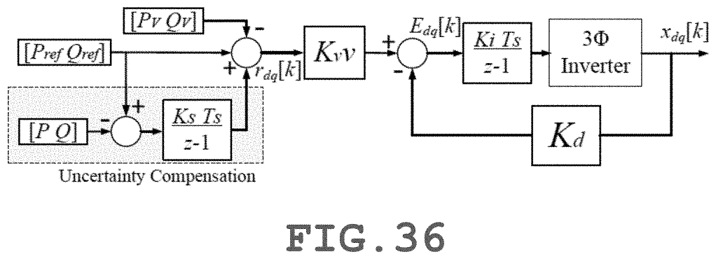

J(k₀)=½Σₖ₌ₖ_{ₒ}^{T}(e[k]^{T}Qₚe[k]+E_{dq}^{T}[k]RₚE_{dq}[k]) (85)

where Qₚ is a symmetric positive semi-definite weighting matrix and Rₚ is a symmetric positive definite weighting matrix. The control scheme of the LQR-ORT controller is shown in FIG. 36. The discrete-time state-space model of the three-phase inverter is given by:

x_{dq}[k+1]=Ā_{dq}x_{dq}[k]+B̅_{1dq}E_{dq}[k]

Y=Cx_{dq}[k]. (86)

Therefore, control law is given by:

E_{dq}=−K_{d}x_{dq}[k]+Kᵥvr_{dq}[k]. (87)

The optimal state-feedback controller matrix is given by:

K_{d}(B̅_{1dq}^{T}SB̅_{1dq}+Rₚ)⁻¹B̅_{1dq}^{T}SĀ_{dq} (88)

where S is the solution to the Discrete Algebraic Ricatti Equation (DARE):

S=ĀT_{dq}^{T}S(Ā_{dq}−B̅_{1dq}K_{d})+C^{T}QₚC. (89)

The term Kᵥ=(B̅_{ldq}^{T}SB̅_{ldq}+Rₚ)⁻¹B̅_{1dq}^{T} is associated to the closed-loop system dynamics as in (85). To find v, the following auxiliary difference equation must be solved:

v[k+1]=(Ā_{dq}−B̅_{1dq}K_{d})^{T}v[k]+C^{T}Qₚr[k]. (90)

Considering that the controller is designed in the dq frame, steady-state is achieved at 0 Hz. Thus, (78) must be solved assuming v[k+1]=v[k] and a unit r[k] as follows:

v=[I−(Ā_{dq}−B̅_{1dq}K_{d})^{T}]⁻¹C^{T}Qₚ. (91)

The reference signal r[k] is given by:

$$r [ k ] = [ \begin{matrix}{P}_{ref} \\ {Q}_{ref}\end{matrix} ] - [ \begin{matrix}{P}_{V} \\ {Q}_{V}\end{matrix} ] + \frac{{K}_{s} {T}_{s}}{z - 1} [ \begin{matrix}{P}_{ref} - P \\ {Q}_{ref} - Q\end{matrix} ] . \qquad ( 92 )$$

Terms P and Q represent the measured power injected to the main grid. An integrator with a low-gain Kₛ is used to eliminate power tracking error induced by uncertainties in the AC bus or component values, without affecting stability margins. In addition, the AC bus power contribution vector [P_{V} Q_{V}]^{T} is subtracted from the power reference vector [P_{ref} Q_{ref}]^{T} to obtain the net power reference as previously explained. To compute P_{V} and Q_{V}, the superposition principle must be used by solving the following closed-loop state-space model with infinite horizon for r[k]=[0 0]^{T} and V_{dq}=[V̅_{dq} 0]^{T}:

x[k+1]=(Ā_{dq}−B̅_{1dq}K_{d})x[k]+B̅_{1dq}Kᵥvr[k]+B̅_{2dq}V_{dq} (93)

Then, the steady-state values of I_{od} and I_{oq} must be replaced in (70) to obtain P_{V} and Q_{V}.

Proportional Power Sharing and Voltage Restoration

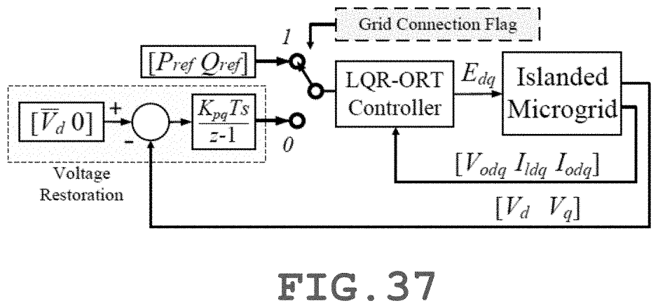

Voltage restoration loop is used to recover voltage deviations when the microgrid is operating in islanded mode. Control scheme for the voltage restoration loop is shown in FIG. 37. When the main grid connection is lost, the voltage in the AC bus drops and the Grid Connection Flag becomes zero. The detection of grid disconnection is assumed, and its development is out of the scope of this research. To restore AC bus voltage without communications, a supplementary loop is implemented on each inverter. This loop integrates the error of V_{dq} referred to V̅_{dq}. The output of this integrator becomes the new power reference of the LQR-ORT controller. The expression of the new power reference for the i-th inverter is given by:

$$\begin{matrix}{P}_{refi} = \frac{{K}_{p i} {T}_{s}}{z - 1} ( {V}_{d} - {\overline{V}}_{d} ) & ( 94 ) \\ {Q}_{refi} = \frac{{K}_{qi} {T}_{s}}{z - 1} ( {V}_{q} ) . & ( 95 )\end{matrix}$$

According to (70), the active power gain Kₚᵢ must be positive and the reactive power gain K_{qi} must be negative. In steady state, P_{refi}=Pᵢ for the LQR-ORT controller. Then, for a pair of inverters connected to the AC bus:

$$\begin{matrix}\frac{{P}_{1}}{{P}_{2}} = \frac{{K}_{p 1}}{{K}_{p 2}} & ( 96 ) \\ \frac{{Q}_{1}}{{Q}_{2}} = \frac{{K}_{q 1}}{{K}_{q 2}} . & ( 97 )\end{matrix}$$

Expressions (93) and (94) result from dividing power expressions (91) and (92) for a pair of inverters connected to the AC bus. These expressions demonstrate that the supplementary loop is capable of distributing power according to the rated power capability of each inverter without communications in islanded mode. This means that, if inverter 1 has a rated power of 1 pu and inverter 2 has a rated power of 2 pu, inverter 2 will share twice the power shared by inverter 1 if 2K_{pq1}=K_{pq2}.

Inverter Synchronization and Frequency Restoration

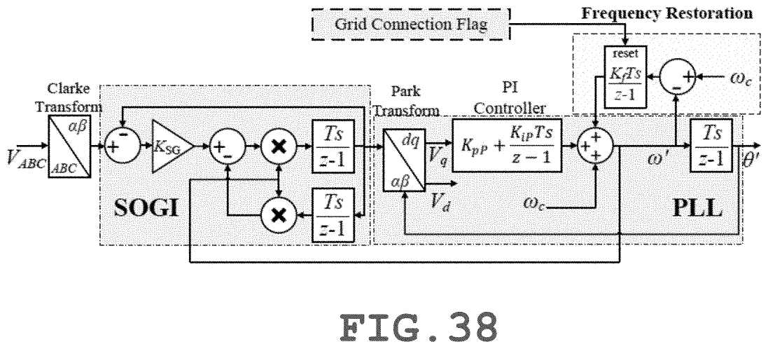

To synchronize each inverter with the AC bus, a Second Order Generalized Integrator (SOGI-PLL) is used as shown in FIG. 38. The output of the SOGI-PLL is used to perform the dq transformation of the input and output signals for the LQR-ORT controller. When grid connection is lost, the operating frequency of the microgrid drops and the frequency restoration loop is activated. The frequency restoration loop integrates the frequency error and compensates the PLL operating frequency ω′. Hence, the output frequency of each generator will increase and the microgrid frequency returns to the nominal value in islanded mode. Thus, the proposed frequency restoration loop gives the capability of working in both grid-connected and islanded modes not only to the proposed PQVI controller, but also to any controller implemented in the dq frame.

The expression for the output frequency of the SOGI-PLL with the frequency restoration loop is given by:

$${ω}^{′} = {V}_{q} ( {K}_{p P} + \frac{{K}_{i P} {T}_{s}}{z - 1} ) + {ω}_{c} + \frac{{F}_{g} {K}_{f} {T}_{s}}{z - 1} ( {ω}^{′} - {ω}_{c} ) \qquad ( 98 )$$

where F_{g}=1 is one when grid connection is lost and F_{g}=0 when the grid is engaged. Assuming that the SOGI-PLL is synchronized, such that V_{q}=0, it can be noted that in steady-state, z→1 and ω′≈ω_{c}.

Complete PQVI Control Scheme

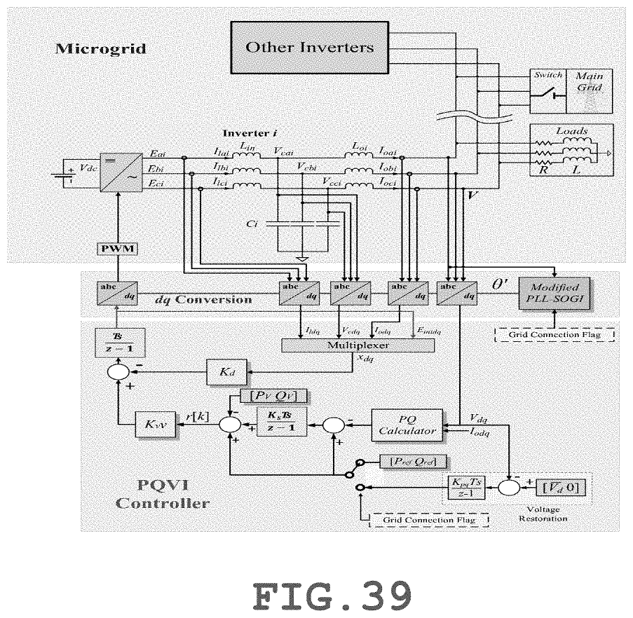

The complete PQVI control scheme for one inverter is shown in FIG. 39. Each inverter has its own PLL-SOGI synchronized with the AC bus. The output of the PLL-SOGI is used to perform the dq conversion of the states and control input. When the microgrid is connected to the main grid, each inverter works as a grid-following generator. This means that the AC bus voltage and frequency are imposed by the main grid. When grid connection is lost, the Grid Connection Flag is activated, each inverter starts working as a grid-forming generator, and the voltage and frequency restoration loops are engaged.

Robustness and Stability Analysis to the Controlled State-Space Model

This analysis provides a concrete view of the capabilities of the proposed controller of the invention. To perform robustness and stability analyses, the following open-loop model of the controlled plant in grid-connected mode must be used for each inverter:

Λᵢ(z)=K_{di}(zI−Ā_{dqi})⁻¹B̅_{1dqi}. (99)

In addition, the following open-loop model of the controlled plant in islanded mode must be used for the complete microgrid:

Λ_{μG}(z)=K_{dT}(zI−Ā_{μG})⁻¹B̅_{μG}. (100)

where Ā_{μG} and B̅_{μG} are the discrete-time state and input matrices from (77) transformed to the dq frame. The feedback control matrix is given by K_{dT}=diag(K_{d1}, K_{d2}, . . . , K_{dn}). The stability can be assessed by analyzing the return difference (I+Λ(z)), which defines the location of the closed-loop eigenvalues:

λ{(I+Λᵢ(z))⁻¹}=λ{Ā_{dqi}−B̅_{1dgi}K_{di}} (101)

λ{(I+Λ_{μG}(z))⁻¹}=λ{Ā_{μG}−B̅_{μG}K_{dT}} (102)

The operator λ{⋅} refers to the eigenvalue computation. The singular value diagram is commonly used to analyze the frequency response and dynamics of MIMO systems. This diagram shows the frequency response of the maximum and minimum singular values of a matrix transfer function. Also, it is possible to set some performance requirements of the closed-loop system regarding to disturbance rejection and transient response. The following requirements are proposed to evaluate the singular value plots of Λ₁(z), Λ₂(z), Λ₃(z), and Λ_{μG}(z):
1) To achieve zero steady state error, it is required that all Λᵢ(z) have a slope of 20 dB/dec at low frequencies
2) IEEE 1547-2018 standard specifies that a converter connected to the main grid must have a frequency ride through in a band of ±4 Hz or ±25.13 rad/s. For the dq frame, this is considered as a low-frequency disturbance in the process. To achieve the ride through requirement, the minimum singular value of all Λᵢ(z) must be above 40 dB in the frequencies below25.14 rad/s.
3) To preserve settling time, the crossover frequency cannot vary more than 10% under process disturbances.

Harmonic current is considered a disturbance in the process. In grid-connected mode, the main grid provides harmonic currents. Thus, no requirements for harmonic compensation are proposed for grid-connected mode. For islanded mode, the THD has to be less than or equal to 5% in compliance with to IEEE 1547-2018. Results from the robustness and stability analysis of the controlled microgrid in both grid-connected and islanded modes for the invention will be described below.

Controller Performance Validation

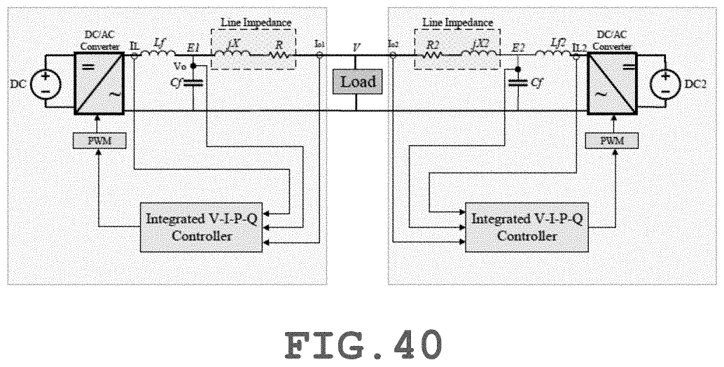

To validate the performance, the integrated PQVI controller is simulated using two or more inverter-based generators connected to a common AC bus and a common load as shown in FIG. 40.

Once the integrated PQVI controller is validated in simulation, it must be validated on the microgrid testbed using the dSPACE system. For this test, two or more inverters with different filter components must be connected to a physical AC bus that are also connected to a controlled three-phase AC load similar to FIG. 40. The AC bus can be connected or disconnected from the main grid to analyze performance of the proposed controller in both grid-connected and islanded modes. Performance is evaluated under variations in loads. It is expected that both generators share active and reactive power proportionally to their power ratings without communication between them in islanded mode. Also, it is expected that harmonic distortion meets the IEEE 1547 standard requirement of a THD below 5%.

Results & Analysis

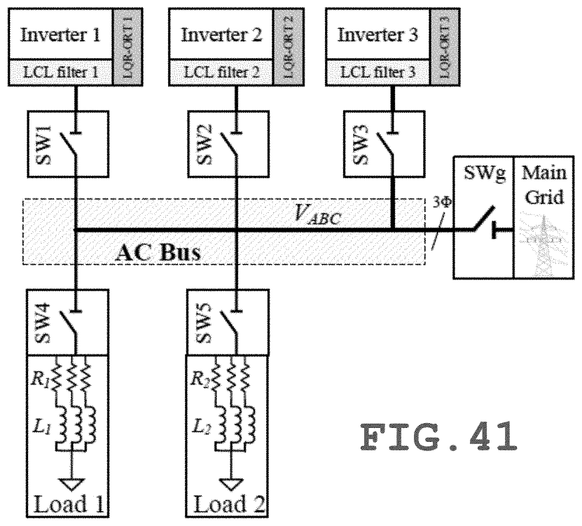

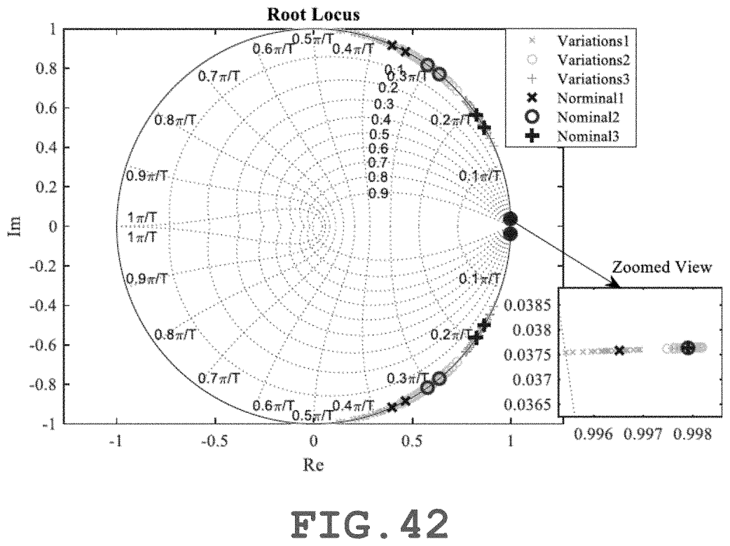

To demonstrate the effectiveness of the PQVI controller of the invention, a microgrid scenario with three inverter-based generators and two loads is proposed, as shown in FIG. 41. Connection switches are located at the output of each inverter, at the input to each load, and at the point of connection with the main grid. Each inverter has its own LQR-ORT controller and supplementary control loops.

Microgrid Model

The parameter specifications for the experiment are summarized in Table 3 below. To obtain the model of the microgrid in grid-connected mode, the component values were entered in (66) for all inverters. Sampling frequency was defined to be ƒₛ=10 kHz according to Shannon sampling theory. This selection allows controller regulating harmonics up to 17-th order equivalent to ƒₕ₁₇=1,020 Hz. The three models were discretized and augmented with integrators using (73). This resulted in three independent models, one for each inverter. Numerical values of each model in grid-connected mode are determined as follows.

State-space models of each inverter connected to the main grid and the entire microgrid in islanded mode are provided. Discrete state-space models are presented in the dq frame. Sampling frequency was defined to be ƒₛ=10 kHz according to Shannon sampling theory. This selection allows controller regulating harmonics up to 17-th order equivalent to ƒₕ₁₇=1,020 Hz. Computed controllers are only presented in discrete-time.

Grid-Connected Inverters

For each inverter connected to the main grid, the following state-space model was used:

x_{dq}[k+1]=Ā_{dq}x_{dq}[k]+B̅_{1dq}E_{dq}[k]

Y=Cx_{dq}[k]. (103)

where

x_{dq}=I_{ld}I_{lq}V_{cd}V_{cq}I_{od}I_{oq}E_{intd}E_{intq}]^{T};E_{dq}=[E_{d}E_{q}]^{T} (104)

Assuming a main grid voltage V_{dq}=[120\sqrt{2} 0]^{T}, the following output matrix is defined for all inverters:

$$C = [ \begin{matrix}0 & 0 & 0 & 0 & 254.5584 & 0 & 0 & 0 \\ 0 & 0 & 0 & 0 & 0 & - 254.5584 & 0 & 0\end{matrix} ] \qquad ( 105 )$$

Inverter 1

State-Space Model

$${\overline{A}}_{d q 1} = [ \begin{matrix}0.4321 & 0.0163 & 9.1123 & 0.3437 & - 9.1 \; 123 & - 0.3 \; 437 & 0.2837 & 0.0070 \\ - 0.0163 & 0.4321 & - 0.3437 & 9.1123 & 0.3437 & - 9.1 \; 123 & - 0.0 \; 070 & 0.2837 \\ - 0.0445 & - 0.0017 & 0.7157 & 0.0270 & 0.2836 & 0.0107 & 0.0501 & 0.0009 \\ 0.0017 & - 0.0445 & - 0.0270 & 0.7157 & - 0.0 \; 107 & 0.2836 & - 0.0 \; 009 & 0.0501 \\ 0.0445 & 0.0017 & 0.2836 & 0.0107 & 0.7157 & 0.0270 & 0.0055 & 0.0002 \\ - 0.0017 & 0.0445 & - 0.0107 & 0.2836 & - 0.0 \; 270 & 0.7157 & - 0.0 \; 002 & 0.0055 \\ 0 & 0 & 0 & 0 & 0 & 0 & 1 & 0 \\ 0 & 0 & 0 & 0 & 0 & 0 & 0 & 1\end{matrix} ] \\$$

$${\overline{B}}_{1 d q 1} = [ \begin{matrix}0 & 0 \\ 0 & 0 \\ 0 & 0 \\ 0 & 0 \\ 0 & 0 \\ 0 & 0 \\ 0.0001 & 0 \\ 0 & 0.0001\end{matrix} ]$$

Controller

$${K}_{d 1} = [ \begin{matrix}- 12 \; 1.8 .41 & - 62.37 & 6383.08 & 1232.97 & 23441.32 & 2106.23 & 5236.10 & 73.16 \\ 62.37 & - 1218.41 & - 1232.97 & 6383.08 & - 2106.23 & 23441.32 & - 73.16 & 5236.10\end{matrix} ]$$

$${K}_{v} {v}_{1} = {[ \begin{matrix}117.3282 & 11.5299 \\ 11.5299 & - 11 \; 7.3282\end{matrix} ] \\ [ {P}_{V 1} {Q}_{V 1} ]}^{T} = [ \begin{matrix}- 5746. 130 \\ - 54 \; 9.409\end{matrix} ]$$

Inverter 2

State-Space Model

$${\overline{A}}_{d q 2} = [ \begin{matrix}0.6074 & 0.0229 & 9.8282 & 0.3707 & - 9.8 \; 282 & - 0.3 \; 707 & 0.0980 & 0.0024 \\ - 0.0 \; 229 & 0.6074 & - 0.3 \; 707 & 9.8282 & 0.3707 & - 9.8 \; 282 & - 0.0 \; 024 & 0.0980 \\ - 0.0 \; 160 & - 0.0 \; 006 & 0.9013 & 0.0340 & 0.0980 & 0.0037 & 0.0179 & 0.0003 \\ 0.0006 & - 0.0 \; 160 & - 0.0 \; 340 & 0.9013 & - 0.0 \; 037 & 0.0980 & - 0.0 \; 003 & 0.0179 \\ 0.0480 & 0.0018 & 0.2939 & 0.0111 & 0.7054 & 0.0266 & 0.0019 & 0.0001 \\ - 0.0018 & 0.0480 & - 0.0 \; 111 & 0.2939 & - 0.0 \; 266 & 0.7054 & - 0.0 \; 001 & 0.0019 \\ 0 & 0 & 0 & 0 & 0 & 0 & 1 & 0 \\ 0 & 0 & 0 & 0 & 0 & 0 & 0 & 1\end{matrix} ]$$

$${\overline{B}}_{1 d q 2} = [ \begin{matrix}0 & 0 \\ 0 & 0 \\ 0 & 0 \\ 0 & 0 \\ 0 & 0 \\ 0 & 0 \\ 0.0001 & 0 \\ 0 & 0.0001\end{matrix} ]$$

Controller

$${K}_{d 2} = [ \begin{matrix}- 1730.34 & - 87.67 & 12833.16 & 2941.53 & 19023.82 & 1727.68 & 3716.85 & 54.99 \\ 87.67 & - 1730.34 & - 2941.53 & 12833.16 & - 1727.68 & 19023.82 & - 54.99 & 3716.85\end{matrix} ] \\$$

$${K}_{v} {v}_{2} = {[ \begin{matrix}125.3842 & 16.6365 \\ 16.6365 & - 125. 3842\end{matrix} ] \\ [ {P}_{V 2} {Q}_{V 2} ]}^{T} = [ \begin{matrix}- 263 \; 5.126 \\ - 247. 277\end{matrix} ]$$

Inverter 3

State-Space Model

$${\overline{A}}_{d q 3} = [ \begin{matrix}0.7001 & 0.0264 & 10.1979 & 0.3846 & - 10.1979 & - 0.3 \; 846 & 0.1496 & 0.0037 \\ - 0.0 \; 264 & 0.7001 & - 0.3 \; 846 & 10.1979 & 0.3846 & - 10.1979 & - 0.0 \; 037 & 0.1496 \\ - 0.0 \; 249 & - 0.0 \; 009 & 0.8497 & 0.0320 & 0.1496 & 0.0056 & 0.0264 & 0.0005 \\ 0.0009 & - 0.0 \; 249 & - 0.0 \; 320 & 0.8497 & - 0.0 \; 056 & 0.1496 & - 0.0 \; 005 & 0.0264 \\ 0.0249 & 0.0009 & 0.1496 & 0.0056 & 0.8497 & 0.0320 & 0.0014 & 0.0000 \\ - 0.0 \; 009 & 0.0249 & - 0.0 \; 056 & 0.1496 & - 0.0 \; 320 & 0.8497 & 0.0000 & 0.0014 \\ 0 & 0 & 0 & 0 & 0 & 0 & 1 & 0 \\ 0 & 0 & 0 & 0 & 0 & 0 & 0 & 1\end{matrix} ]$$

$${\overline{B}}_{1 d q 3} = [ \begin{matrix}0 & 0 \\ 0 & 0 \\ 0 & 0 \\ 0 & 0 \\ 0 & 0 \\ 0 & 0 \\ 0.0001 & 0 \\ 0 & 0.0001\end{matrix} ]$$

Controller

$${K}_{d 3} = [ \begin{matrix}- 1057.25 & - 58.51 & 11441.44 & 2028.32 & 19604.84 & 2480.08 & 3805.08 & 55.47 \\ 58.51 & - 1057.25 & - 2028.32 & 11441.44 & - 2480.08 & 19604.84 & - 55.47 & 3805.98\end{matrix} ]$$

$${K}_{v} {v}_{3} = {[ \begin{matrix}125.3842 & 16.6365 \\ 16.6365 & - 12 \; 5.3842\end{matrix} ] \\ [ {P}_{V 3} {Q}_{V 3} ]}^{T} = [ \begin{matrix}- 263 \; 5.1 \; 26 \\ 247.277\end{matrix} ]$$

MATLAB codes to develop the grid-connected and islanded model are discussed at the end of the specification.

TABLE 3
Parameter Specifications for the LQR-ORT Controller

| Parameter | SYMBOL | Value | |
|---|---|---|---|
| Grid Voltage | V | 120 | V_{RMS} |
| DC bus Voltage | V_{dc} | 350 | V |
| Grid Frequency | f (ω_{c}) | 60 Hz (376.99 rad/s) | |
| Output Inductance | Lₒ₁, Lₒ₂, Lₒ₃ | 1.8 mH, 1.8 mH, 3.6 mH | |
| Input Inductance | Lᵢ₁, Lᵢ₂, Lᵢ₃ | 1.8 mH, 5.4 mH, 3.6 mH | |
| Filter Capacitance | C₁, C₂, C₃ | 8.8 | μF |
| PWM Frequency | f_{PWM} | 10 | kHz |
| Sampling Period | Tₛ | 100 | μs |

| | | |
|---|---|---|
| Load 1 | R₁, L₁ | 85.7 Ω, 0.46 H |
| Load 2 | R₁, L₁ | 171.43 Ω, 0.53 H |
| Error Weighting Matrix | Qₚ₁, Qₚ₂, Qₚ₃ | {5, 4.9, 4.8} × 10³ × I_{2×2} |
| Input Weighting Matrix | Rₚ₁, Rₚ₂, Rₚ₃ | {0.2, 0.15, 0.18} × I_{2×2} |
| Inner Integrator Gain | Kᵢ₁, Kᵢ₂, Kᵢ₃ | 1 |
| Outer Integrator Gain | Kₛ₁, Kₛ₂, Kₛ₃ | 5 |
| SOGI gain | K_{SG} | 0.7 |
| PLL Proportional Gain | K_{pP} | 0.28307 |
| PLL Integral Gain | K_{iP} | 7.5102 |
| Frequency Restoration Gain | K_{f} | 100 |
| Power Rating | S₁, S₂, S₃ | 500, 1000, 1500 VA |
| Voltage Restoration Gain | Kₚ₁, Kₚ₂, Kₚ₃ | 1000, 2000, 3000 |
| (Active) | | |
| Voltage Restoration Gain | K_{q1}, K_{q2}, K_{q3} | −1000, −2000, −3000 |
| (Reactive) | | |

The complete microgrid model in islanded-mode was obtained by merging the grid-connected models and using (76) and (77). The resulting model for one phase of the islanded microgrid with three generators and a common RL load is shown in (100). This model was transformed to the dq frame using (103) as previously explained. Component values from Table 3 were evaluated and the model was discretized. Finally, the discretized model was augmented using integrators. This resulted in a state-space system with 6 input, 6 output, and 24 states. Numerical values of the resulting islanded microgrid model are presented below.

$$[ \begin{matrix}{\dot{V}}_{c 1} \\ {\dot{I}}_{l 1} \\ {\dot{I}}_{o 1} \\ {\dot{V}}_{c 2} \\ {\dot{I}}_{l 2} \\ {\dot{I}}_{o 2} \\ {\dot{V}}_{c 3} \\ {\dot{I}}_{l 3} \\ {\dot{I}}_{o 3}\end{matrix} ] = [ \begin{matrix}0 & \frac{1}{{C}_{1}} & - \frac{1}{{C}_{1}} & 0 & 0 & 0 & 0 & 0 & 0 \\ - \frac{1}{{L}_{i 1}} & 0 & 0 & 0 & 0 & 0 & 0 & 0 & 0 \\ - \frac{{L}_{d 1}}{{L}_{t}} & 0 & - \frac{{RL}_{o 2} {L}_{o 3}}{{L}_{t}} & - \frac{{LL}_{o 3}}{{L}_{t}} & 0 & - \frac{{RL}_{o 2} {L}_{o 3}}{{L}_{t}} & - \frac{{LL}_{o 2}}{{L}_{t}} & 0 & - \frac{{RL}_{o 2} {L}_{o 3}}{{L}_{t}} \\ 0 & 0 & 0 & 0 & \frac{1}{{C}_{2}} & - \frac{1}{{C}_{2}} & 0 & 0 & 0 \\ 0 & 0 & 0 & - \frac{1}{{L}_{i 2}} & 0 & 0 & 0 & 0 & 0 \\ - \frac{{LL}_{o 3}}{{L}_{t}} & 0 & - \frac{{RL}_{o 1} {L}_{o 3}}{{L}_{t}} & \frac{{L}_{d 2}}{{L}_{t}} & 0 & - \frac{{RL}_{o 1} {L}_{o 3}}{{L}_{t}} & - \frac{{LL}_{o 1}}{{L}_{t}} & 0 & - \frac{{RL}_{o 1} {L}_{o 3}}{{L}_{t}} \\ 0 & 0 & 0 & 0 & 0 & 0 & 0 & \frac{1}{{C}_{3}} & - \frac{1}{{C}_{3}} \\ 0 & 0 & 0 & 0 & 0 & 0 & - \frac{1}{{L}_{i 3}} & 0 & 0 \\ - \frac{{LL}_{o 2}}{{L}_{t}} & 0 & - \frac{{RL}_{o 1} {L}_{o 2}}{{L}_{t}} & - \frac{{LL}_{o 1}}{{L}_{t}} & 0 & - \frac{{RL}_{o 1} {L}_{o 2}}{{L}_{t}} & \frac{{L}_{d 3}}{{L}_{t}} & 0 & - \frac{{RL}_{o 1} {L}_{o 2}}{{L}_{t}}\end{matrix} ] [ \begin{matrix}{V}_{c 1} \\ {I}_{l 1} \\ {I}_{o 1} \\ {V}_{c 2} \\ {I}_{l 2} \\ {I}_{o 2} \\ {V}_{c 3} \\ {I}_{l 3} \\ {I}_{o 3}\end{matrix} ] + [ \begin{matrix}0 & 0 & 0 \\ \frac{1}{{L}_{i 1}} & 0 & 0 \\ 0 & 0 & 0 \\ 0 & 0 & 0 \\ 0 & \frac{1}{{L}_{i 2}} & 0 \\ 0 & 0 & 0 \\ 0 & 0 & 0 \\ 0 & 0 & \frac{1}{{L}_{i 3}} \\ 0 & 0 & 0\end{matrix} ] [ \begin{matrix}{E}_{1} \\ {E}_{2} \\ {E}_{3}\end{matrix} ] \\ where {L}_{t} = L ( {L}_{o 1} {L}_{o 2} + {L}_{o 1} {L}_{o 3} + {L}_{o 2} {L}_{o 3} + {L}_{o 1} {L}_{o 2} {L}_{o 3} ) , {L}_{d 1} = L {L}_{o 2} + {L}_{o 2} {L}_{o 3} + L {L}_{o 3} , \\ {L}_{d 2} = L {L}_{o 1} + {L}_{o 1} {L}_{o 3} + L {L}_{o 3} , and {L}_{d 3} = L {L}_{o 1} + {L}_{o 1} {L}_{o 2} + L {L}_{o 2} . \qquad ( 106 )$$

Islanded Microgrid

For the islanded microgrid the following state-space model was used:

x_{μG}[k+1]=Ā_{μG}x_{μG}[k]+B̅_{μG}E_{μG}[k] (107)

Y_{μG}=C_{μG}x_{μG}[k].

State vector and input vector are given by x_{μG}=[x_{1dq} x_{2dq} x_{3dq}] and E_{μG}=[E_{1dq} E_{2dq} E_{3dq}], respectively. where the state matrix is given by:

$${\overline{A}}_{μ G} = [ \begin{matrix}0.538 & 0.020 & 9.544 & 0.360 & - 9.504 & - 0.358 & 0 & 0 & 0.110 & 0.004 & 0.441 & 0.017 & - 0.401 & - 0.015 & 0 & 0 & 0.058 & 0.002 & 0.113 & 0.004 & - 0.074 & - 0.003 & 0 & 0 \\ - 0.020 & 0.538 & - 0.360 & 9.544 & 0.358 & - 9.504 & 0 & 0 & - 0.004 & 0.110 & - 0.017 & 0.017 & 0.015 & - 0.401 & 0 & 0 & - 0.002 & 0.058 & - 0.004 & 0.113 & 0.003 & - 0.074 & 0 & 0 \\ - 0.047 & - 0.002 & 0.709 & 0.027 & 0.289 & 0.011 & 0 & 0 & - 0.002 & 0.000 & - 0.006 & 0.441 & 0.006 & 0.000 & 0 & 0 & - 0.001 & 0.000 & - 0.002 & 0.000 & 0.001 & 0.000 & 0 & 0 \\ 0.002 & - 0.047 & 0.027 & 0.709 & - 0.011 & 0.289 & 0 & 0 & 0.000 & - 0.002 & 0.000 & 0.000 & 0.000 & 0.006 & 0 & 0 & 0.000 & - 0.001 & 0.000 & - 0.002 & 0.000 & 0.001 & 0 & 0 \\ 0.027 & 0.001 & 0.171 & 0.006 & 0.821 & 0.031 & 0 & 0 & - 0.019 & - 0.001 & - 0.116 & - 0.006 & 0.109 & 0.004 & 0 & 0 & - 0.010 & 0.000 & - 0.030 & - 0.001 & 0.023 & 0.001 & 0 & 0 \\ - 0.001 & 0.027 & - 0.006 & 0.171 & - 0.031 & 0.821 & 0 & 0 & 0.001 & - 0.019 & 0.004 & - 0.004 & - 0.004 & 0.109 & 0 & 0 & 0.000 & - 0.010 & 0.001 & - 0.030 & - 0.001 & 0.023 & 0 & 0 \\ 0.000 & 0.000 & 0.000 & 0.000 & 0.000 & 0.000 & 1 & 0 & 0.000 & 0.000 & 0.000 & 0.000 & 0.000 & 0.000 & 0 & 0 & 0.000 & 0.000 & 0.000 & 0.000 & 0.000 & 0.000 & 0 & 0 \\ 0.000 & 0.000 & 0.000 & 0.000 & 0.000 & 0.000 & 0 & 1 & 0.000 & 0.000 & 0.000 & 0.000 & 0.000 & 0.000 & 0 & 0 & 0.000 & 0.000 & 0.000 & 0.000 & 0.000 & 0.000 & 0 & 0 \\ 0.110 & 0.004 & 0.441 & 0.017 & - 0.400 & - 0.015 & 0 & 0 & 0.722 & 0.027 & 10.279 & 0.388 & - 10.238 & - 0.386 & 0 & 0 & 0.060 & 0.002 & 0.116 & 0.004 & - 0.075 & - 0.003 & 0 & 0 \\ - 0.004 & 0.110 & - 0.017 & 0.441 & 0.015 & - 0.400 & 0 & 0 & - 0.027 & 0.722 & - 0.388 & 10.279 & 0.386 & - 10.238 & 0 & 0 & - 0.002 & 0.060 & - 0.004 & 0.116 & 0.003 & - 0.075 & 0 & 0 \\ - 0.001 & 0.000 & - 0.002 & 0.000 & 0.002 & 0.000 & 0 & 0 & - 0.017 & - 0.001 & 0.899 & 0.034 & 0.100 & 0.004 & 0 & 0 & 0.000 & 0.000 & - 0.001 & 0.000 & 0.000 & 0.000 & 0 & 0 \\ 0.000 & - 0.001 & 0.000 & - 0.002 & 0.000 & 0.002 & 0 & 0 & 0.001 & - 0.017 & - 0.034 & 0.899 & - 0.004 & 0.100 & 0 & 0 & 0.000 & 0.000 & 0.000 & - 0.001 & 0.000 & 0.000 & 0 & 0 \\ - 0.017 & - 0.001 & - 0.112 & - 0.004 & 0.105 & 0.004 & 0 & 0 & 0.029 & 0.001 & 0.178 & 0.007 & 0.815 & 0.031 & 0 & 0 & - 0.010 & 0.000 & - 0.030 & - 0.001 & 0.023 & 0.001 & 0 & 0 \\ 0.001 & - 0.017 & 0.004 & - 0.112 & - 0.004 & 0.105 & 0 & 0 & - 0.001 & 0.029 & - 0.007 & 0.178 & - 0.031 & 0.815 & 0 & 0 & 0.000 & - 0.010 & 0.001 & - 0.030 & - 0.001 & 0.023 & 0 & 0 \\ 0.000 & 0.000 & 0.000 & 0.000 & 0.000 & 0.000 & 0 & 0 & 0.000 & 0.000 & 0.000 & 0.000 & 0.000 & 0.000 & 1 & 0 & 0.000 & 0.000 & 0.000 & 0.000 & 0.000 & 0.000 & 0 & 0 \\ 0.000 & 0.000 & 0.000 & 0.000 & 0.000 & 0.000 & 0 & 0 & 0.000 & 0.000 & 0.000 & 0.000 & 0.000 & 0.000 & 0 & 1 & 0.000 & 0.000 & 0.000 & 0.000 & 0.000 & 0.000 & 0 & 0 \\ 0.029 & 0.001 & 0.113 & 0.004 & - 0.103 & - 0.004 & 0 & 0 & 0.030 & 0.001 & 0.116 & 0.004 & - 0.105 & - 0.004 & 0 & 0 & 0.861 & 0.032 & 5.413 & 0.204 & - 5.403 & - 0.204 & 0 & 0 \\ - 0.001 & 0.029 & - 0.004 & 0.113 & 0.004 & - 0.103 & 0 & 0 & - 0.001 & 0.030 & - 0.004 & 0.116 & 0.004 & - 0.105 & 0 & 0 & - 0.032 & 0.861 & - 0.204 & 5.413 & 0.204 & - 5.403 & 0 & 0 \\ 0.000 & 0.000 & - 0.001 & 0.000 & 0.001 & 0.000 & 0 & 0 & 0.000 & 0.000 & - 0.001 & 0.000 & 0.001 & 0.000 & 0 & 0 & - 0.026 & - 0.001 & 0.922 & 0.035 & 0.077 & 0.003 & 0 & 0 \\ 0.000 & 0.000 & 0.000 & - 0.001 & 0.000 & 0.001 & 0 & 0 & 0.000 & 0.000 & 0.000 & - 0.001 & 0.000 & 0.001 & 0 & 0 & 0.001 & - 0.026 & - 0.035 & 0.922 & - 0.003 & 0.077 & 0 & 0 \\ - 0.010 & 0.000 & - 0.058 & - 0.002 & 0.055 & 0.002 & 0 & 0 & - 0.010 & 0.000 & - 0.061 & - 0.002 & 0.057 & 0.002 & 0 & 0 & 0.021 & 0.001 & 0.061 & 0.002 & 0.934 & 0.035 & 0 & 0 \\ 0.000 & - 0.010 & 0.002 & - 0.058 & - 0.002 & 0.055 & 0 & 0 & 0.000 & - 0.010 & 0.002 & - 0.061 & - 0.002 & 0.057 & 0 & 0 & - 0.001 & 0.021 & - 0.002 & 0.061 & - 0.035 & 0.934 & 0 & 0 \\ 0.000 & 0.000 & 0.000 & 0.000 & 0.000 & 0.000 & 0 & 0 & 0.000 & 0.000 & 0.000 & 0.000 & 0.000 & 0.000 & 0 & 0 & 0.000 & 0.000 & 0.000 & 0.000 & 0.000 & 0.000 & 1 & 0 \\ 0.000 & 0.000 & 0.000 & 0.000 & 0.000 & 0.000 & 0 & 0 & 0.000 & 0.000 & 0.000 & 0.000 & 0.000 & 0.000 & 0 & 0 & 0.000 & 0.000 & 0.000 & 0.000 & 0.000 & 0.000 & 0 & 1\end{matrix} ]$$

The input matrix is given by:

B_{μG}=diag(B_{1dq},B̅_{2dq},B̅_{2dq}) (108)

the output matrix is given by:

C_{μG}=diag(C,C,C). (109)

the state-space controller is given by:

K_{dT}=diag(K_{d1},K_{d2},K_{d3}) (110)

Robustness & Stability Analysis for the Inventive Model

The robustness and stability analyses previously presented were performed to the grid-connected and islanded models G_{μG}(z) and Gᵢ(z) presented in (79) and (80). For these analyses, the components in the LCL filters were defined as uncertain elements with a uniform variation of 30% around nominal parameter values shown in Table 3. Stability analyses found in literature for V-I or primary control are based on varying one parameter at a time and observing the variations in eigenvalues location. Analyzing random variations in components gives a more conservative notion of stability and robustness because this method considers all variations at the same time. Thus, 20 instances of each G_{μG}(z) and Gᵢ(z) were created based on parameter variations. Variations in load and components are presented in Table 4 below. MATLAB codes for the robustness and stability analysis is provided at the end of the specification.

TABLE 4
Component Variations for Robustness and Stability
Analysis

| # | C₁ | Lᵢ₁ | Lₒ₁ | C₂ | Lᵢ₂ | Lₒ₂ | C₃ | Lᵢ₃ | Lₒ₃ | R | L |
|---|---|---|---|---|---|---|---|---|---|---|---|
| Unit | μF | mH | mH | μF | mH | mH | μF | mH | mH | Ω | mH |
| Nom | 8.8 | 1.8 | 1.8 | 8.8 | 5.4 | 1.8 | 8.8 | 3.6 | 3.6 | 85.7 | 0.46 |
| 1 | 10.46 | 1.29 | 2.29 | 9.62 | 3.97 | 1.30 | 6.36 | 2.89 | 3.06 | 100.04 | 0.44 |
| 2 | 10.94 | 2.06 | 2.25 | 6.35 | 5.99 | 1.87 | 10.83 | 3.36 | 3.15 | 81.76 | 0.35 |
| 3 | 6.83 | 1.80 | 1.32 | 10.64 | 3.92 | 2.21 | 10.98 | 4.32 | 3.85 | 64.66 | 0.49 |
| 4 | 10.98 | 1.78 | 2.06 | 11.09 | 4.01 | 1.98 | 10.36 | 4.26 | 3.09 | 73.69 | 0.45 |
| 5 | 9.50 | 2.24 | 1.55 | 9.74 | 5.47 | 1.47 | 6.68 | 2.65 | 4.30 | 67.89 | 0.51 |
| 6 | 6.68 | 1.92 | 1.72 | 10.16 | 4.09 | 1.66 | 7.54 | 3.38 | 4.64 | 74.44 | 0.52 |
| 7 | 7.63 | 1.93 | 1.85 | 10.08 | 6.43 | 1.76 | 7.93 | 3.66 | 4.10 | 82.62 | 0.50 |
| 8 | 9.05 | 2.19 | 2.28 | 8.23 | 6.43 | 2.32 | 9.75 | 3.42 | 3.26 | 87.10 | 0.33 |
| 9 | 11.22 | 2.13 | 1.71 | 9.62 | 6.12 | 1.43 | 6.88 | 3.94 | 3.78 | 83.51 | 0.34 |
| 10 | 11.25 | 1.88 | 2.32 | 7.06 | 4.27 | 2.18 | 9.97 | 3.88 | 2.75 | 105.00 | 0.41 |
| 11 | 6.99 | 1.46 | 1.59 | 9.89 | 5.92 | 1.96 | 6.72 | 3.15 | 4.48 | 86.63 | 0.47 |
| 12 | 11.28 | 1.52 | 2.02 | 6.33 | 5.46 | 1.67 | 9.61 | 3.45 | 4.42 | 108.51 | 0.50 |
| 13 | 11.21 | 2.22 | 1.98 | 7.62 | 6.93 | 1.47 | 8.77 | 2.55 | 4.29 | 92.78 | 0.43 |
| 14 | 8.72 | 1.29 | 1.84 | 6.40 | 5.88 | 1.72 | 10.27 | 4.65 | 3.08 | 109.23 | 0.55 |
| 15 | 10.39 | 1.79 | 2.01 | 6.67 | 6.37 | 1.78 | 9.94 | 2.88 | 3.80 | 72.37 | 0.52 |
| 16 | 6.91 | 1.44 | 1.98 | 10.51 | 5.25 | 1.39 | 10.93 | 2.75 | 2.57 | 94.76 | 0.59 |
| 17 | 8.39 | 2.32 | 1.45 | 9.83 | 5.18 | 1.90 | 10.86 | 3.32 | 3.44 | 74.85 | 0.47 |
| 18 | 11.00 | 2.03 | 1.40 | 7.83 | 6.45 | 1.50 | 7.92 | 2.95 | 3.20 | 94.53 | 0.41 |
| 19 | 10.34 | 1.80 | 2.34 | 11.18 | 4.05 | 1.68 | 9.85 | 3.58 | 2.87 | 95.73 | 0.35 |
| 20 | 11.23 | 1.77 | 1.44 | 6.34 | 4.21 | 1.89 | 7.20 | 3.25 | 2.91 | 63.49 | 0.49 |

Grid Connected Models

Open-loop eigenvalues of nominals G₁(z), G₂(z), and G₃(z) and their variations are shown in FIG. 42. As seen on the zoomed view, the eigenvalues remain inside the unit circle, which implies that all inverters are stable in grid-connected mode without a controller. However, after analyzing stability margins, none of the open-loop models is closed-loop stable using unit feedback.

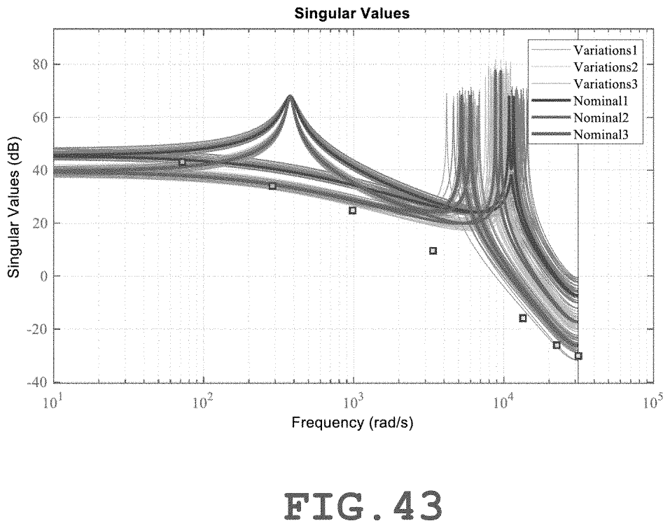

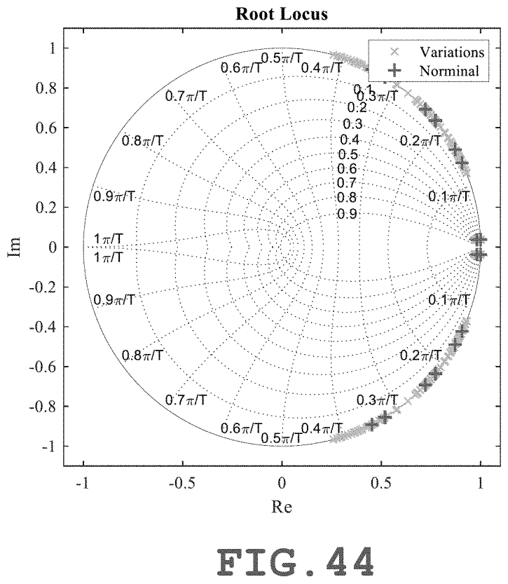

Singular Value Diagrams of the nominal G₁(z), G₂(z), and G₃(z) and their variations are shown in FIG. 43. According to these diagrams, frequency responses of inverters 2 and 3 are similar, with variations on their resonant and crossover frequencies. Also, Inverter 1 has the astest dynamics followed by Inverters 2 and 3, respectively.

Islanded Microgrid Mode

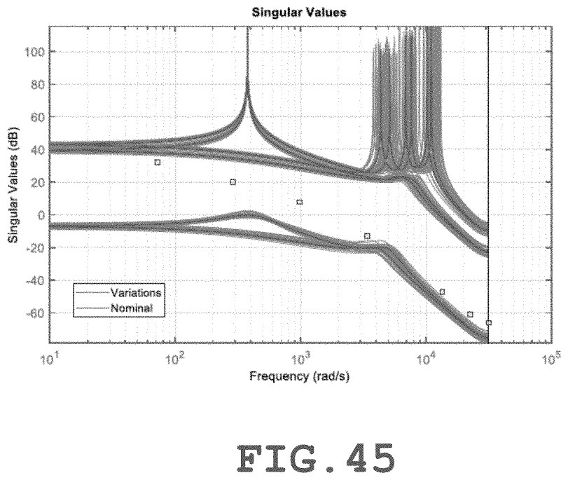

Open-loop eigenvalues of G_{μG}(z) and its variations are shown in FIG. 44. All the eigenvalues remain inside the unit circle, which implies that open-loop microgrid is stable in grid-connected mode without a controller. However, after analyzing stability margins, none of the open-loop models is closed-loop stable using a unit feedback. Finally, Singular Value Diagrams of the nominal G_{μG}(z) and its variations are shown in FIG. 45. These diagrams show similar behavior compared to FIG. 43. However, there is an additional response below 0 dB that is related to the RL load.

Open-Loop Models Validation

Models were validated in grid-connected and islanded modes. State vectors and output power of each mathematical model were compared against responses of their equivalent circuit under the same input signal. Finally, the NRMSE defined in (81) was computed for each model to quantify the difference between the mathematical model and the equivalent circuit.

Grid-Connected Inverter Model

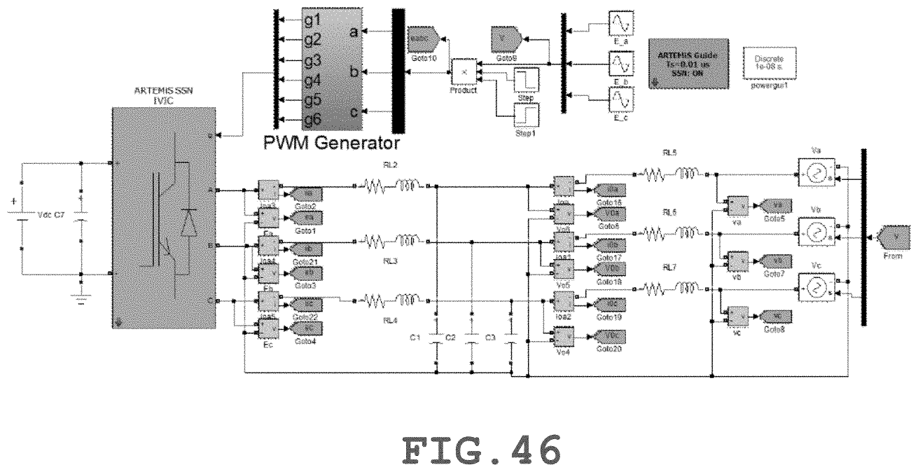

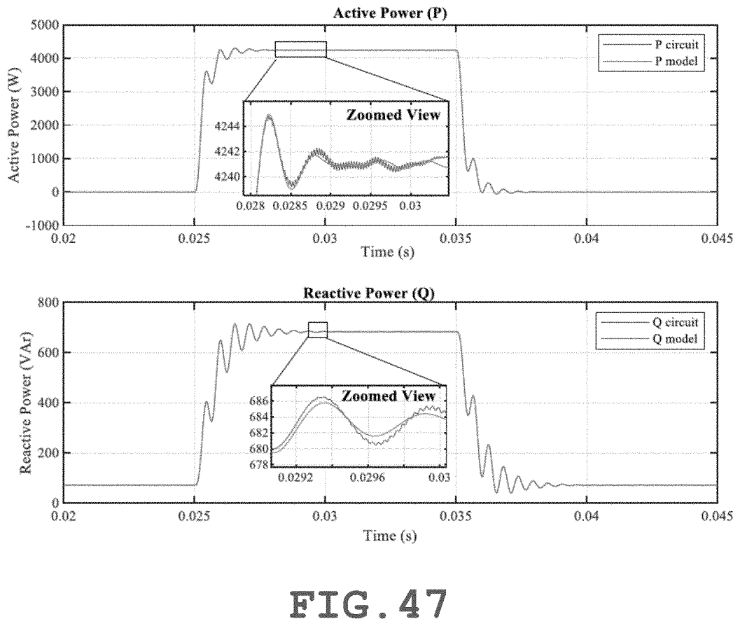

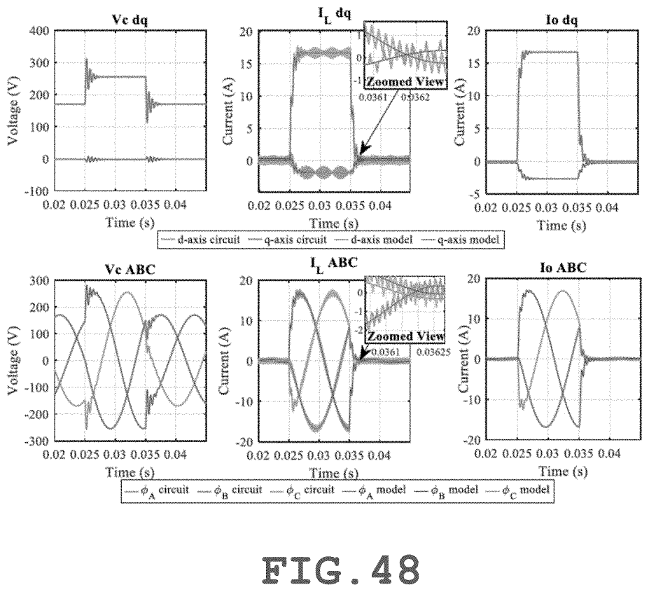

To validate the mode in grid-connected mode, the circuit shown in FIG. 46 was simulated using the ARTEMiS library for power electronics devices from Opal-RT Technologies™. The mathematical solver of this library runs accurate simulations of power electronics devices, such as the IGBT transistors used in three-phase inverters. To validate the mathematical model (66), Inverter 1 LCL component values were used. Once Inverter 1 model is validated, it is assumed that (66) is adequate on describing dynamics of any grid-connected inverter such as Inverters 2 or 3. For this, the inverter output voltage E and main grid voltage V start with the same nominal amplitude and phase. At t=0.025 s, inverter output amplitude was duplicated to a peak value of 240\sqrt{2} and returned to the original value at t=0.035 s. FIG. 47 shows the active and reactive power values for the mathematical model and circuit. FIG. 48 shows the state vector waveforms in the dq frame and ABC frame. Zoomed views in FIG. 47 show that active and reactive power for the mathematical model and circuit have similar dynamics. However, there are small high-frequency oscillations in the power of the circuit. These oscillations are generated by IGBT transistor switching at a frequency of 10 kHz. Zoomed views in FIG. 48 also show current switching oscillations in the input inductor. However, state vector dynamics show similar behavior in steady state and during transient response.

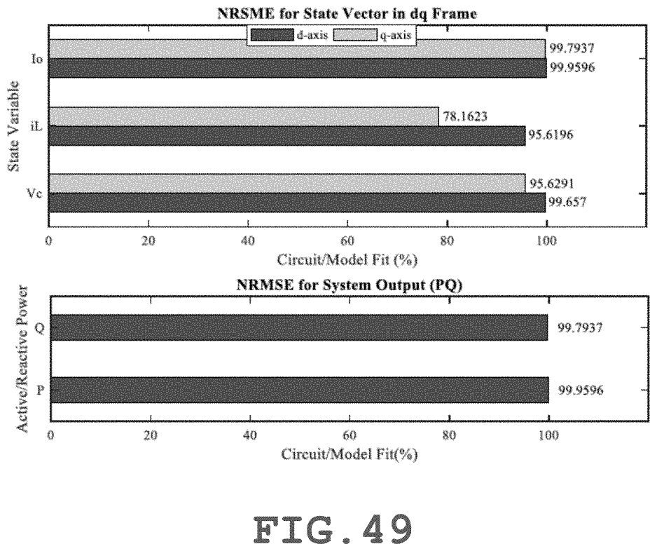

The NRMSE value was also analyzed for the shared power and the state vector in the dq frame. FIG. 49 shows that fitting values are above 95% in all state variables except input inductor current, which is about 78% on the d component of the inductor current. This is caused by the 10 KHz switching noise of the PWM signal. Which is not considered in the proposed model. These results validate the accuracy of the proposed model for grid-connected inverter.

Islanded Microgrid Model

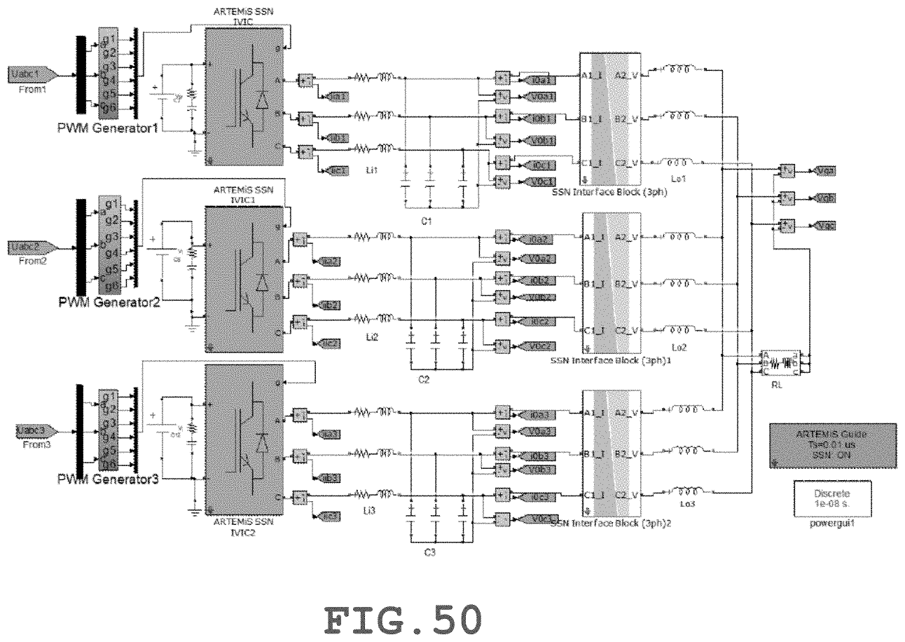

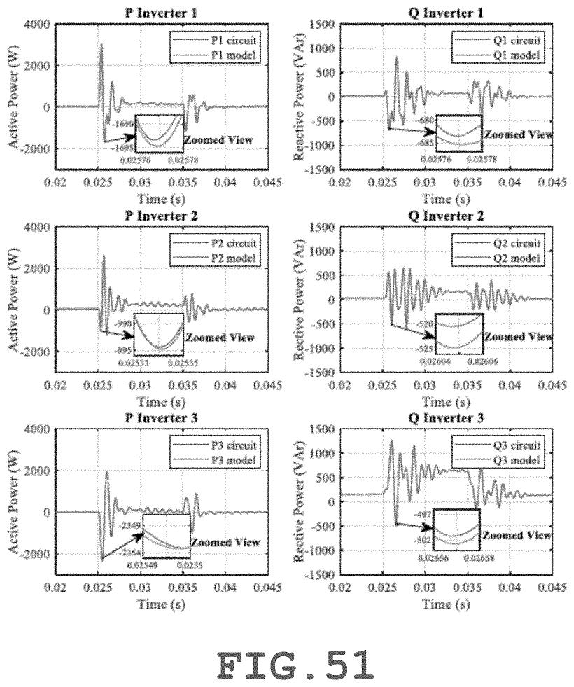

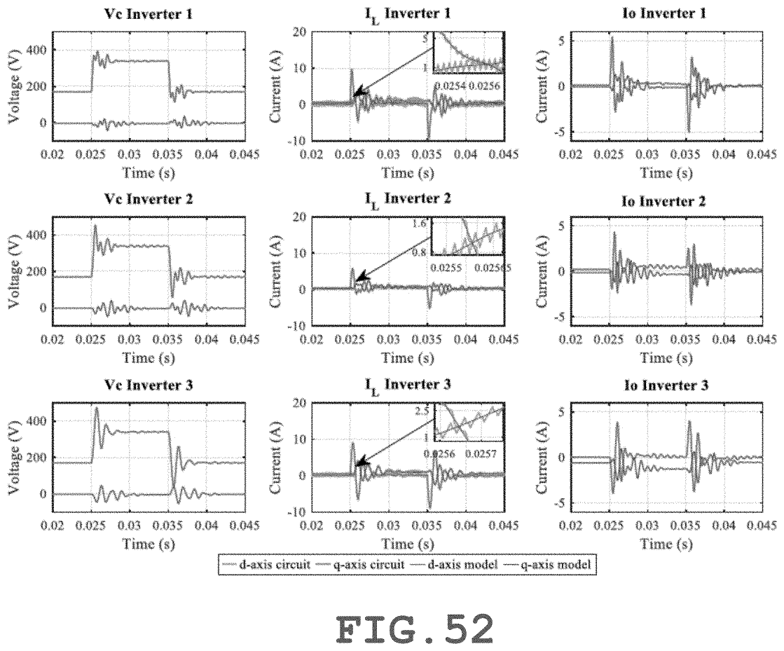

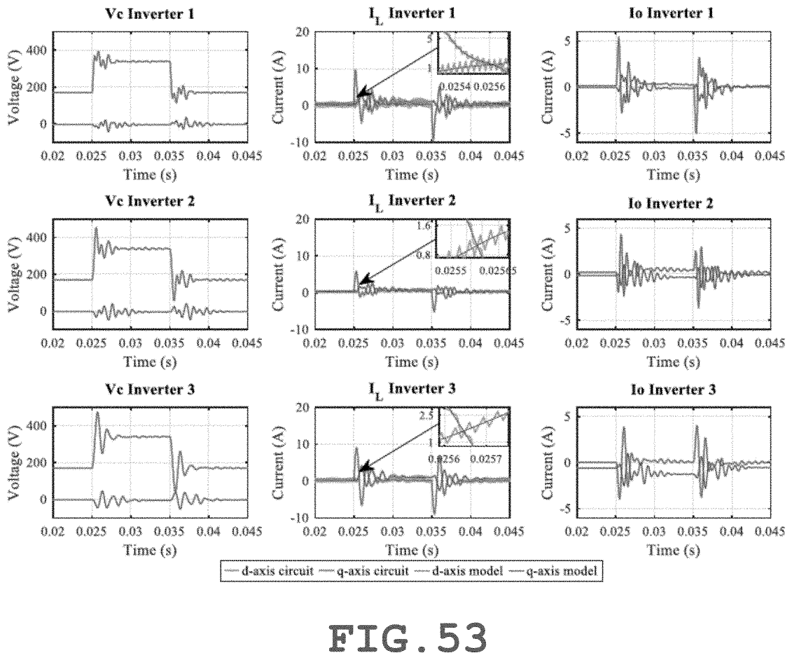

For islanded mode, the circuit shown in FIG. 50 was simulated using the ARTEMiS library for power electronics devices. To validate mathematical model (77), LCL component values from Table 3 were used. For this, the output voltage of the three inverters and main grid started with the same nominal amplitude and phase. At t=0.025 s, inverters output amplitude was duplicated to a peak value of 240\sqrt{2} and returned to the original value at t=0.035 s. FIG. 51 shows the active and reactive power waveforms for the mathematical model and circuit. State vector waveforms in the dq frame are shown in FIG. 52 and in the ABC frame in FIG. 53. The active and reactive power for the mathematical model and circuit have similar dynamics. As detailed in zoomed views, input inductor currents show switching oscillations. These oscillations are caused by the IGBT transistors switching at a frequency of 10 kHz. However, state vector dynamics show similar behavior in steady state and during transient response.

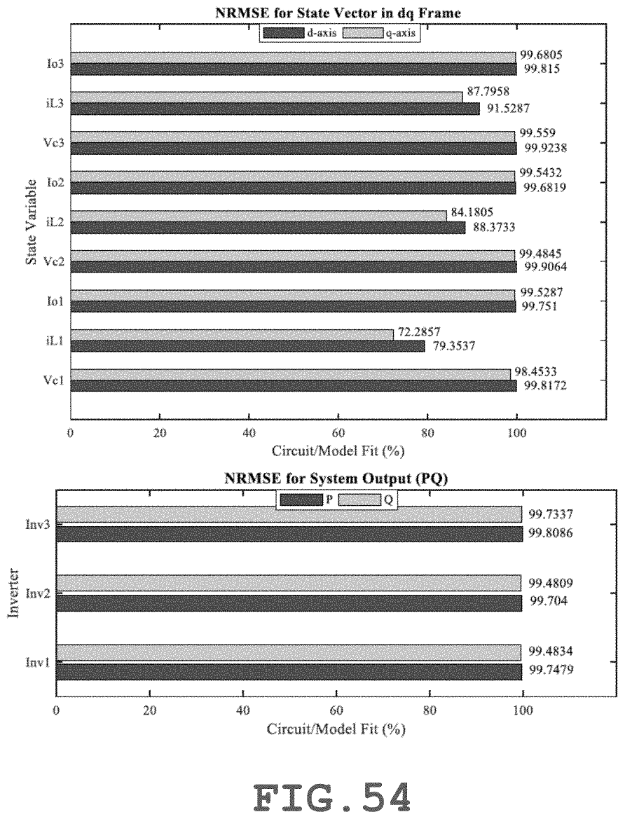

The NRMSE value was also analyzed for the shared power and the state vector in the dq frame. FIG. 54 shows that fitting values are above 98% in all state variables except input inductor currents. Which decrease due to the presence of the 10 kHz PWM switching. Which is not considered in the proposed model. These results validate the accuracy of the proposed model for the islanded microgrid.

Controller Implementation & Validation

To obtain the LQR-ORT controller, the weighting matrices shown in Table 3 were selected. The values of the weighting matrices Qₚᵢ and Rₚᵢ were selected to meet design requirements previously shown. In addition, it was required to obtain a settling time less than 0.5 s and a damped response without oscillations. The control feedback matrices K_{d1}, K_{d2}, and K_{d3} were computed using (85) and (86). The matrices Kᵥv₁, Kᵥv₂, and Kᵥv₃ were obtained using (88) for each inverter. The numerical values of the control matrices are the same as previously determined. MATLAB codes for computing controllers will be discussed at the end of the specification. Simulink block diagrams for both grid-connected and islanded mode control are discussed below.

Microgrid Model for Simulation

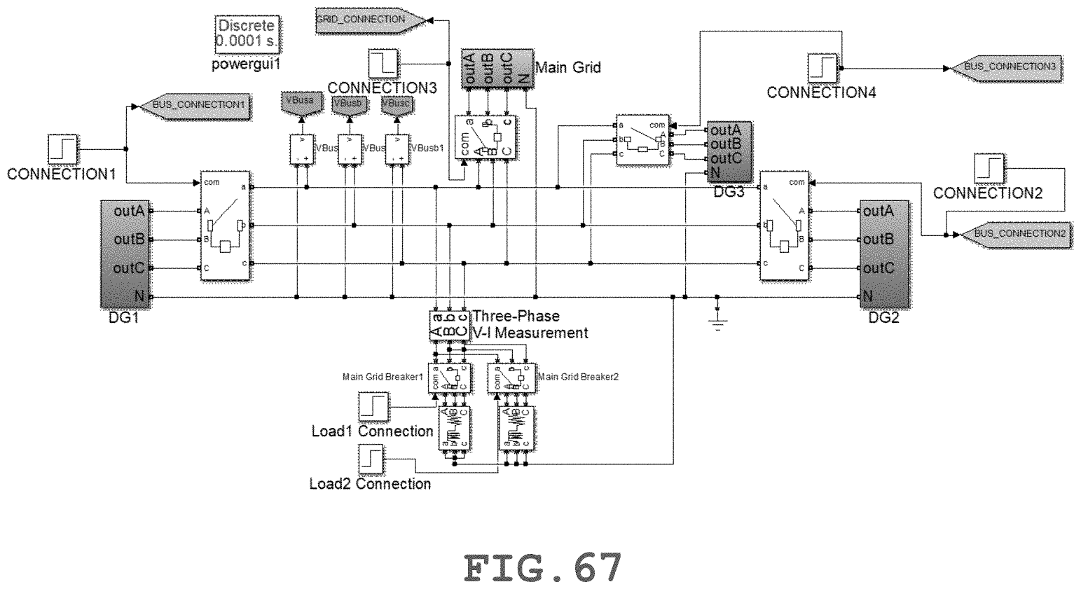

Microgrid simulation block diagram is shown in FIG. 67. This block diagram was used for both grid-connected and islanded mode simulations. The block diagram used for each inverter with the LCL filter is shown in FIG. 46. Main Grid block is a continuous three-phase generator with voltage and current measurements.

Circuit Measurement and Dq Transformation

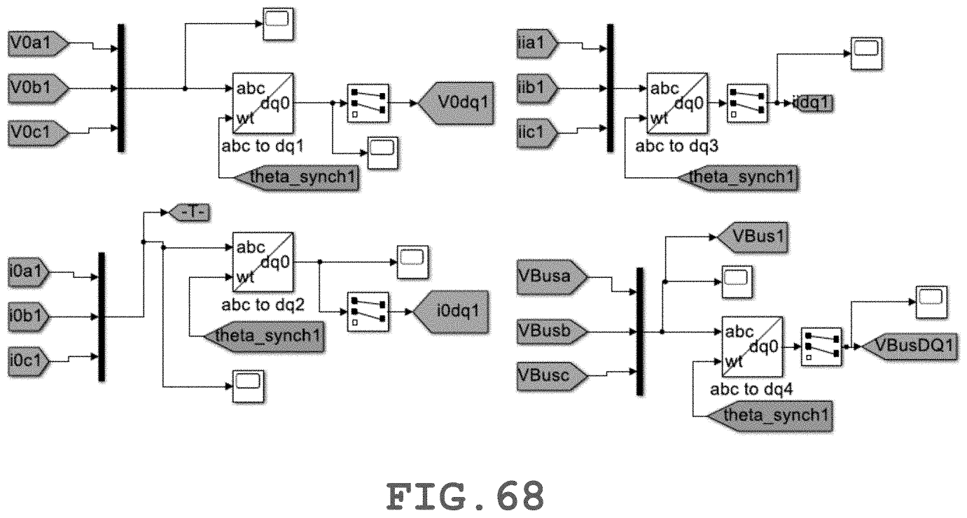

The block diagram shown in FIG. 68 was used to perform the dq transformation used in simulation and experimental results previously presented.

Controller Model Implemented in the dSPACE 1006

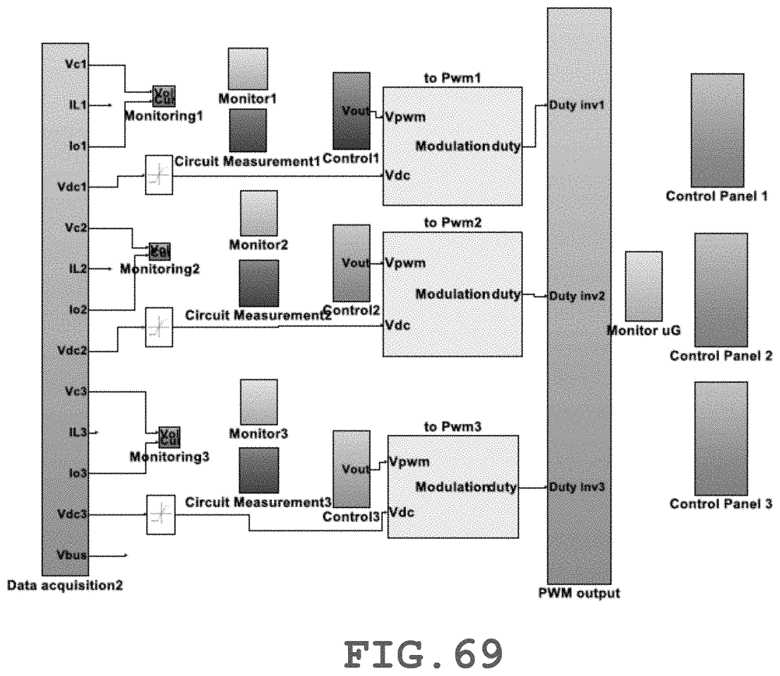

The block diagram shown in FIG. 69 was programmed on the dSPACE 1006 to obtain simulation and experimental results discussed. This block diagram was used for both grid-connected and islanded mode.

Simulink Block Diagram for the Integrated PQVI Controller

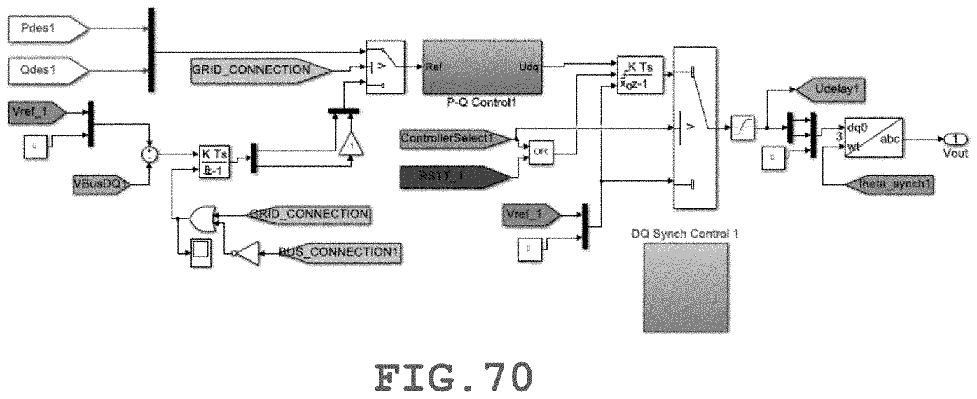

The block diagram shown in FIG. 69 represents the integrated PQVI controller used for both grid-connected and islanded mode. This block diagram is contained inside blocks “Control 1”, “Control 2”, and “Control 3” from FIG. 70. Signals Pdes and Qdes are the active and reactive power reference. GRID_CONNECTION signal is the grid connection flag that engages voltage and frequency restoration loops. Voltage restoration loop integrates the error in the AC bus voltage referred to its nominal value. Frequency restoration loop is implemented inside the block DQ synch Control 1. The LQR-ORT controller is implemented inside the block P-Q control.

Simulink Block Diagram for the LQR-ORT Controller

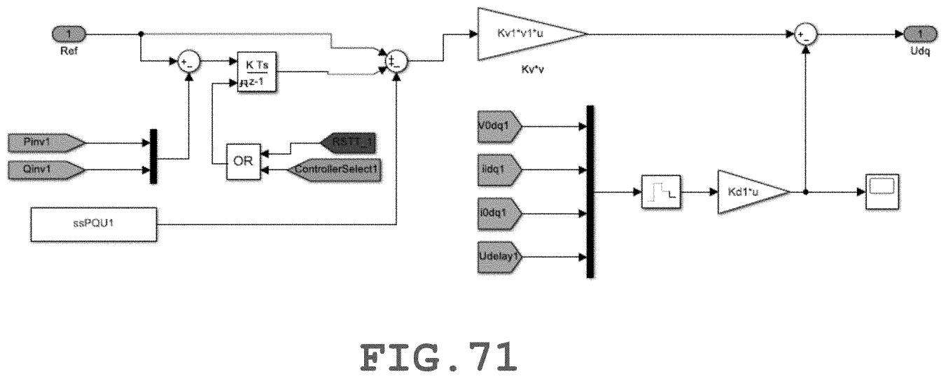

The block diagram shown in FIG. 71 represents the LQR-ORT controller used for both grid-connected and islanded mode. This block contains the optimal feedback matrix K_{d} and the optimal tracking matrix Kᵥv with the low-gain integrator for steady-state error regulation.

Simulink Block Diagram for the PLL-SOGI with the Frequency Restoration Loop

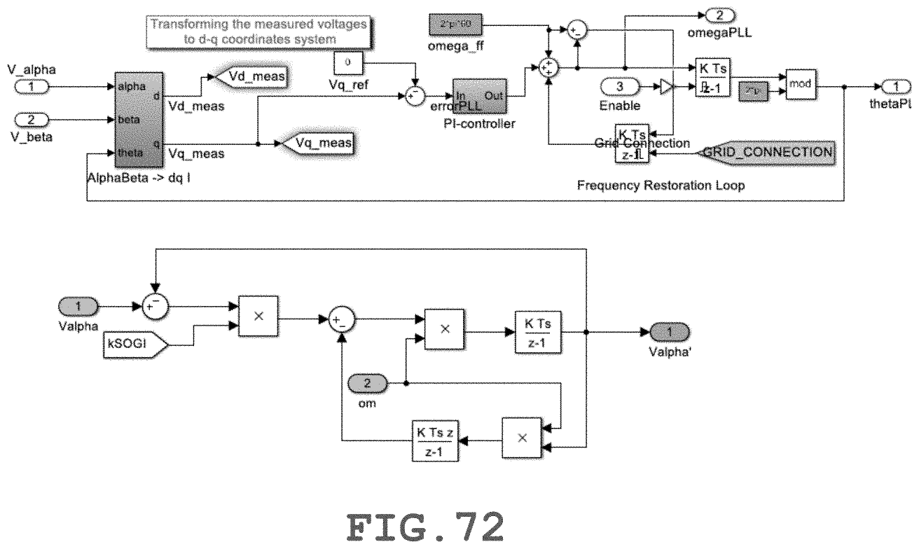

The block diagram shown in FIG. 72 represents the SOGI-PLL with the frequency restoration loop used for both grid-connected and islanded mode. The SOGI-PLL input must be received in the αβ frame using the Park transformation defined in (3).

Additional loop gains are presented in Table 3. Outer integrator gain Kₛ was selected to be small enough not to affect stability margins nor transient response. Modified PLL-SOGI gains were required to reach steady state in less than 0.3 s. This is because inverters need to always be synchronized with AC bus in both grid-connected and islanded modes. Thus, V_{q} always tends to zero and the frequency in islanded mode always tends to 60 Hz.

Voltage restoration gains were selected according to the power rating of each inverter. Note that the power ratings of Inverters 1, 2, and 3 are 500VA, 1000VA, and 1500VA, respectively. This means that Kₚ₂ must duplicate Kₚ₁, and Kₚ₃ must triplicate Kₚ₁ to allow proportional power sharing. In addition, it was required to restore voltage levels in the AC bus in less than 0.3 s.

Robustness and Stability Analysis for the Proposed LQR-ORT Controller

The robustness and stability analyses previously presented were performed to the controlled grid-connected and islanded models Λᵢ(z) and Λ_{μG}(z) previously shown. For these analyses, the components in the LCL filters were defined as uncertain elements with a uniform variation of 30% around nominal parameter values, shown in Table 3. Thus, 20 instances of each Λ_{μG}(z) and Λᵢ(z) were created based on parameter variations. MATLAB codes for the robustness and stability analysis will be discussed at the end of the specification.

Grid Connected Inverters

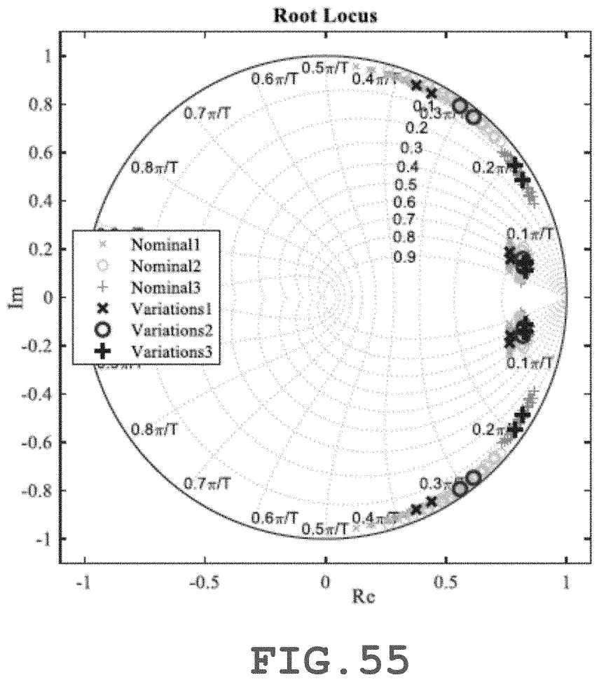

Closed-Loop eigenvalues of nominal Λ₁(z), Λ₂(z), and Λ₃(z) and their variations are shown in FIG. 55. All eigenvalues remain inside the unit circle, which implies that all closed-loop inverters are stable in grid-connected mode.

Stability margins are shown in Table 5 below. These margins indicate that closed-loop inverters in grid-connected mode are robust for disturbances less than 12.21 dB and 50.24° for the nominal case, and 10.63 dB and 39.36° for the worst case of component deviation. Thus, the closed loop inverters remain stable under parameter variations using the LQR-ORT controller.

TABLE 5
Stability Margins of nominal Λ₁(z), Λ₂(z), and Λ₃(z)
and their variations

| Nominal GM | 12.21 dB | 14.40 dB | 14.03 dB |
|---|---|---|---|
| Nominal PM | 52.43° | 54.29° | 50.24° |
| Min Uncertain GM | 10.99 dB | 12.17 dB | 10.63 dB |
| Min Uncertain PM | 45.92° | 46.29° | 39.36° |

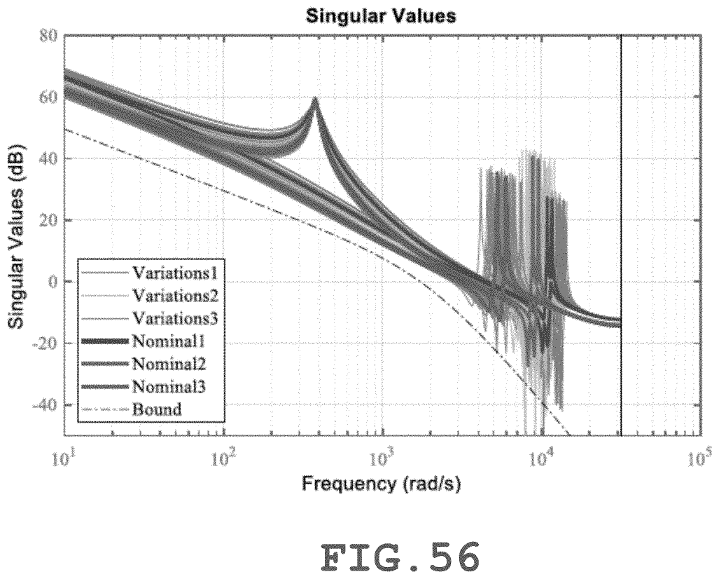

Finally, Singular Value diagrams of the nominal Λ₁(z), Λ₂(z), and Λ₃(z) and their variations are shown in FIG. 56. Results from the singular value plots confirm performance robustness of the LQR-ORT controller with stablished bounds.

Islanded Microgrid

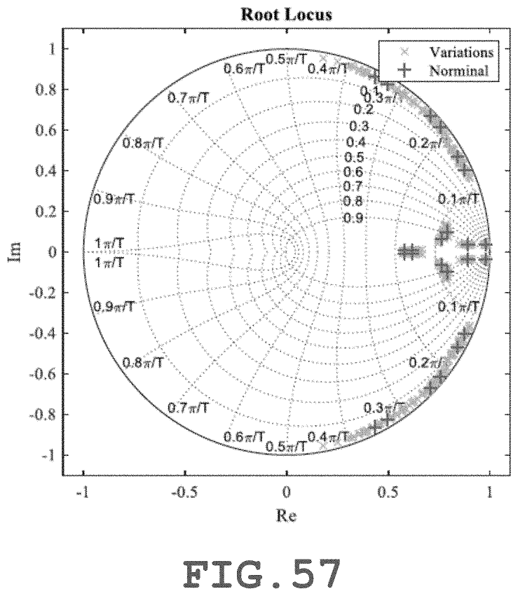

Closed-Loop eigenvalues of nominal Λ_{μG}(z) and its variations are shown in FIG. 57. All eigenvalues remain inside the unit circle, which implies that the islanded microgrid is stable using the LQR-ORT controller on each inverter.

The nominal islanded microgrid has a gain margin of 12.10 dB and a phase margin of 42.68°. Considering uncertainties in components and loads, the microgrid reaches a minimum gain margin of 9.25 dB and a minimum phase margin of 34.45°. These results demonstrate robustness and stability under component and load variations in the islanded microgrid.

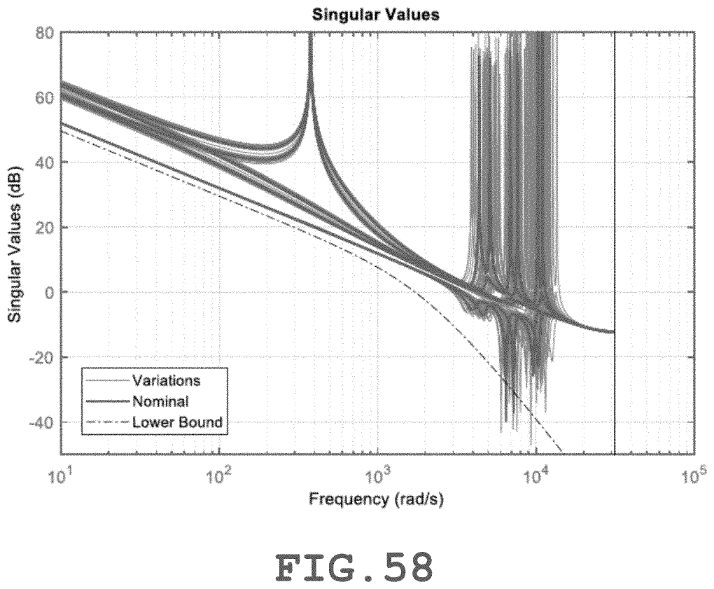

Finally, Singular Value diagrams of the nominal Λ_{μG}(z) and its variations are shown in FIG. 58. Results from the singular value plots confirm performance robustness of the LQR-ORT controller for the islanded microgrid.

Controller Performance Validation

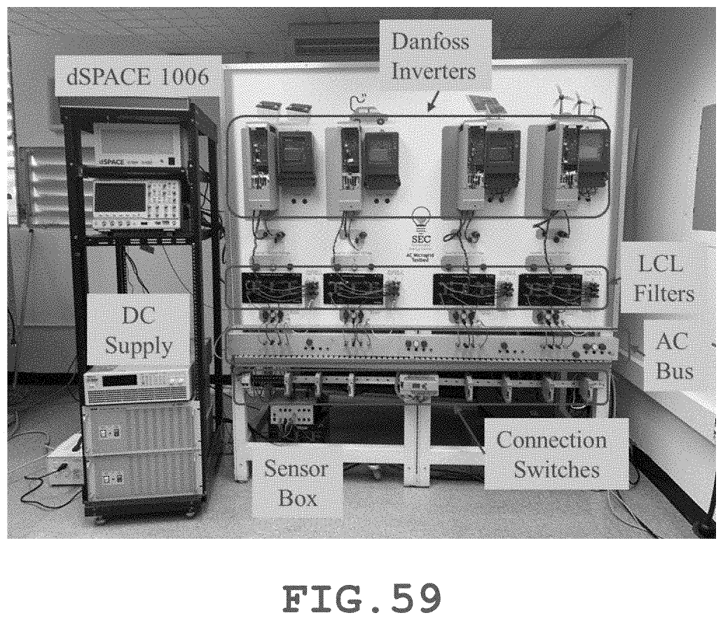

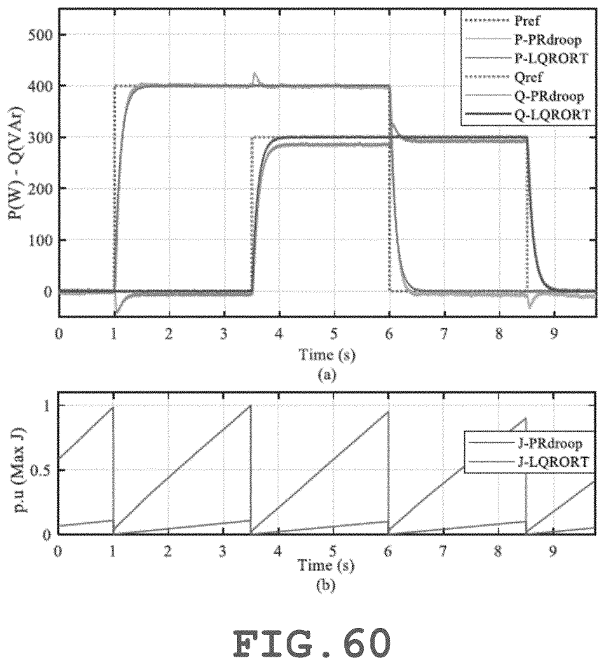

To evaluate the performance of the proposed control scheme, the microgrid testbed, shown in FIG. 59, was used. This testbed consists of four Danfoss 2.2 kW inverters, voltage and current sensor boxes, LCL filters, solid-state connection switches, and a dSPACE1006. The switching frequency of the inverters was set to 10 KHz using symmetric space-vector modulation. The microgrid testbed is connected to the main grid using a solid-state connection switch. Finally, output currents were acquired using a Lecroy Wavesurfer 64Xs oscilloscope and CP031 current probes. Equipment specification used is shown on the tables below.

TABLE 7
Technical Characteristics of the dSPACE 1006

| Component | Technical Characteristic |
|---|---|
| Processor Board | Quad-core AMD Opteron 2.8 GHz processor, 1 GB DDR-2-267 SDRAM |
| dSPACE 1006 | memory for the application and dynamic application data, 4 × 128 MB |
| | DDR-2-267 SDRAM global memory for host data exchange, serial COM |
| | port and I/O module interfaces. |
| Expansion Box - PX10 | Chassis with availability to 10 full-size 16-bit ISA slots, 1 slot reserved |
| | for Link Board or slot CPU board for Ethernet connection |
| Analog Input Module - | 16 channels, 16-bit resolution A/D Converter and 800 ns conversion |
| DS2004 | time |
| Digital I/O Module - | 3 ports, each one with the availability of 32 I/O lines by port, each |
| DS4003 | channel support TTL levels and every port needs a power supply of |
| | 5 Vdc |
| PWM Module - | 16 optical channels with high accuracy, and time resolution of 25 ns |
| DS5101_2 | |
| Inverter - Danfoss | 2.2 kW, three phases, supports a DC level input up to 400 Vdc, AC |
| VLT-302 | output up to 690 VAC, frequency output between 0 and 590 Hz, PWM |
| | and digital I/O for control |

TABLE 8
Technical Specifications of the Danfoss
F102 2.2 kW Inverter

| Feature | Value | |
|---|---|---|
| Rated Power | 2.2 | kW |
| Phases | 1-3 | |
| Input DC Voltage | 380-480 | V |
| Input Current | 5 | A |

TABLE 9
Technical Characteristics of the Lecroy
Wavesurfer 64Xs Oscilloscope

| Feature | Value | |
|---|---|---|
| Bandwidth | 600 | MHz |
| Rise Time | 625 | ps |
| Input Channels | 4 | |
| Sample Rate | 2.5 | GS/s |
| CP031 Current Probe Capacity | 30 | Arms |
| CP031 Current Probe Bandwidth | 100 | MHz |

Experimental results are presented for grid-connected and islanded modes. For both modes, simulated and experimental results were obtained. For grid connected mode, Inverter 1 works as a grid-follower generator. Inverter 1 frequency and amplitude vary depending on main grid variations. In this mode, Inverter 1 is used to inject active and reactive power to the main grid. For islanded mode, all inverters work as grid forming generators with frequency and amplitude close to nominal values. Also, active and reactive power demanded by the load are divided between generators according to their rated power value. MATLAB codes and Simulink block diagrams used to validate controller performance will be explained at the end of the specification.

Grid-Connected Mode

For the grid-connected experiment, Inverter 1 was used. The LQR-ORT controller was compared with a known PR-droop controller, which was developed using the same component values from Inverter 1 shown in Table 3. The reference signals P_{ref}[k] and Q_{ref}[k] were selected to be squared pulses with a period of 10 s, varying from 0 to 400 W and 0 to 300 Var, respectively. To analyze decoupling between active and reactive power, the Q_{ref} signal had a time delay of 2.5 s from the P_{ref} signal.

Simulation Results

For the simulated results, the control scheme shown in FIG. 36 was built in MATLAB and tested using a dSPACE 1006 simulator. The circuit shown in FIG. 33 was implemented using MATLAB/Simulink.

The main grid three-phase signal V_{dq}[k] was acquired using the dSPACE digital-to-analog converter from the actual grid. This signal was used as a reference for the simulated main grid so that the actual grid voltage is included in the simulation in real-time to evaluate controller performance under real grid conditions. Active and Reactive power P[k] and Q[k] were computed using (68) and (69) with a low-pass filter with a bandwidth of 10 rad/s to obtain the mean value.

FIG. 60(a) shows the simulation results for the LQR-ORT and the PR-droop controller. Both controllers show similar settling time and transient response under a step reference. However, The LQR-ORT controller shows a negligible steady-state error compared to the PR-droop controller. Also, when there is a reference step change in active power, the reactive power shows high decoupling and vice versa for the LQR-ORT controller. This is caused by the dq transformation and the intrinsic robustness properties of the LQR controllers. Furthermore, the PR-droop controller has less decoupling because droop (ω-V) curves are not completely independent. Finally, the normalized cost j was calculated using (82) divided by the highest achieved cost during the simulation. It can be noticed in FIG. 60(b) that the simulated PR-droop has a normalized cost of about 9.2 times compared to the LQR-ORT controller. This implies that the LQR-ORT controller spends less energy tracking reference signals.

Experimental Results

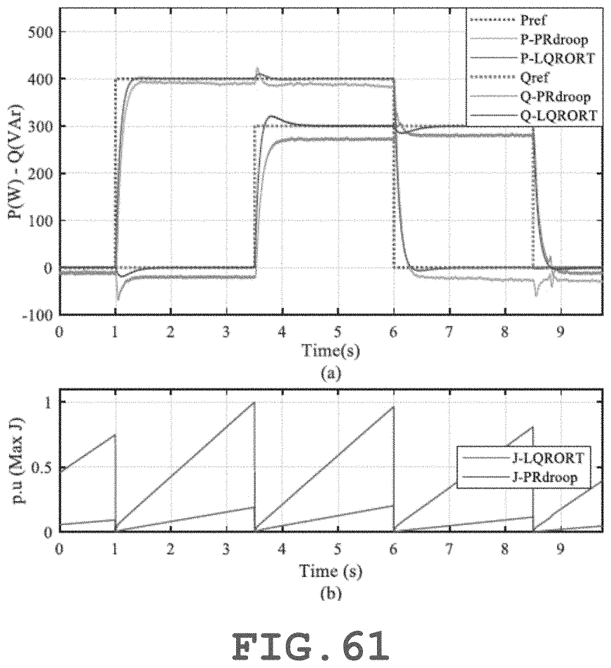

Experimental results are shown in FIG. 61(a). Compared to the PR-droop controller, the LQR-ORT controller presents a better transient response, less noise at the output and less steady-state error. Also, the LQR-ORT shows higher decoupling between active and reactive power for step changes in the reference signals compared to the PR-droop controller. Finally, FIG. 61(b) shows that the normalized cost of the PR-droop controller is about 4.92 times higher compared to the LQR-ORT controller.

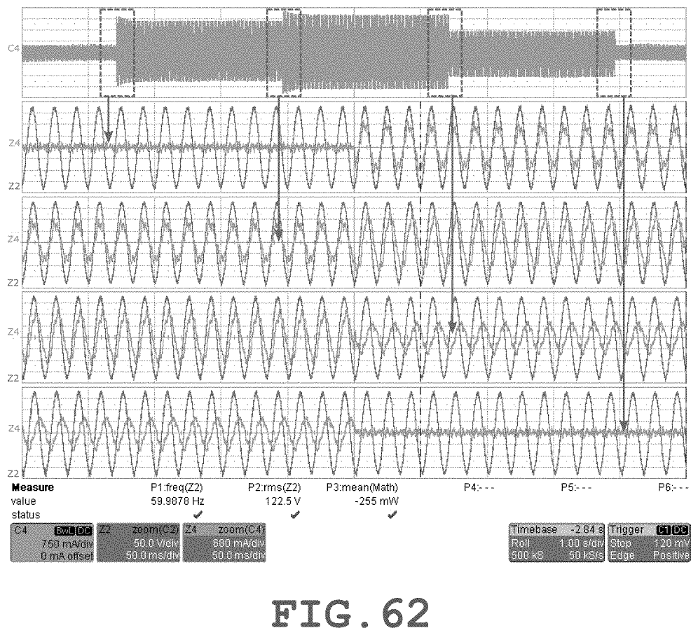

FIG. 62 shows experimental iₒₐ values for the LQR-ORT controller. The top portion of the graphic shows the transient behavior of the output current under changes in active and reactive power reference values. The other portions of the graphic represent zoomed intervals of 500 ms of iₒₐ and Vₐ signals when a change in active and reactive power reference occurs. Output current values show that the LQR-ORT controller provides smooth transitions for step reference changes in active and reactive power. It is also shown that there is an adequate phase shift of iₒₐ referred to V when changing from active to reactive power injection.

Islanded Mode

The simulated and real experiment for islanded mode was made based on the scheme shown in FIG. 39. The complete experiment was made in a time lapse of 7s. The microgrid started connected to the main grid. Then, main grid switch was opened and the microgrid started working in islanded mode with Load 1 connected. Finally, Load 2 is connected.

Simulation Results

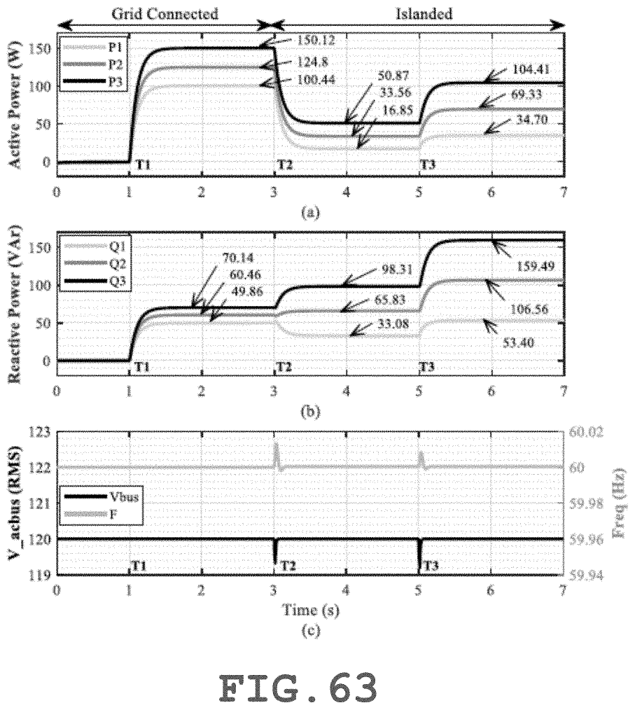

To obtain simulation results, the circuit shown in FIG. 39 was implemented in MATLAB/Simulink using OPAL-RT ARTEMiS libraries. Main grid frequency and amplitude were selected to have nominal values. FIG. 63 shows the simulated output power of each inverter, the RMS voltage on the AC bus, and the microgrid frequency under different intervals of time.

At T₁=1 s, an active power reference of 100 W, 125 W, and 150 W was set for Inverters 1, 2, and 3 respectively. It can be seen that the three inverters have a damped response with a settling time of about 0.4 s and a steady-state error less than 0.2%.

At T₂=3 s, the main grid is disconnected and the microgrid starts working in islanded mode with Load 1 connected. At this time, voltage and frequency on the AC bus are recovered in 0.05 s and 0.1 s, respectively. Active and reactive powers reach steady-state in 0.5 s and 0.3 s, respectively. Also, generated power is proportionally shared between the three inverters according to their rated power capacity since

$$\frac{{P}_{2}}{{P}_{1}} = \frac{33.56}{16.85} = 1.991 \\ \frac{{P}_{3}}{{P}_{1}} = \frac{50.87}{16.85} = 3.018 \\ \frac{{Q}_{2}}{{Q}_{1}} = \frac{65.83}{33.08} = 1.990 \\ \frac{{Q}_{3}}{{Q}_{1}} = \frac{98.31}{33.08} = 2.971$$

Finally, at T₃=5 s, Load 2 is connected. The voltage in the AC bus and the microgrid frequency show a disturbance of about 0.8 V and 0.01 Hz, respectively, with a recovery time of about 0.05 s and 0.1 s, respectively. In addition, active and reactive power have a settling time of about 0.3 s. Finally, active and reactive power remain proportionally shared between the three inverters since

$$\frac{{P}_{2}}{{P}_{1}} = \frac{69.33}{34.70} = 1.997 \\ \frac{{P}_{3}}{{P}_{1}} = \frac{104.41}{34.70} = 3.008 \\ \frac{{Q}_{2}}{{Q}_{1}} = \frac{106.56}{53.40} = 1.994 \\ \frac{{Q}_{3}}{{Q}_{1}} = \frac{159.49}{53.40} = 2.986$$

Simulation results confirm the effectiveness of the proposed controller in a computational environment.

Experimental Results

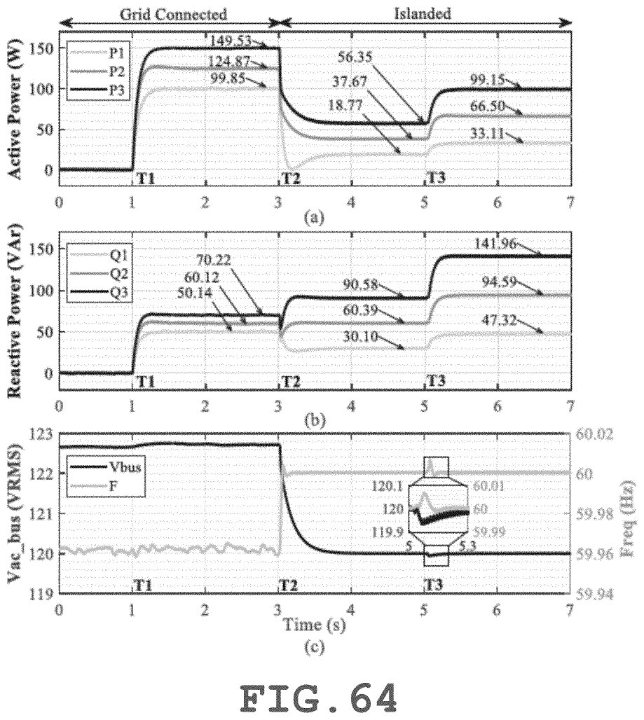

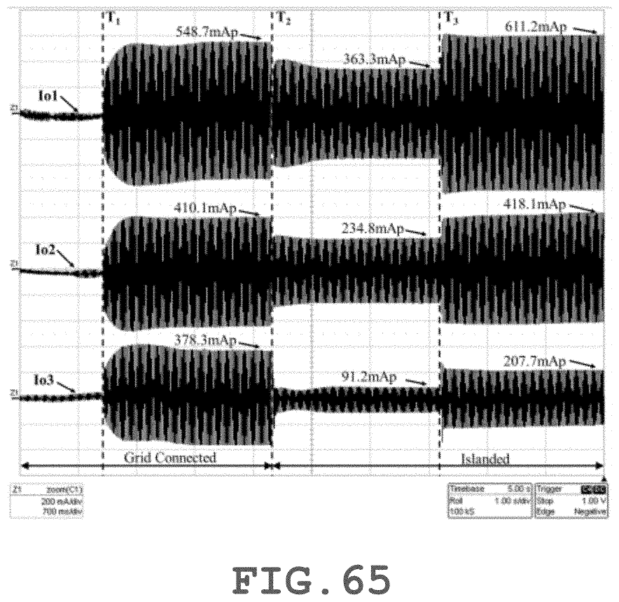

For islanded mode experiment, the microgrid scheme shown in FIG. 41 was implemented using the parameters shown in Table 3. FIG. 64 shows the output power of each inverter, the RMS voltage on the AC bus, and the microgrid frequency under different intervals of time. Experimental waveforms of the output currents of each inverter are also shown in FIG. 65.

At the beginning of the experiment (prior to T₂=3 s), the AC bus is connected to the main grid. At this time, the voltage on the AC bus and the frequency are deviated from their nominal values. This is because main grid voltage from the power utility does not always operate under nominal conditions.

At T₁=1 s, an active power reference of 100 W, 125 W, and 150 W was set for Inverters 1, 2, and 3, respectively. Also, a reactive power reference of 50 VAr, 60 VAr, and 70 VAr was set for Inverters 1, 2, and 3, respectively. It can be seen that the power shown in FIG. 64 and output currents shown in FIG. 65 for the three inverters have a damped response with a settling time of about 0.4 s and a steady-state error less than 0.3%.

At T₂=3 s, the main grid is disconnected and the microgrid starts working in islanded mode with Load 1 connected. This means that the inverters work together as grid forming generators to deliver the power demanded by Load 1 and to recover voltage and frequency without communications. At this time, voltage and frequency on the AC bus are recovered in 0.8 s and 0.2 s, respectively. Active and reactive powers reach steady-state in 0.8 s and 0.5 s, respectively. Also, generated power is proportionally shared between the three inverters according to their rated power capability since

$$\frac{{P}_{2}}{{P}_{1}} = \frac{37.67}{18.77} = 2.006 \\ \frac{{P}_{3}}{{P}_{1}} = \frac{56.35}{18.77} = 3.002 \\ \frac{{Q}_{2}}{{Q}_{1}} = \frac{60.39}{30.10} = 2.006 \\ \frac{{Q}_{3}}{{Q}_{1}} = \frac{90.58}{30.10} = 3.009$$

Finally, at T₃=5 s, Load 2 is connected. Voltage in the AC bus and frequency show a disturbance of less than 0.1 V and 0.01 Hz respectively with a recovery time of less than 0.3 s. In addition, active and reactive power have a settling time of about 0.4 s. Finally, active and reactive power remain proportionally shared between the three inverters since

$$\frac{{P}_{2}}{{P}_{1}} = \frac{66.50}{33.11} = 2.008 \\ \frac{{P}_{3}}{{P}_{1}} = \frac{99.15}{33.11} = 2.994 \\ \frac{{Q}_{2}}{{Q}_{1}} = \frac{94.59}{47.32} = 1.998 \\ \frac{{Q}_{3}}{{Q}_{1}} = \frac{141.96}{47.32} = 3.000$$

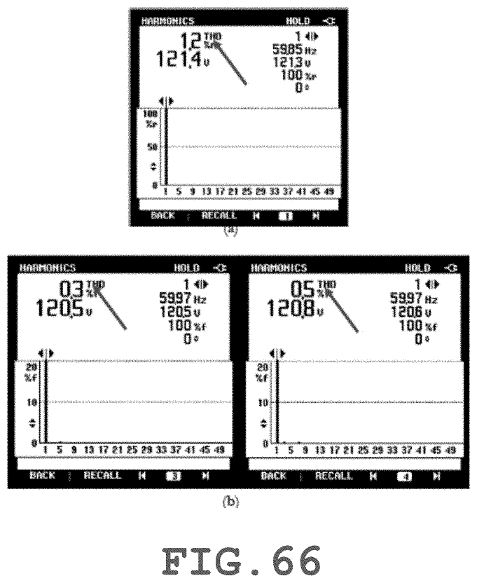

THD values shown in FIG. 66 were measured using a Fluke 43D power quality analyzer. THD value were measured in the AC bus for grid-connected and islanded modes. Main grid THD was about 1.2%. After disconnection, the THD on the AC bus reached 0.3% at T2 and 0.5% at T₃. Experimental results validate the effectiveness of the complete PQVI controller in a real experiment with deviations in components and main grid parameters.

Controller Comparison

Controller performance was compared for both grid-connected and islanded mode. In grid-connected mode, the LQR-ORT controller was compared considering transient response, power coupling and quadratic cost values. In islanded mode, the LQR-ORT, along with the voltage and frequency restoration loops, was compared considering transient response, proportional power generation, and voltage and frequency restoration.

Grid-Connected Mode

For grid-connected mode, results previously shown demonstrate that the LQR-ORT controller is more effective improving transient response and power coupling than the classical droop controller. In addition, this approach has the following advantages over other approaches found in the literature such as:
1. This approach produces a lower cost function j than the classical droop controller, which means better transient response, reduced tracking error, and less power losses during transient responses.
2. The use of an LQR controller has suitable robustness properties regarding to gain and phase margins.
3. The controller is effective on reducing active and reactive power coupling. This is because power sharing control in the LQR-ORT is not based on modifying amplitude and frequency as the classical droop control does.
4. The proposed model for computing the LQR-ORT controller allows to apply robustness analysis methods that may provide a more precise estimation about the stability of the closed loop inverter in grid-connected mode under uncertainties in components.
5. This approach does not use resonant filters that may affect sensitivity and robustness under parameter variations as the classical droop control does.

Islanded Mode

The results previously determined for the islanded mode were compared against literature based on parameters, such as power sharing accuracy, frequency and voltage restoration, and settling time.

Power Sharing Accuracy

For islanded mode, the LQR-ORT controller uses a voltage restoration loop with an integrator that recovers voltage amplitude in the AC bus. This restoration loop can also be used to distribute power generation among inverters according to their rated power capability. To compare power sharing accuracy, the LQR-ORT controller was compared against results presented in the prior art. In this work, a comparison was made between classic droop controllers and a droop controller with a supplementary control loop that enhances power sharing accuracy. The results show that power sharing between two inverters with a rated power capability ratio of 1:2 reached a sharing ratio of 1:1.867 for classic droop, and 1:2.02 for the control loop proposed by the authors of the prior art. The LQR-ORT controller with the proposed voltage restoration loop, previously presented, reaches a power sharing ratio of about 1:2.006. This result is better than that reported in the prior art.

Voltage and Frequency Restoration

Voltage and frequency restoration in islanded mode was compared against approaches found in the prior art. These results are summarized in Table 6. For frequency deviations, the LQR-ORT controller implements a SOGI-PLL with a novel frequency restoration loop to synchronize each inverter with the AC bus in both grid-connected and islanded mode. This synchronization allows to eliminate the q component of the AC bus voltage V_{dq} and improves power sharing decoupling as shown in (70). The results for the LQR-ORT controller, along with the proposed frequency restoration loop, was compared against the literature results reported in Table 6. It can be noticed that the LQR-ORT controller has a deviation of 0.01% with a settling time of 0.25 s under load changes. The current damping controller from [66] has the smallest frequency deviation (0.012%). However, this controller takes 3.5 s to restore AC bus frequency to the nominal value. This shows that the proposed LQR-ORT controller provides better frequency restoration than results reported in Table 6.

TABLE 6
Comparison of Voltage and Frequency Restoration
Approaches

| | Δf | Settling | ΔV | Settling |
|---|---|---|---|---|
| Approach | (%) | Time f (s) | (%) | Time V (s) |
| Proposed LQR-ORT | 0.01 | 0.25 | 0.04 | 0.3 |
| Classical Centralized [7] | 0.2 | 1.5 | 2.2 | 0.5 |
| Current Damping [66] | 0.012 | 3.5 | 0.001 | 3 |
| Classical Centralized [36] | 0.14 | 10 | 2.1 | 2.5 |
| Frequency Restoration [91] | 0.05 | 5 | N/A | N/A |
| Frequency Restoration [94] | 0.16 | 1.5 | N/A | N/A |

For voltage deviations, the LQR-ORT controller implements a novel restoration loop that calculates the integral of the voltage error in the AC bus. The results for the LQR-ORT controller, along with the proposed voltage restoration loop, was compared against the literature results reported in Table 6. It can be noticed that the LQR-ORT controller has a voltage deviation of 0.04% with a settling time of 0.3 s under load changes. The current damping controller from [66] has the smallest voltage deviation (0.001%). However, this controller takes 3 s to restore AC bus frequency to the nominal value. Also, a resistive load was used in this work, which does not induce large voltage deviations. This shows that the proposed LQR-ORT controller provides better voltage restoration than results reported in Table 6.

Settling Time

Finally, the settling time for this controller under load changes was also compared against approaches reported in Table 6. None of these approaches reached steady-state in less than 0.8 s under load changes. This is because the power sharing dynamics of droop controllers rely on a low-pass filter that is used to estimate active and reactive power inside the control loop. As previously shown, the LQR-ORT controller reaches steady state in less than 0.5 s. This is because the LQR-ORT controller uses a model that integrates power sharing and V-I dynamics instead of separating them using low-pass filters.

MATLAB Programs

1. Models and Controllers

1.1 ModelosDiscretos.m

2. close all

3. clear all

4. clc

5.

6. Tch=inf;

7. Td= 1/10000; %1/ƒₛ=sampling period

8. Ts=Td;

9. Tsw=−1;

10. % PLL

11. Tset=0.1; % settling time

141. hold on

142. sigma(Ln, ‘r’);

143. grid on

144. Lb=tf(3000, [1 0])*(tf([2000], [1 2000]))\hat{ }2;

145. sigma(c2d(Lb,Ts), ‘c-.’);

146.

147. legend(‘Variations’, ‘Nominal’, ‘Lower Bound’);

148. ylim([−50 80])

### CONCLUSIONS

This invention proposes a novel model that integrates V-I and power sharing dynamics in a single state-space model. This model can be scaled to be implemented in both grid-connected and islanded modes.

For islanded mode, a mathematical procedure is proposed to integrate any number of generators and loads in a single open-loop model that may be used for modern robustness and stability analysis. Modern control methods such as LQR, H_{∞}, or μ-synthesis require an open-loop state-space model to implement numerical optimization methods that find a suitable controller according to a specific control objective. The use of the proposed integrated model in the dq frame (66), along with the use of the superposition principle, allows to implement modern control methods that not only improve robustness and transient response, but also integrates V-I and power sharing dynamics for inverter-based generators. Also, the proposed model and controller take advantage of the low-inertia of inverter-based generators. Approaches found in literature emulate the behavior of a mechanic synchronous machine, which has not been demonstrated to be the optimal approach to transform energy from DC to AC.

The proposed LQR-ORT controller for islanded and grid-connected microgrids improves transient response, accuracy on power sharing, and voltage and frequency restoration. It is worth to mention that the frequency and voltage restorations are performed without communications, which ensures robustness on the microgrid against abnormal conditions. Stability and robustness analysis show that the LQR-ORT controller has robust performance and stability under component uncertainties, as well as multiplicative uncertainties. The robustness against component variations is important for heavy duty applications, where environmental conditions may affect component specifications through time. Experimental results have confirmed the benefits of the presented approach and its advantages compared to literature work. The methodology used to develop the PQVI controller presented in this invention can be used to implement other types of modern control methods found in literature.

Supplementary loops for voltage and frequency restoration allow controller implementation in both grid-connected and islanded modes without communications. The voltage restoration loop also allows to distribute power sharing proportionally among generators according to their rated power capability. Frequency restoration loop also demonstrates to considerably improve transient response of the frequency deviations when connecting loads or when switching between grid-connected and islanded mode.

The present invention provides a novel approach and contributions in the microgrid control area.
1. An integrated power sharing control method for three-phase inverter-based generators in islanded microgrids.
2. An integrated state-space model that considers open-loop V-I and power sharing control dynamics for three-phase inverter-based generators in islanded microgrids.
3. A novel voltage restoration loop that allows to recover voltage deviations in islanded mode and also allows to distribute power sharing among generators proportionally according to their rated power capability.
4. A novel frequency restoration loop that synchronizes each inverter with the AC bus in both grid-connected and islanded modes.
5. A novel controller based on numerical methods that improve inverter robustness and transient response.
6. A novel voltage restoration loop that may be used in both grid-connected and islanded modes without communications. This loop also allows to distribute power generation among generators according to their rated power capability.
7. A novel frequency restoration loop that allows inverters to synchronize with the AC bus and recover frequency deviations in islanded mode without communications.

Although the present invention has been described herein with reference to the foregoing exemplary embodiment, this embodiment does not serve to limit the scope of the present invention. Accordingly, those skilled in the art to which the present invention pertains will appreciate that various modifications are possible, without departing from the technical spirit of the present invention.

1. A controller based on numerical methods to improve inverter robustness and transient response in microgrids.

2. A voltage restoration loop operating in grid-connected and islanded modes without communication, wherein the loop allows to distribute power generation among generators according to their rated power capability.

3. A frequency restoration loop that allows inverters to synchronize with the AC bus and recover frequency deviations in islanded mode without communications.
